(19) United States
(12) Patent Application Publication
(10) Pub. No.: US 2017/0081347 A1
(43) Pub. Date: Mar. 23, 2017

(54) FUNCTIONALIZED AZABORINE COMPOUNDS AND AZABORINE-CONTAINING BIARYLCARBOXAMIDES, AND COMPOSITIONS AND METHODS THEREOF

(71) Applicant: The Trustees of Boston College, Chestnut Hill, MA (US)

(72) Inventors: Shih-Yuan Liu, Chestnut Hill, MA (US); Peng Zhao, Quincy, MA (US); Alec Nathaniel Brown, Boston, MA (US)

(21) Appl. No.: 15/126,233

(22) PCT Filed: Apr. 13, 2015
(86) PCT No.: PCT/US15/25533

§ 371 Date: Sep. 14, 2016

Related U.S. Application Data
(60) Provisional application No. 61/979,049, filed on Apr. 14, 2014.
(60) Provisional application No. 62/001,685, filed on May 22, 2014.

(51) Int. Cl. C07F 7/08; C07F 5/02

(52) U.S. Cl. CPC C07F 7/082; C07F 5/02

(57) ABSTRACT

The invention provides novel azaborine compounds, methods for their syntheses and functionalization, and various applications thereof. For example, novel azaborine-containing biarylcarboxylic acids and biarylcarboxamides are disclosed herein, which provide the opportunity to be used as therapeutic agents in different diseases. The novel azaborine-containing compounds show unique physical and biological properties when compared to their corresponding all-carbon compounds. Also, disclosed herein are substituted 1,2-dihydro-1,2-azaborine compounds and methods for making the same including methods for the preparation of various substituted azaborines including alkyl, alkenyl, aryl, nitrile, heteroaryl, and fused ring substituents in the presence of B—H, B—Cl, B—O and N—H bonds from Br-substituted azaborines as well as the synthesis of new fused BN-heterocycles.

### PRIORITY CLAIMS AND RELATED APPLICATIONS

This application claims the benefit of U.S. Provisional Application No. 61/979,049, filed Apr. 14, 2014, and 62/001,685, filed May 22, 2014, the entire content of each of which is incorporated herein by reference in its entirety.

### GOVERNMENT RIGHTS

This invention was made with Government support pursuant to Grant No. R01GM094541 awarded by the National Institutes of Health. The Government has certain rights in the invention.

### TECHNICAL FIELDS OF THE INVENTION

The invention generally relates to azaborine compounds and their applications. More particularly, the invention relates to novel azaborine compounds, synthetic methodologies for their preparation and functionalization, and pharmaceutical applications thereof.

### BACKGROUND OF THE INVENTION

Boron-containing drugs are an emerging element in modem drug discovery and development. The substitution of the organic C═C unit with the isosteric inorganic B—N bond in organic molecules can lead to novel hybrid structures with unique properties. BN/CC isosterism has emerged as a viable strategy for broadening the chemical diversity of compounds relevant to materials science and biomedical research. (Campbell, et al. 2012 Angew. Chem. Int. Ed. Engl. 51, 6074-6092; Bosdet, et al. 2009 Can. J. Chem. 87, 8-29; Liu, et al. 2008 Angew. Chem. Int. Ed. Engl. 47, 242-244.) The replacement of two carbon atoms in benzene with a boron and a nitrogen atom leads to BN isosteres of benzene, including 1,2-azaborine, (Dewar, et al. 1958 J. Chem. Soc. 3073-3076; Dewar, et al. 1959 J. Chem. Soc. 2728-2730; Dewar, et al. 1962 J. Am. Chem. Soc. 1962, 84, 3782; Ashe, et al. 2001 Organometallics 20, 5413-5418; Ashe, et al. 2000 Org. Lett. 2, 2089-2091; Knack, et al. 2013 J. Heider, Angew. Chem. Int. Ed. Engl. 52, 2599-2601; d) A. N. Lamm, E. B. Garner, D. A. Dixon, S.-Y. Liu, Angew. Chem. Int. Ed. Engl. 2011, 50, 8157-8160; Marwitz, et al. 2010 Chem. Commun. 46, 779-781; Lamm, et al. 2009 Mol. BioSyst. 5, 1303-1305; Marwitz, et al. 2012 Chem. Sci. 3, 825-829; Rudebusch, et al. 2013 Angew. Chem. Int. Ed. Engl. 52, 9316-9319; Lu, et al. 2013 Angew. Chem. Int. Ed. Engl. 52, 4544-4548; Taniguchi, et al. 2010 Organometallics 29, 5732-5735; Hatakeyama, et al. 2011 J. Am. Chem. Soc. 133, 18614-18617.)

Azaborine is a boron-containing isosterere of the ubiquitous benzene motif obtained by applying B—N/C═C isosterism. Azaborine compounds have been demonstrated to show novel bioactivity. The amide bond is ubiquitous and widely used in medicinal chemistry. Biaryl groups have received increased attention in the pharmaceutical industry and have shown a wide activity range in a variety of therapeutic fields. Incorporating azaborine motifs into biarylcarboxamides has the potential to greatly expand the chemical space of biologically active molecules. Azaborines also have the potential to interact with substrates in ways that typical benzene-based analogs would not.

To explore this unique chemical space, novel compounds, robust synthetic methodologies, and related therapeutic use and application are strongly desired.

### SUMMARY OF THE INVENTION

The invention provides novel azaborine compounds, methods for their syntheses and functionalization, and various applications thereof. For example, novel azaborine-containing biarylcarboxylic acids and biarylcarboxamides are disclosed herein, which provide the opportunity to be used as therapeutic agents in different diseases. The novel azaborine-containing compounds show unique physical and biological properties when compared to their corresponding all-carbon compounds.

Also, disclosed herein are substituted 1,2-dihydro-1,2-azaborine compounds and methods for making the same. 1,2-Dihydro-1,2-azaborines are boron-containing isosteres of benzene made through replacement of a C═C bond with a B—N bond. Methods for the preparation of various substituted azaborines are disclosed herein, including alkyl, alkenyl, aryl, nitrile, and heteroaryl substituents in the presence of B—H, B—Cl, B—O, and N—H bonds from Br-substituted azaborines.

In one aspect, the invention generally relates to a compound having the structural Formula (I):

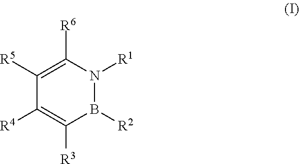

wherein

R¹ is H, or an optionally substituted alkyl, aryl, or silane group;

R² is H, a halogen, or an optionally substituted aryl, alkyl, alkenyl, alkynyl, alkoxy, amino, alcohol, or thio group; and

each of R³, R⁴, R⁵ and R⁶ is independently H, a halogen, or an optionally substituted alkyl, alkoxy, aryl, alkenyl, alkynyl, heteroaryl, phosphinyl, amino, amide, silyl, thio, sunlfonyl, carbonyl, ester, or ketone group,

or a pharmaceutically acceptable salt or ester thereof.

In another aspect, the invention generally relates to a method of preparing a compound of Formula (I), the method comprising: reacting a compound of Formula (III) with a zincate in the presence of a catalyst;

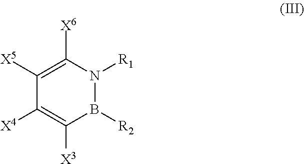

wherein

R¹ is H, or an optionally substituted alkyl, aryl, or silane;

R² is H, a halogen, or an optionally substituted aryl, alkyl, alkenyl, alkynyl, alkoxy, amino, alcohol, or thio; and

each of X³, X⁴, X⁵ and X⁶ is independently H, a halogen, an optionally substituted alkyl, alkoxy, aryl, alkenyl, alkynyl, heteroaryl, phosphinyl, amino, amide, silyl, thio, sunlfonyl, carbonyl, ester, or ketone group; provided that at least one of X³, X⁴, X⁵ and X⁶ is a halogen.

In yet another aspect, the invention generally relates to a method of preparing a compound of Formula (II), the method comprising: reacting a compound of Formula (IV) with a zincate in the presence of a catalyst;

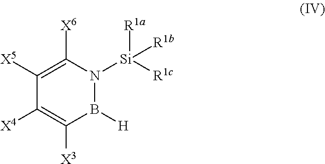

wherein;

R^{1a}, R^{1b}, and R^{1c} are each independently lower alkyl or aryl groups; and

each of X³, X⁴, X⁵ and X⁶ is independently H, a halogen, alkyl, alkoxy, aryl, alkenyl, alkynyl, heteroaryl, phosphinyl, amino, amide, silyl, thio, sunlfonyl, carbonyl, ester, or ketone; provided that at least one of X³, X⁴, X⁵ and X⁶ is a halogen.

In yet another aspect, the invention generally relates to a compound of the Formula (V):

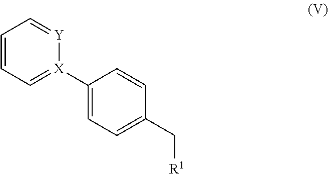

wherein:

X is B or C;

Y is CR² or NR²;

R¹ is CO₂R³ or CONR³R4;

R² is H, a halogen, or an optionally substituted alkyl, alkenyl, alkynyl, aryl, phosphinyl, heteroaryl, alkoxy, aramino, amide, silyl, thio, sunlfonyl, carbonyl, or carbonate ester; and

each of R³ and R⁴ is independently H, a halogen, or an optionally substituted alkyl, alkenyl, alkynyl, aryl, phosphinyl, heteroaryl, alkoxy, aramino, amide, silyl, thio, sunlfonyl, carbonyl, or carbonate ester;

or a pharmaceutically acceptable salt, solvate, clathrate, or ester thereof.

In yet another aspect, the invention generally relates to a compound having the structural Formula (VI):

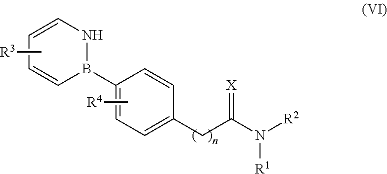

wherein:

each of R¹ and R² is independently H, or an alkyl, alkoxy, aryl, alkenyl, alkynyl, heteroaryl, ester, or amino acid group;

each of R³ and R⁴ is H, or an alkyl, alkoxy, aryl, alkenyl, alkynyl, heteroaryl, halogen, phosphinyl, amino, amide, silyl, thio, sunlfonyl, carbonyl, carbonate, ester, wherein R³ and R⁴ can be at any position or positions on the phenyl-ring;

X is O or S;

n is an integer between 0 and 18;

or a pharmaceutically acceptable salt, solvate, clathrate or ester thereof.

In yet another aspect, the invention generally relates to a compound having the structural Formula (VII):

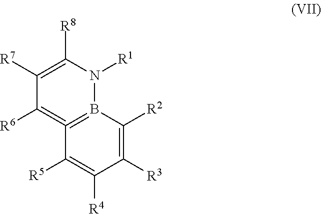

wherein

R¹ is H, or an optionally substituted alkyl, aryl, or silane;

each of R², R³, R⁴, R⁵, R6, R⁷ and R⁸ is independently H, or an optionally substituted alkyl, alkoxy, aryl, alkenyl, alkynyl, heteroaryl, phosphinyl, amino, amide, silyl, thio, sunlfonyl, carbonyl, ester, boronic ester, or ketone;

or a pharmaceutically acceptable salt, solvate, or clathrate thereof.

In yet another aspect, the invention generally relates to a compound having the structural Formula (VIII):

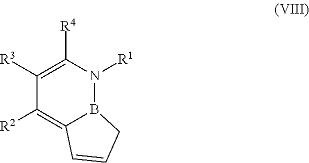

wherein

R¹ is H, or an optionally substituted alkyl, aryl, or silane;

each of R², R³, or R⁴ is independently H, or an optionally substituted alkyl, alkoxy, aryl, alkenyl, alkynyl, heteroaryl, phosphinyl, amino, amide, silyl, thio, sunlfonyl, carbonyl, ester, boronic ester, or ketone;

or a pharmaceutically acceptable salt, solvate, or clathrate thereof.

The invention also encompasses the use of any compound disclosed herein for the manufacture of a medicament for use in the treatment of a disease.

In yet another aspect, the invention generally relates to a pharmaceutical composition comprising an amount of a compound of the invention, effective to treat, prevent, or reduce one or more diseases or disorders, and a pharmaceutically acceptable excipient, carrier, or diluent.

In yet another aspect, the invention generally relates to a method of treating a disease, comprising administering to the subject in need thereof administering to a subject in need thereof a pharmaceutical composition comprising an amount of the compound of the invention, effective to treat, prevent, or reduce one or more diseases or disorders, and a pharmaceutically acceptable excipient, carrier, or diluent.

### DEFINITIONS

Unless defined otherwise, all technical and scientific terms used herein have the same meaning as commonly understood by one of ordinary skill in the art to which this invention belongs.

General principles of organic chemistry, as well as specific functional moieties and reactivity, are described in “Organic Chemistry”, Thomas Sorrell, University Science Books, Sausalito: 2006.

Certain compounds of the present invention may exist in particular geometric or stereoisomeric forms. The present invention contemplates all such compounds, including cis- and trans-isomers, R- and S-enantiomers, diastereomers, (D)-isomers, (L)-isomers, the racemic mixtures thereof, and other mixtures thereof, as falling within the scope of the invention. Additional asymmetric carbon atoms may be present in a substituent such as an alkyl group. All such isomers, as well as mixtures thereof, are intended to be included in this invention.

Isomeric mixtures containing any of a variety of isomer ratios may be utilized in accordance with the present invention. For example, where only two isomers are combined, mixtures containing 50:50, 60:40, 70:30, 80:20, 90:10, 95:5, 96:4, 97:3, 98:2, 99:1, or 100:0 isomer ratios are contemplated by the present invention. Those of ordinary skill in the art will readily appreciate that analogous ratios are contemplated for more complex isomer mixtures.

If, for instance, a particular enantiomer of a compound of the present invention is desired, it may be prepared by asymmetric synthesis, or by derivation with a chiral auxiliary, where the resulting diastereomeric mixture is separated and the auxiliary group cleaved to provide the pure desired enantiomers. Alternatively, where the molecule contains a basic functional group, such as amino, or an acidic functional group, such as carboxyl, diastereomeric salts are formed with an appropriate optically-active acid or base, followed by resolution of the diastereomers thus formed by fractional crystallization or chromatographic methods well known in the art, and subsequent recovery of the pure enantiomers.

Given the benefit of this disclosure, one of ordinary skill in the art will appreciate that synthetic methods, as described herein, may utilize a variety of protecting groups. By the term “protecting group”, as used herein, it is meant that a particular functional moiety, e.g., O, S, or N, is temporarily blocked so that a reaction can be carried out selectively at another reactive site in a multifunctional compound. In preferred embodiments, a protecting group reacts selectively in good yield to give a protected substrate that is stable to the projected reactions; the protecting group should be selectively removable in good yield by preferably readily available, non-toxic reagents that do not attack the other functional groups; the protecting group forms an easily separable derivative or analog (more preferably without the generation of new stereogenic centers); and the protecting group has a minimum of additional functionality to avoid further sites of reaction. Oxygen, sulfur, nitrogen, and carbon protecting groups may be utilized. Examples of a variety of protecting groups can be found in Protective Groups in Organic Synthesis, Third Ed. Greene, T. W. and Wuts, P. G., Eds., John Wiley & Sons, New York: 1999.

It will be appreciated that the compounds, as described herein, may be substituted with any number of substituents or functional moieties. Throughout the specifications, groups and substituents thereof may be chosen to provide stable moieties and compounds.

As used herein, the term “effective” amount of an active agent refers to an amount sufficient to elicit the desired biological response. As will be appreciated by those of ordinary skill in this art, the effective amount of a compound of the invention may vary depending on such factors as the desired biological endpoint, the pharmacokinetics of the compound, the disease being treated, the mode of administration, and the patient.

As used herein, the terms “treating”, “reducing”, or “preventing” a disease or disorder refer to ameliorating such a condition before or after it has occurred. As compared with an equivalent untreated control, such reduction or degree of prevention is at least 5%, 10%, 20%, 40%, 50%, 60%, 80%, 90%, 95%, or 100% as measured by any standard technique.

As used herein, the term “pharmaceutically acceptable excipient, carrier, or diluent” refers to a pharmaceutically acceptable material, composition or vehicle, such as a liquid or solid filler, diluent, excipient, solvent or encapsulating material, involved in carrying or transporting the subject pharmaceutical agent from one organ, or portion of the body, to another organ, or portion of the body. Each carrier must be “acceptable” in the sense of being compatible with the other ingredients of the formulation and not injurious to the patient. Some examples of materials which can serve as pharmaceutically-acceptable carriers include: sugars, such as lactose, glucose and sucrose; starches, such as corn starch and potato starch; cellulose, and its derivatives and analogs, such as sodium carboxymethyl cellulose, ethyl cellulose and cellulose acetate; powdered tragacanth; malt; gelatin; talc; excipients, such as cocoa butter and suppository waxes; oils, such as peanut oil, cottonseed oil, safflower oil, sesame oil, olive oil, corn oil and soybean oil; glycols, such as propylene glycol; polyols, such as glycerin, sorbitol, mannitol and polyethylene glycol; esters, such as ethyl oleate and ethyl laurate; agar; buffering agents, such as magnesium hydroxide and aluminum hydroxide; alginic acid; pyrogen-free water; isotonic saline; Ringer's solution; ethyl alcohol; phosphate buffer solutions; and other non-toxic compatible substances employed in pharmaceutical formulations. Wetting agents, emulsifiers and lubricants, such as sodium lauryl sulfate, magnesium stearate, and polyethylene oxide-polypropylene oxide copolymer as well as coloring agents, release agents, coating agents, sweetening, flavoring and perfuming agents, preservatives and antioxidants can also be present in the compositions.

As used herein, “subject” refers to any animal (e.g., a mammal), including, but not limited to humans, non-human primates, rodents, and the like, which is to be the recipient of a particular treatment. Typically, the terms “subject” and “patient” are used interchangeably herein in reference to a human subject.

As used herein, an amount “sufficient” refers to the amount of a compound, alone or in combination with another therapeutic regimen, required to treat, prevent, or reduce a metabolic disorder such as diabetes in a clinically relevant manner. A sufficient amount of an active compound used to practice the present invention for therapeutic treatment of conditions caused by or contributing to diabetes varies depending upon the manner of administration, the age, body weight, and general health of the mammal or patient. Ultimately, the prescribers will decide the appropriate amount and dosage regimen. Additionally, an effective amount may be an amount of compound in the combination of the invention that is safe and efficacious in the treatment of a patient having a metabolic disorder such as diabetes over each agent alone as determined and approved by a regulatory authority (such as the U.S. Food and Drug Administration).

As used herein, “acyl” refers to a group having the structure —C(O)R, where R may be, for example, optionally substituted alkyl, optionally substituted aryl, or optionally substituted heteroaryl. “Lower acyl” groups are those that contain one to six carbon atoms.

As used herein, “acyloxy” refers to a group having the structure —OC(O)R—, where R may be, for example, optionally substituted alkyl, optionally substituted aryl, or optionally substituted heteroaryl. “Lower acyloxy” groups contain one to six carbon atoms.

As used herein, “alkenyl” refers to a cyclic, branched or straight chain group containing only carbon and hydrogen, and containing one or more double bonds that may or may not be conjugated. Alkenyl groups may be unsubstituted or substituted. “Lower alkenyl” groups contain one to six carbon atoms.

As used herein, “alkoxy” refers to a straight, branched or cyclic hydrocarbon configuration and combinations thereof, including from 1 to 20 carbon atoms, preferably from 1 to 8 carbon atoms (referred to as a “lower alkoxy”), more preferably from 1 to 4 carbon atoms, that includes an oxygen atom at the point of attachment. An example of an “alkoxy group” is represented by the formula —OR, where R can be an alkyl group, optionally substituted with an alkenyl, alkynyl, aryl, aralkyl, cycloalkyl, halogenated alkyl, alkoxy or heterocycloalkyl group. Suitable alkoxy groups include methoxy, ethoxy, n-propoxy, i-propoxy, n-butoxy, i-butoxy, sec-butoxy, tert-butoxy cyclopropoxy, cyclohexyloxy, and the like. “Alkoxycarbonyl” refers to an alkoxy substituted carbonyl radical, —C(O)OR, wherein R represents an optionally substituted alkyl, aryl, aralkyl, cycloalkyl, cycloalkylalkyl or similar moiety.

As used herein, “alkoxyaryl” refers to C₁₋₆ alkyloxyaryl such as benzyloxy.

As used herein, “alkyl” refers to a branched or unbranched saturated hydrocarbon group of 1 to 24 carbon atoms, such as methyl, ethyl, n-propyl, isopropyl, n-butyl, isobutyl, i-butyl, pentyl, hexyl, heptyl, octyl, decyl, tetradecyl, hexadecyl, eicosyl, tetracosyl and the like. A “lower alkyl” group is a saturated branched or unbranched hydrocarbon having from 1 to 6 carbon atoms. Preferred alkyl groups have 1 to 4 carbon atoms. Alkyl groups may be “substituted alkyls” wherein one or more hydrogen atoms are substituted with a substituent such as halogen, cycloalkyl, alkoxy, amino, hydroxyl, aryl, alkenyl, or carboxyl. For example, a lower alkyl or (C₁-C₆)alkyl can be methyl, ethyl, propyl, isopropyl, butyl, iso-butyl, sec-butyl, pentyl, 3-pentyl, or hexyl; (C₃-C₆)cycloalkyl can be cyclopropyl, cyclobutyl, cyclopentyl, or cyclohexyl; (C₃-C₆)cycloalkyl(C₁-C₆)alkyl can be cyclopropylmethyl, cyclobutylmethyl, cyclopentylmethyl, cyclohexylmethyl, 2-cyclopropylethyl, 2-cyclobutylethyl, 2-cyclopentylethyl, or 2-cyclohexylethyl; (C₁-C₆)alkoxy can be methoxy, ethoxy, propoxy, isopropoxy, butoxy, iso-butoxy, sec-butoxy, pentoxy, 3-pentoxy, or hexyloxy; (C₂-C₆)alkenyl can be vinyl, allyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, or 5-hexenyl; (C₂-C₆)alkynyl can be ethynyl, 1-propynyl, 2-propynyl, 1-butynyl, 2-butynyl, 3-butynyl, 1-pentynyl, 2-pentynyl, 3-pentynyl, 4-pentynyl, 1-hexynyl, 2-hexynyl, 3-hexynyl, 4-hexynyl, or 5-hexynyl; (C₁-C₆)alkanoyl can be acetyl, propanoyl or butanoyl; halo(C₁-C₆)alkyl can be iodomethyl, bromomethyl, chloromethyl, fluoromethyl, trifluoromethyl, 2-chloroethyl, 2-fluoroethyl, 2,2,2-trifluoroethyl, or pentafluoroethyl; hydroxy(C₁-C₆)alkyl can be hydroxymethyl, 1-hydroxyethyl, 2-hydroxyethyl, 1-hydroxypropyl, 2-hydroxypropyl, 3-hydroxypropyl, 1-hydroxybutyl, 4-hydroxybutyl, 1-hydroxypentyl, 5-hydroxypentyl, 1-hydroxyhexyl, or 6-hydroxyhexyl; (C₁-C₆)alkoxycarbonyl can be methoxycarbonyl, ethoxycarbonyl, propoxycarbonyl, isopropoxycarbonyl, butoxycarbonyl, pentoxycarbonyl, or hexyloxycarbonyl; (C₁-C₆)alkylthio can be methylthio, ethylthio, propylthio, isopropylthio, butylthio, isobutylthio, pentylthio, or hexylthio; (C₂-C₆)alkanoyloxy can be acetoxy, propanoyloxy, butanoyloxy, isobutanoyloxy, pentanoyloxy, or hexanoyloxy.

As used herein, “alkynyl” refers to a cyclic, branched or straight chain group containing only carbon and hydrogen, and containing one or more triple bonds. Alkynyl groups may be unsubstituted or substituted. “Lower alkynyl” groups are those that contain one to six carbon atoms.

As used herein, “amine” or “amino” refers to a group of the formula —NRR′, where R and R′ can be, independently, hydrogen or an alkyl, alkenyl, alkynyl, aryl, aralkyl, cycloalkyl, halogenated alkyl, or heterocycloalkyl group. For example, an “alkylamino” or “alkylated amino” refers to —NRR′, wherein at least one of R or R′ is an alkyl.

As used herein, “araminio” refers to a group of the formula —NRR′, wherein either R or R′ is an aryl or a heteroaryl group.

As used herein, “aminocarbonyl” alone or in combination, means an amino substituted carbonyl (carbamoyl) radical, wherein the amino radical may optionally be mono- or di-substituted, such as with alkyl, aryl, aralkyl, cycloalkyl, cycloalkylalkyl, alkanoyl, alkoxycarbonyl, aralkoxycarbonyl and the like. An aminocarbonyl group may be —N(R)—C(O)—R (wherein R is a substituted group or H). A suitable aminocarbonyl group is acetamido.

As used herein, “carbonyl” is represented by the formula R—C(O)—R′, wherein R and R′ can be any independently substituted substituents, including but not limited to a hydrogen, alkyl, alkenyl, alkynyl, aryl, aralkyl, cycloalkyl, halogenated alkyl, or heteroaryl, heterocycloalkyl group described above.

As used herein, “amide” or “amido” is represented by the formula —C(O)NRR′, where R and R′ independently can be a hydrogen, alkyl, alkenyl, alkynyl, aryl, aralkyl, cycloalkyl, halogenated alkyl, or heterocycloalkyl group described above.

As used herein, “aryl” refers to a monovalent unsaturated aromatic carbocyclic group having a single ring (e.g., phenyl) or multiple condensed rings (e.g., naphthyl or anthryl), which can optionally be unsubstituted or substituted. A “heteroaryl group,” is defined as an aromatic group that has at least one heteroatom incorporated within the ring of the aromatic group. Examples of heteroatoms include, but are not limited to, nitrogen, oxygen, sulfur, and phosphorous. Heteroaryl includes, but is not limited to, pyridinyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, isoquinolinyl, benzimidazolyl, benzooxazolyl, quinoxalinyl, and the like. The aryl or heteroaryl group can be substituted with one or more groups including, but not limited to, alkyl, alkynyl, alkenyl, aryl, halide, nitro, amino, ester, ketone, aldehyde, hydroxy, carboxylic acid, or alkoxy, or the aryl or heteroaryl group can be unsubstituted.

As used herein, “aralkyl” or “arylalkyl” refers to an alkyl group wherein an aryl group is substituted for a hydrogen of the alkyl group. An example of an aralkyl group is a benzyl group.

As used herein, “aryloxy” or “heteroaryloxy” refers to a group of the formula —OAr, wherein Ar is an aryl group or a heteroaryl group, respectively. “Carbocycle” refers to a carbon-based ring that includes at least three carbon atoms. A carbocycle may be, for example, a cycloalkyl, a cycloalkenyl, or an aryl group.

As used herein, “carboxylate” or “carboxyl” refers to the group —COO— or —COOH.

As used herein, “cycloalkyl” refers to a non-aromatic carbon-based ring composed of at least three carbon atoms. Examples of cycloalkyl groups include, but are not limited to, cyclopropyl, cyclobutyl, cyclopentyl, cyclohexyl, and the like. The term “heterocycloalkyl group” is a cycloalkyl group as defined above where at least one of the carbon atoms of the ring is substituted with a heteroatom such as, but not limited to, nitrogen, oxygen, sulfur, or phosphorous.

As used herein, “ester” or “carbonate ester” refers to a carboxyl group having the hydrogen replaced with, for example, a C₁₋₆alkyl group (“carboxylC₁₋₆alkyl” or “alkylester”), an aryl or aralkyl group (“arylester” or “aralkylester”) and so on. CO₁₋₅alkyl groups are preferred, such as for example, methylester (CO₂Me), ethylester (CO₂Et) and propylester (CO₂Pr) and includes reverse esters thereof (e.g., —OCOMe, —OCOEt and —OCOPr).

As used herein, “halogen” or “halide” refers to fluoro, bromo, chloro and iodo substituents.

As used herein, “halogenated alkyl” or “haloalkyl group” refer to an alkyl group as defined above with one or more hydrogen atoms present on these groups substituted with a halogen (F, Cl, Br, I).

As used herein, “heterocycle” refers to mono or bicyclic rings or ring systems that include at least one heteroatom. The rings or ring systems generally include 1 to 9 carbon atoms in addition to the heteroatom(s) and may be saturated, unsaturated or aromatic (including pseudoaromatic). The term “pseudoaromatic” refers to a ring system which is not strictly aromatic, but which is stabilized by means of derealization of electrons and behaves in a similar manner to aromatic rings. Aromatic includes pseudoaromatic ring systems, such as pyrrolyl rings.

Examples of monocyclic heterocycle groups include, but are not limited to, those containing one nitrogen atom such as aziridine (3-membered ring), azetidine (4-membered ring), pyrrolidine (tetrahydropyrrole), pyrroline (e.g., 3-pyrroline, 2,5-dihydropyrrole), 2H-pyrrole or 3H-pyrrole (isopyrrole, isoazole) or pyrrolidinone (5-membered rings), piperidine, dihydropyridine, tetrahydropyridine (6-membered rings), and azepine (7-membered ring); those containing two nitrogen atoms such as imidazoline, pyrazolidine (diazolidine), imidazoline, pyrazoline (dihydropyrazole) (5-membered rings), piperazine (6-membered ring); those containing one oxygen atom such as oxirane (3-membered ring), oxetane (4-membered ring), oxolane (tetrahydrofuran), oxole (dihydrofuran) (5-membered rings), oxane (tetrahydropyran), dihydropyran, pyran (6-membered rings), oxepin (7-membered ring); those containing two oxygen atoms such as dioxolane (5-membered ring), dioxane (6-membered ring), and dioxepane (7-membered ring); those containing three oxygen atoms such as trioxane (6-membered ring); those containing one sulfur atom such as thiirane (3-membered ring), thietane (4-membered ring), thiolane (tetrahydrothiophene) (5-membered ring), thiane (tetrahydrothiopyran) (6-membered ring), thiepane (7-membered ring); those containing one nitrogen and one oxygen atom such as tetrahydrooxazole, dihydrooxazole, tetrahydroisoxazole, dihydroisoxazole (5-membered rings), morpholine, tetrahydrooxazine, dihydrooxazine, oxazine (6-membered rings); those containing one nitrogen and one sulfur atom such as thiazoline, thiazolidine (5-membered rings), thiomorpholine (6-membered ring); those containing two nitrogen and one oxygen atom such as oxadiazine (6-membered ring); those containing one oxygen and one sulfur such as: oxathiole (5-membered ring) and oxathiane (thioxane) (6-membered ring); and those containing one nitrogen, one oxygen and one sulfur atom such as oxathiazine (6-membered ring).

Examples of 5-membered monocyclic heteroaryl groups include but are not limited to furanyl, thienyl, pyrrolyl, oxazolyl, oxadiazolyl (including 1,2,3 and 1,2,4 oxadiazolyls and furazanyl i.e. 1,2,5-oxadiazolyl), thiazolyl, isoxazolyl, isothiazolyl, pyrazolyl, imidazolyl, triazolyl (including 1,2,3, 1,2,4 and 1,3,4 triazolyls), oxatriazolyl, tetrazolyl, thiadiazolyl (including 1,2,3 and 1,3,4 thiadiazolyls) and the like.

Examples of 6-membered monocyclic heteroaryl groups include but are not limited to pyridinyl, pyrimidinyl, pyridazinyl, pyrazinyl, triazinyl, pyranyl, oxazinyl, dioxinyl, thiazinyl, thiadiazinyl and the like. Examples of 6-membered aromatic heterocyclyls containing nitrogen include pyridyl (1 nitrogen), pyrazinyl, pyrimidinyl and pyridazinyl (2 nitrogens).

Aromatic heterocycle groups may also be bicyclic or polycyclic heteroaromatic ring systems such as fused ring systems (including purine, pteridinyl, napthyridinyl, 1H thieno[2,3-c]pyrazolyl, thieno[2,3-b]furyl and the like) or linked ring systems (such as oligothiophene, polypyrrole and the like). Fused ring systems may also include aromatic 5-membered or 6-membered heterocycles fused to carbocyclic aromatic rings such as phenyl, naphthyl, indenyl, azulenyl, fluorenyl, anthracenyl and the like, such as 5-membered aromatic heterocycles containing nitrogen fused to phenyl rings, 5-membered aromatic heterocycles containing 1 or 2 nitrogens fused to phenyl ring. A bicyclic heteroaryl group may be, for example, a group selected from: a) a benzene ring fused to a 5- or 6-membered ring containing 1, 2 or 3 ring heteroatoms; b) a pyridine ring fused to a 5- or 6-membered ring containing 1, 2 or 3 ring heteroatoms; c) a pyrimidine ring fused to a 5- or 6-membered ring containing 1 or 2 ring heteroatoms; d) a pyrrole ring fused to a 5- or 6-membered ring containing 1, 2 or 3 ring heteroatoms; e) a pyrazole ring fused to a 5- or 6-membered ring containing 1 or 2 ring heteroatoms; f) an imidazole ring fused to a 5- or 6-membered ring containing 1 or 2 ring heteroatoms; g) an oxazole ring fused to a 5- or 6-membered ring containing 1 or 2 ring heteroatoms; h) an isoxazole ring fused to a 5- or 6-membered ring containing 1 or 2 ring heteroatoms; i) a thiazole ring fused to a 5- or 6-membered ring containing 1 or 2 ring heteroatoms; j) an isothiazole ring fused to a 5- or 6-membered ring containing 1 or 2 ring heteroatoms; k) a thiophene ring fused to a 5- or 6-membered ring containing 1, 2 or 3 ring heteroatoms; I) a furan ring fused to a 5- or 6-membered ring containing 1, 2 or 3 ring heteroatoms; m) a cyclohexyl ring fused to a 5- or 6-membered ring containing 1, 2 or 3 ring heteroatoms; and n) a cyclopentyl ring fused to a 5- or 6-membered ring containing 1, 2 or 3 ring heteroatoms.

Particular examples of bicyclic heteroaryl groups containing a five membered ring fused to another five membered ring include but are not limited to imidazothiazole (e.g. imidazo[2,1-b]thiazole) and imidazoimidazole (e.g. imidazo[1,2-a] imidazole).

Particular examples of bicyclic heteroaryl groups containing a six membered ring fused to a five membered ring include but are not limited to benzofuran, benzothiophene, benzimidazole, benzoxazole, isobenzoxazole, benzisoxazole, benzothiazole, benzisothiazole, isobenzofuran, indole, isoindole, indolizine, indoline, isoindoline, purine (e.g., adenine, guanine), indazole, pyrazolopyrimidine (e.g. pyrazolo[1,5-a]pyrimidine), benzodioxole and pyrazolopyridine (e.g. pyrazolo[1,5-a]pyridine) groups. A further example of a six membered ring fused to a five membered ring is a pyrrolopyridine group such as a pyrrolo[2,3-b]pyridine group.

Particular examples of bicyclic heteroaryl groups containing two fused six membered rings include but are not limited to quinoline, isoquinoline, chroman, thiochroman, chromene, isochromene, isochroman, benzodioxan, quinolizine, benzoxazine, benzodiazine, pyridopyridine, quinoxaline, quinazoline, cinnoline, phthalazine, naphthyridine and pteridine groups.

Examples of heteroaryl groups containing an aromatic ring and a non-aromatic ring include tetrahydronaphthalene, tetrahydroisoquinoline, tetrahydroquinoline, dihydrobenzothiophene, dihydrobenzofuran, 2,3-dihydro-benzo[1,4]dioxine, benzo[1,3]dioxole, 4,5,6,7-tetrahydrobenzofuran, indoiine, isoindoline and indane groups.

Examples of aromatic heterocycles fused to carbocyclic aromatic rings may therefore include but are not limited to benzothiophenyl, indolyl, isoindolyl, benzofuranyl, isobenzofuranyl, benzimidazolyl, indazolyl, benzoxazolyl, benzisoxazolyl, isobenzoxazoyl, benzothiazolyl, benzisothiazolyl, quinolinyl, isoquinolinyl, quinoxalinyl, quinazolinyl, cinnolinyl, benzotriazinyl, phthalazinyl, carbolinyl and the like.

Examples of 5-membered non-aromatic heterocycle rings include 2H-pyrrolyl, 1-pyrrolinyl, 2-pyrrolinyl, 3-pyrrolinyl, pyrrolidinyl, 1-pyrrolidinyl, 2-pyrrolidinyl, 3-pyrrolidinyl,

tetrahydrofuranyl, tetrahydrothiophenyl, pyrazolinyl, 2-pyrazolinyl, 3-pyrazolinyl, pyrazolidinyl, 2-pyrazolidinyl, 3-pyrazolidinyl, imidazolidinyl, 3-dioxalanyl, thiazolidinyl, isoxazolidinyl, 2-imidazolinyl and the like.

Examples of 6-membered non-aromatic heterocycles include piperidinyl, piperidinonyl, pyranyl, dihydropyranyl, tetrahydropyranyl, 2H pyranyl, 4H pyranyl, thianyl, thianyl oxide, thianyl dioxide, piperazinyl, diozanyl, 1,4-dioxinyl, 1,4-di thianyl, 1,3,5-triozalanyl, 1,3,5-trithianyl, 1,4-morpholinyl, thiomorpholinyl, 1,4-oxathianyl, triazinyl, 1,4-thiazinyl and the like.

Examples of 7-membered non-aromatic heterocycles include azepanyl, oxepanyl, thiepanyl and the like.

As used herein, “N-heterocyclic” refers to mono or bicyclic rings or ring systems that include at least one nitrogen heteroatom. The rings or ring systems generally include 1 to 9 carbon atoms in addition to the heteroatom(s) and may be saturated, unsaturated or aromatic (including pseudoaromatic). The term “pseudoaromatic” refers to a ring system which is not strictly aromatic, but which is stabilized by means of derealization of electrons and behaves in a similar manner to aromatic rings.

Aromatic includes pseudoaromatic ring systems, such as pyrrolyl rings.

Examples of 5-membered monocyclic N-heterocycles include pyrrolyl, H-pyrrolyl, pyrrolinyl, pyrrolidinyl, oxazolyl, oxadiazolyl, (including 1,2,3 and 1,2,4 oxadiazolyls) isoxazolyl, furazanyl, thiazolyl, isothiazolyl, pyrazolyl, pyrazolinyl, pyrazolidinyl, imidazolyl, imidazolinyl, triazolyl (including 1,2,3 and 1,3,4 triazolyls), tetrazolyl, thiadiazolyl (including 1,2,3 and 1,3,4 thiadiazolyls), and dithiazolyl

Examples of 6-membered monocyclic N-heterocycles include pyridyl, pyrimidinyl, pyridazinyl, pyrazinyl, piperidinyl, morpholinyl, thiomorpholinyl, piperazinyl, and triazinyl. The heterocycles may be optionally substituted with a broad range of substituents, and preferably with C₁₋₆ alkyl, C₁₋₆ alkoxy, C₂₋₆ alkenyl, C₂₋₆ alkynyl, halo, hydroxy, mercapto, trifluoromethyl, amino, cyano or mono or di(C₁₋₆alkyl)amino.

The N-heterocyclic group may be fused to a carbocyclic ring such as phenyl, naphthyl, indenyl, azulenyl, fluorenyl, and anthracenyl.

Examples of 8, 9 and 10-membered bicyclic heterocycles include 1H thieno[2,3-c]pyrazolyl, indolyl, isoindolyl, benzoxazolyl, benzothiazolyl, benzisoxazolyl, benzisothiazolyl, benzimidazolyl, indazolyl, isoquinolinyl, quinolinyl, quinoxalinyl, purinyl, cinnolinyl, phthalazinyl, quinazolinyl, quinoxalinyl, benzotriazinyl, and the like. These heterocycles may be optionally substituted, for example with C₁₋₆ alkyl, C₁₋₆ alkoxy, C₂₋₆ alkenyl, C₂₋₆ alkynyl, halo, hydroxy, mercapto, trifluoromethyl, amino, cyano or mono or di(₁₋₆alkyl)amino. Unless otherwise defined optionally substituted N-heterocyclics includes pyridinium salts and the N-oxide form of suitable ring nitrogens.

As used herein, “hydroxyl” or “hydroxyl” is represented by the formula —OH.

As used herein, “isonitrile” refers to —NC.

As used herein, “nitrile” refers to —CN.

As used herein, “nitro” refers to an R-group having the structure —NO₂.

As used herein, “organic” includes polymeric materials as well as small molecule organic materials that may be used to fabricate organic opto-electronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be a fluorescent or phosphorescent small molecule emitter. A dendrimer may be a “small molecule,” and it is believed that all dendrimers currently used in the field of OLEDs are small molecules.

As used herein, “phosphinyl” refers to —PRR′ wherein R and R′ to substituted groups.

As used herein, “silyl” refers to —SiH₃ or SiR₃, wherein R is a substituted group.

As used herein, a “substituent” refers to a single atom (for example, a halogen atom) or a group of two or more atoms that are covalently bonded to each other, which are covalently bonded to an atom or atoms in a molecule to satisfy the valency requirements of the atom or atoms of the molecule, typically in place of a hydrogen atom. Examples of substituents include alkyl groups, hydroxyl groups, alkoxy groups, acyloxy groups, mercapto groups, and aryl groups.

As used herein, “solution processible” means capable of being dissolved, dispersed, or transported in and/or deposited from a liquid medium, either in solution or suspension form.

As used herein, “substituted” or “substitution” refers to replacement of a hydrogen atom of a molecule or an R-group with one or more additional R-groups. Unless otherwise defined, the term “optionally substituted” or “optional substituent” as used herein refers to a group which may or may not be further substituted with 1, 2, 3, 4 or more groups, preferably 1, 2 or 3, more preferably 1 or 2 groups selected from the group consisting of C₁₋₆alkyl, C₂₋₆alkenyl, C₂₋₆alkynyl, C₃₋₈cycloalkyl, hydroxyl, oxo, C₁₋₆alkoxy, aryloxy, C₁₋₆alkoxyaryl, halo, C₁₋₆alkylhalo (such as CF₃ and CHF₂), C₁₋₆alkoxyhalo (such as OCF₃ and OCHF₂), carboxyl, esters, cyano, nitro, amino, substituted amino, disubstituted amino, acyl, ketones, amides, aminoacyl, substituted amides, disubstituted amides, thiol, alkylthio, thioxo, sulfates, sulfonates, sulfinyl, substituted sulfinyl, sulfonyl, substituted sulfonyl, sulfonylamides, substituted sulfonamides, disubstituted sulfonamides, aryl, arC₁₋₆alkyl, heterocyclyl and heteroaryl wherein each alkyl, alkenyl, alkynyl, cycloalkyl, aryl and heterocyclyl and groups containing them may be further optionally substituted. Optional substituents in the case of heterocycles containing N may also include but are not limited to C₁₋₆alkyl i.e. N—C₁₋₆alkyl, more preferably methyl particularly N-methyl.

As used herein, “sulfinyl” refers to the group —S(═O)H.

As used herein, “substituted sulfinyl” or “sulfoxide” refers to a sulfinyl group having the hydrogen replaced with, for example a C₁₋₆alkyl group (“C₁₋₆alkylsulfinyl” or “C₁₋₆alkylsulfoxide”), an aryl (“arylsulfinyl”), an aralkyl (“aralkyl sulfinyl”) and so on. C₁₋₆alkylsulfinyl groups are preferred, such as for example, —SOmethyl, —SOethyl and —SOpropyl.

As used herein, “sulfonyl” refers to the group —SO₂H.

As used herein, “substituted sulfonyl” refers to a sulfonyl group having the hydrogen replaced with, for example a C₁₋₆alkyl group (“sulfonylC₁₋₆alkyl”), an aryl (“arylsulfonyl”), an aralkyl (“aralkylsulfonyl”) and so on. SulfonylC₁₋₆alkyl groups are preferred, such as for example, —SO₂Me, —SO₂Et and —SO₂Pr.

As used herein, “sulfonylamido” or “sulfonamide” refers to the group —SO₂NH₂. The term “sulfate” refers to the group —OS(O)₂OH and includes groups having the hydrogen replaced with, for example a C₁₋₆alkyl group (“alkylsulfates”), an aryl (“arylsulfate”), an aralkyl (“aralkylsulfate”) and so on. C₁₋₆Sulfates are preferred, such as for example, OS(O)₂OMe, OS(O)₂OEt and OS(O)₂OPr.

As used herein, “sulfonate” refers to the group —SO₃H and includes groups having the hydrogen replaced with, for example a C₁₋₆alkyl group (“alkylsulfonate”), an aryl (“arylsulfonate”), an aralkyl (“aralkylsulfonate”) and so on. C₁₋₆Sulfonates are preferred, such as for example, SO₃Me, SO₃Et and SO₃Pr.

As used herein, “thioether” refers to a —S—R group, wherein R may be, for example, alkyl (including substituted alkyl), or aryl (including substituted aryl).

As used herein, “thiol” or “thio” refers to —SH. A “substituted thiol” refers to a —S—R group wherein R is not an aliphatic or aromatic group. For instance, a substituted thiol may be a halogenated thiol such as, for example, —SFs.

As used herein, “thioxo” refers to the group ═S.

As used herein, “clathrate” refers to a chemical substance consisting of a lattice that traps or contains molecules.

As used herein, “solvate” refers to a compound that is associated with the molecules of a solvent.

As used herein, “salt” refers to an ionic compound that results from the neutralization reaction of an acid and a base.

Isotopically-labeled compounds are also within the scope of the present disclosure. As used herein, an “isotopically-labeled compound” refers to a presently disclosed compound including pharmaceutical salts and prodrugs thereof, each as described herein, in which one or more atoms are replaced by an atom having an atomic mass or mass number different from the atomic mass or mass number usually found in nature. Examples of isotopes that can be incorporated into compounds presently disclosed include isotopes of hydrogen, carbon, nitrogen, oxygen, phosphorous, fluorine and chlorine, such as ²H, ³H, ¹³C, ¹⁴C, ¹⁵N, ¹⁸O, ¹⁷O, ³¹P, ³²P, ³⁵S, ¹⁸F, and ³⁶Cl, respectively.

By isotopically-labeling the presently disclosed compounds, the compounds may be useful in drug and/or substrate tissue distribution assays. Tritiated (³H) and carbon-14 (¹⁴C) labeled compounds are particularly preferred for their ease of preparation and detectability. Further, substitution with heavier isotopes such as deuterium (²H) can afford certain therapeutic advantages resulting from greater metabolic stability, for example increased in vivo half-life or reduced dosage requirements and, hence, may be preferred in some circumstances. Isotopically labeled compounds presently disclosed, including pharmaceutical salts, esters, and prodrugs thereof, can be prepared by any means known in the art.

Further, substitution of normally abundant hydrogen (¹H) with heavier isotopes such as deuterium can afford certain therapeutic advantages, e.g., resulting from improved absorption, distribution, metabolism and/or excretion (ADME) properties, creating drugs with improved efficacy, safety, and/or tolerability. Benefits may also be obtained from replacement of normally abundant ¹²C with ¹³C. See, WO 2007/005643, WO 2007/005644, WO 2007/016361, and WO 2007/016431.

Stereoisomers (e.g., cis and trans isomers) and all optical isomers of a presently disclosed compound (e.g., R and S enantiomers), as well as racemic, diastereomeric and other mixtures of such isomers are within the scope of the present disclosure.

Compounds of the present invention are, subsequent to their preparation, preferably isolated and purified to obtain a composition containing an amount by weight equal to or greater than 95% (“substantially pure”), which is then used or formulated as described herein. In certain embodiments, the compounds of the present invention are more than 99% pure.

Solvates and polymorphs of the compounds of the invention are also contemplated herein. Solvates of the compounds of the present invention include, for example, hydrates.

Possible formulations include those suitable for oral, sublingual, buccal, parenteral (for example subcutaneous, intramuscular, or intravenous), rectal, topical including transdermal, intranasal and inhalation administration. Most suitable means of administration for a particular patient will depend on the nature and severity of the disease or condition being treated or the nature of the therapy being used and on the nature of the active compound.

### DESCRIPTION OF THE INVENTION

The invention provides novel azaborine compounds, methods for their syntheses and functionalization, and various applications thereof. For example, novel azaborine-containing biarylcarboxylic acids and biarylcarboxamides disclosed herein are promising candidates as therapeutic agents in different diseases. These novel azaborine-containing compounds show unique physical and biological properties when compared to their corresponding all-carbon compounds. For example, in terms of physical properties, the compounds possess aromaticity, fluorescence properties, water and air stability. Unique biological properties include novel molecular targets, novel binding modes, increased activity, enhanced selectivity, reduced toxicity, novel metabolism, novel in vitro transport and distribution approach, novel pharmacokinetics, etc. Biarylcarboxamides disclosed herein are also promising as tool molecules in basic research and as therapeutic agents in agroscience and human health.

The invention also provides novel, substituted 1,2-dihydro-1,2-azaborine compounds and methods for making the same. Current methodologies for the late-stage substitution of azaborines are limited by the use of high-energy intermediates, borophilic nucleophiles, or high temperature. Novel methodologies are disclosed herein for the preparation of various substituted azaborines including alkyl, alkenyl, aryl, nitrile, heteroaryl, and fused ring substituents in the presence of B—H, B—Cl, B—O and N—H bonds from Br-substituted azaborines as well as the synthesis of new fused BN-heterocycles.

The novel methodology of the invention allows access to new ligands for cross-coupling chemistry and methods for making the same. The use of organozinc compounds as coupling partners with azaborine derived electrophile reagents enables the introduction of new functional groups not previously possible. The present technology provides methods of functionalizing 1,2-dihydro-1,2-azaborines with substituents at the remaining four carbon atoms around the ring. In some preferred embodiments, functionalization occurs at the C3 position. In some preferred embodiments, a carbon atom of the 1,2-dihydro-1,2-azaborine scaffold (e.g., the C3 atom) is first halogenated by treatment with a halogen (e.g., bromine).

TABLE 1
Biologically Active Compounds and their Corresponding BN Isosteres

| | | Mol. Formula & | Representative |
|---|---|---|---|
| No. | Molecular Structure | Mol. Weight | Biological Target |
| A-1 | 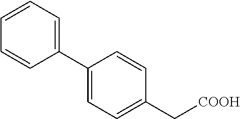 [SMILES: O=C(O)Cc1ccc(-c2ccccc2)cc1] | C₁₄H₁₂O₂ Exact Mass: 212.08373 | COX-2 inhibitor |
| A-2 | 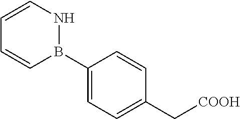 [SMILES: O=C(O)Cc1ccc(B2C=CC=CN2)cc1] | C₁₂H₁₂BNO₂ Exact Mass: 213.09611 | COX-2 inhibitor |
| A-5 | 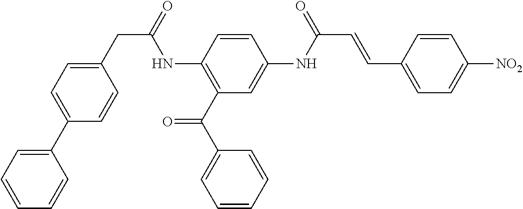 [SMILES: O=C(/C=C/c1ccc([N+](=O)[O-])cc1)Nc1ccc(NC(=O)Cc2ccc(-c3ccccc3)cc2)c(C(=O)c2ccccc2)c1] | C₃₆H₂₇N₃O₅ Exact Mass: 581.19507 | Farnesyltransferase Inhibitors |
| 5 | 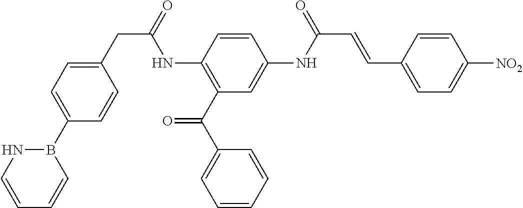 [SMILES: O=C(/C=C/c1ccc([N+](=O)[O-])cc1)Nc1ccc(NC(=O)Cc2ccc(B3C=CC=CN3)cc2)c(C(=O)c2ccccc2)c1] | C₃₄H₂₇BN₄O₅ Exact Mass: 582.20745 | Farnesyltransferase Inhibitors |
| A-6 | 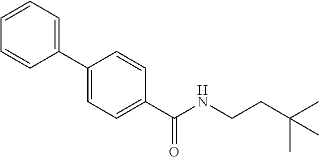 [SMILES: CC(C)(C)CCNC(=O)c1ccc(-c2ccccc2)cc1] | C₁₉H₂₃NO Exact Mass: 281.17796 | Potassium channels I_{Ks} blocker |
| 6 | 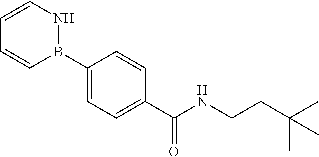 [SMILES: CC(C)(C)CCNC(=O)c1ccc(B2C=CC=CN2)cc1] | C₁₇H₂₃BN₂O Exact Mass: 282.19034 | Potassium channels I_{Ks} blocker |
| A-7 | 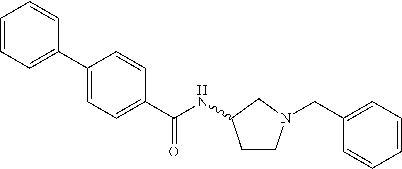 [SMILES: O=C(NC1CCN(Cc2ccccc2)C1)c1ccc(-c2ccccc2)cc1] | C₂₄H₂₄N₂O Exact Mass: 356.18886 | Dopamine D₄ receptor antagonists |
| 7 | 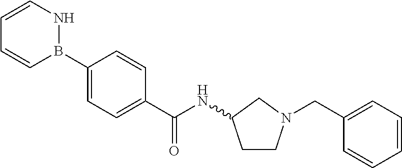 [SMILES: O=C(NC1CCN(Cc2ccccc2)C1)c1ccc(B2C=CC=CN2)cc1] | C₂₂H₂₄BN₃O Exact Mass: 357.20124 | Dopamine D₄ receptor antagonists |
| A-8 | 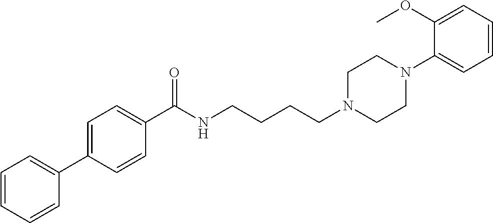 [SMILES: COc1ccccc1N1CCN(CCCCNC(=O)c2ccc(-c3ccccc3)cc2)CC1] | C₂₈H₃₃N₃O₂ Exact Mass: 443.25728 | Dopamine D₃ receptor antagonist |
| 8 | 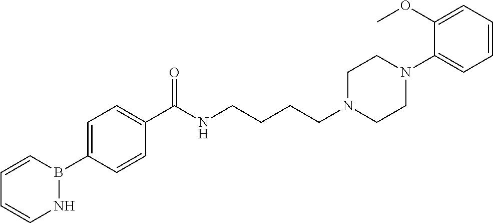 [SMILES: COc1ccccc1N1CCN(CCCCNC(=O)c2ccc(B3C=CC=CN3)cc2)CC1] | C₂₆H₃₃BN₄O₂ Exact Mass: 444.26966 | Dopamine D₃ receptor antagonist |
| A-9 | 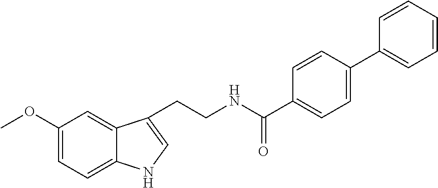 [SMILES: COc1ccc2[nH]cc(CCNC(=O)c3ccc(-c4ccccc4)cc3)c2c1] | C₂₄H₂₂N₂O₂ Exact Mass: 370.16813 | TRPV1 (transient receptor potential vanilloid subfamily member 1) antagonist |
| 9 | 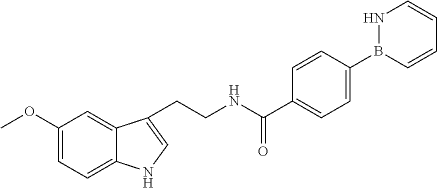 [SMILES: COc1ccc2[nH]cc(CCNC(=O)c3ccc(B4C=CC=CN4)cc3)c2c1] | C₂₂H₂₂BN₃O₂ Exact Mass: 371.18051 | TRPV1 (transient receptor potential vanilloid subfamily member 1) antagonist |
| A-10 | 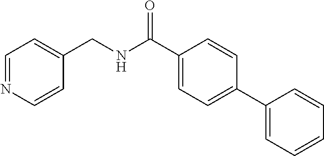 [SMILES: O=C(NCc1ccncc1)c1ccc(-c2ccccc2)cc1] | C₁₉H₁₆N₂O Exact Mass: 288.12626 | Matrix metalloprotease 13 (MMP13) inhibitor |
| 10 | 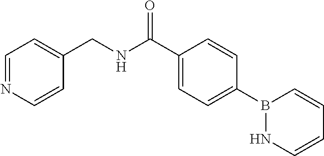 [SMILES: O=C(NCc1ccncc1)c1ccc(B2C=CC=CN2)cc1] | C₁₇H₁₆BN₃O Exact Mass: 289.13864 | Matrix metalloprotease 13 (MMP13) inhibitor |
| A-11 | 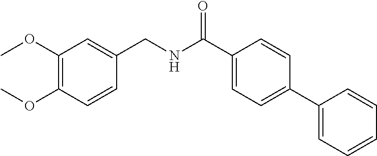 [SMILES: COc1ccc(CNC(=O)c2ccc(-c3ccccc3)cc2)cc1OC] | C₂₂H₂₁NO₃ Exact Mass: 347.15214 | NADH-ubiquinone oxidoreductases inhibitor |
| 11 | 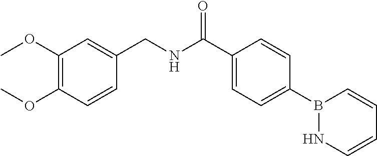 [SMILES: COc1ccc(CNC(=O)c2ccc(B3C=CC=CN3)cc2)cc1OC] | C₂₀H₂₁BN₂O₃ Exact Mass: 348.16452 | NADH-ubiquinone oxidoreductases inhibitor |
| A-12 | 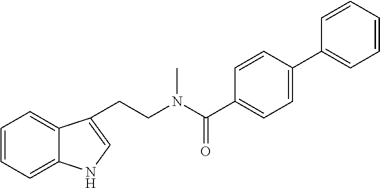 [SMILES: CN(CCc1c[nH]c2ccccc12)C(=O)c1ccc(-c2ccccc2)cc1] | C₂₄H₂₂N₂O Exact Mass: 354.17321 | Cyclin-dependent kinase 4 (Cdk4) inhibitor |
| 12 | 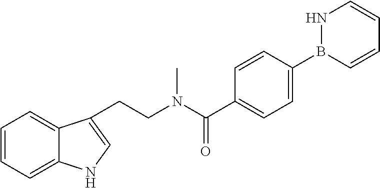 [SMILES: CN(CCc1c[nH]c2ccccc12)C(=O)c1ccc(B2C=CC=CN2)cc1] | C₂₂H₂₂BN₃O Exact Mass: 355.18559 Mol. Wt.: 355.24058 | Cyclin-dependent kinase 4 (Cdk4) inhibitor |
| A-13 | 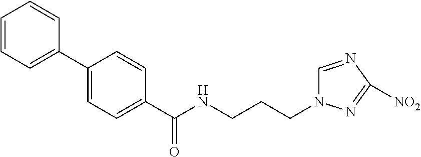 [SMILES: O=C(NCCCn1cnc([N+](=O)[O-])n1)c1ccc(-c2ccccc2)cc1] | C₁₈H₁₇N₅O₃ Exact Mass: 351.13314 | Antitrypanosomal agents |
| 13 | 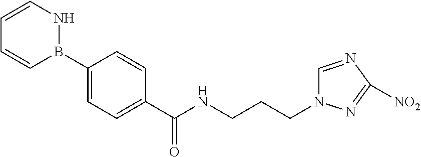 [SMILES: O=C(NCCCn1cnc([N+](=O)[O-])n1)c1ccc(B2C=CC=CN2)cc1] | C₁₆H₁₇BN₆O₃ Exact Mass: 352.14552 | Antitrypanosomal agents |

Compounds of the invention can be used in any number of biological assays, as therapeutic or diagnostic agents, and/or as intermediates for the syntheses of other compounds useful in biological assays, as therapeutic or diagnostic agents.

For instance, the biological assays may include pharmacokinetic assays, famaselytransferase assays, I_{Ks} activity assays, Dopamine D₄ receptor assays, Dopamine D₃ receptor assays, TRPV1 assays, MMP13 assays, NADH-ubiquinone oxidoreductases assays, Cdk4 activity assays, or assays for in vitro activity against T. cruzi, T. brucei rhodesiense, and L. donovani.

Exemplary synthetic procedures and schemes for various compounds disclosed herein are presented in the Examples section below.

Thus, in one aspect, the invention generally relates to a compound having the structural Formula (I):

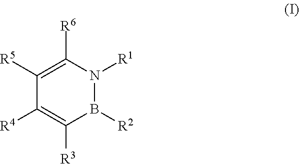

wherein

R¹ is H, or an optionally substituted alkyl, aryl, or silane group;

R² is H, a halogen, or an optionally substituted aryl, alkyl, alkenyl, alkynyl, alkoxy, amino, alcohol, or thio group; and

each of R³, R⁴, R⁵ and R⁶ is independently H, a halogen, or an optionally substituted alkyl, alkoxy, aryl, alkenyl, alkynyl, heteroaryl, phosphinyl, amino, amide, silyl, thio, sunlfonyl, carbonyl, ester, or ketone group,

or a pharmaceutically acceptable salt or ester thereof.

In certain embodiments, the compound has the structural Formula (II):

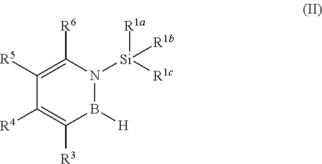

wherein each of R^{1a}, R^{1b}, and R^{1c} is independently a C₁-C₆ alkyl or aryl group. In certain preferred embodiments, each of R^{1a}, R^{1b}, and R^{1c} is independently a C₁-C₆ alkyl group. In certain preferred embodiments, each of R^{1a} and R^{1b} is methyl; R^{1c} is tert-butyl; each of R⁴, R⁵ and R⁶ is H; and R³ is H, or an optionally substituted alkyl, alkoxy or aryl group.

In certain embodiments, the compound has the structural formula:

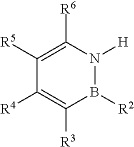

wherein R² is a halogen, or an optionally substituted alkoxy group. In certain preferred embodiments, each of R⁴, R⁵ and R⁶ is H. In certain preferred embodiments, R² is chloride. In certain preferred embodiments, R² is a butoxy group.

In certain embodiments, the compound has the structural formula:

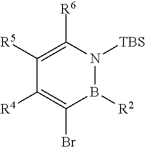

wherein R² is H, a halogen, or an alkoxy group. In certain preferred embodiments, the compound has the structural each of R⁴, R⁵ and R⁶ is H.

In certain embodiments, the compound has the structural formula:

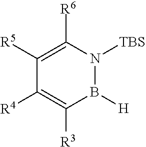

wherein R³ is H or an alkyl, aryl, heteroaryl, or alkenyl group, or Br.

In another aspect, the invention generally relates to a method of preparing a compound of Formula (I), the method comprising: reacting a compound of Formula (III) with a zincate in the presence of a catalyst;

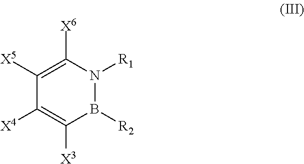

wherein

R¹ is H, or an optionally substituted alkyl, aryl, or silane;

R² is H, a halogen, or an optionally substituted aryl, alkyl, alkenyl, alkynyl, alkoxy, amino, alcohol, or thio; and

each of X³, X⁴, X⁵ and X⁶ is independently H, a halogen, an optionally substituted alkyl, alkoxy, aryl, alkenyl, alkynyl, heteroaryl, phosphinyl, amino, amide, silyl, thio, sunlfonyl, carbonyl, ester, or ketone group; provided that at least one of X³, X⁴, X⁵ and X⁶ is a halogen.

In certain preferred embodiments, X³ is a halogen (e.g., Br).

In certain preferred embodiments, the catalyst is PdCl₂(Potol₃)₂ or Pd(PtBu₃)₂.

In certain embodiments, the zincate is RZnX^{a}, wherein R is an optionally substituted alkyl, alkoxy, aryl, alkenyl, alkynyl, heteroaryl, phosphinyl, amino, amide, silyl, thio, sunlfonyl, carbonyl, ester, or ketone desired to be added to formula (III); and X^{a} is a halogen. In certain preferred embodiments, X^{a} is Br.

In certain embodiments, the reaction is conducted in an organic solvent, for example, selected from an ether, toluene, dimethylformamide, dimethylacetamide, acetonitrile or selected linear, branched, or cyclic alkane. In certain preferred embodiments, the solvent is tetrahydrofuran.

In yet another aspect, the invention generally relates to a method of preparing a compound of Formula (II), the method comprising: reacting a compound of Formula (IV) with a zincate in the presence of a catalyst;

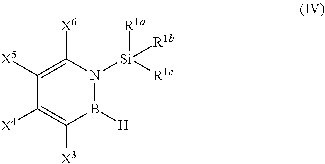

wherein;

R^{1a}, R^{1b}, and R^{1c} are each independently lower alkyl or aryl groups; and

each of X³, X⁴, X⁵ and X⁶ is independently H, a halogen, alkyl, alkoxy, aryl, alkenyl, alkynyl, heteroaryl, phosphinyl, amino, amide, silyl, thio, sunlfonyl, carbonyl, ester, or ketone; provided that

at least one of X³, X⁴, X⁵ and X⁶ is a halogen.

In certain preferred embodiments, X³ is a halogen (e.g., Br).

In certain preferred embodiments, the catalyst is PdCl₂(Potol₃)₂ or Pd(PtBu₃)₂.

In certain embodiments, the zincate is RZnX^{a}, wherein R is an optionally substituted alkyl, alkoxy, aryl, alkenyl, alkynyl, heteroaryl, phosphinyl, amino, amide, silyl, thio, sunlfonyl, carbonyl, ester, or ketone desired to be added to formula (III); and X^{a} is a halogen. In certain preferred embodiments, X^{a} is Br.

In certain embodiments, the reaction is conducted in an organic solvent, for example, selected from an ether, toluene, dimethylformamide, dimethylacetamide, acetonitrile or selected linear, branched, or cyclic alkane. In certain preferred embodiments, the solvent is tetrahydrofuran.

In yet another aspect, the invention generally relates to a compound of the Formula (V):

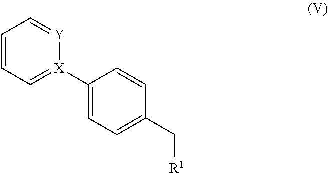

wherein:

X is B or C;

Y is CR² or NR²;

R¹ is CO₂R³ or CONR³R4;

R² is H, a halogen, or an optionally substituted alkyl, alkenyl, alkynyl, aryl, phosphinyl, heteroaryl, alkoxy, aramino, amide, silyl, thio, sunlfonyl, carbonyl, or carbonate ester; and

each of R³ and R⁴ is independently H, a halogen, or an optionally substituted alkyl, alkenyl, alkynyl, aryl, phosphinyl, heteroaryl, alkoxy, aramino, amide, silyl, thio, sunlfonyl, carbonyl, or carbonate ester;

or a pharmaceutically acceptable salt, solvate, clathrate, or ester thereof.

In yet another aspect, the invention generally relates to a compound having the structural Formula (VI):

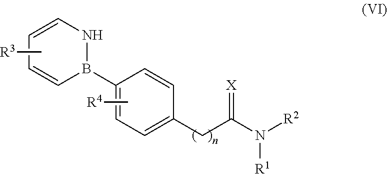

wherein:

each of R¹ and R² is independently H, or an alkyl, alkoxy, aryl, alkenyl, alkynyl, heteroaryl, ester, or amino acid group;

each of R³ and R⁴ is H, or an alkyl, alkoxy, aryl, alkenyl, alkynyl, heteroaryl, halogen, phosphinyl, amino, amide, silyl, thio, sunlfonyl, carbonyl, carbonate, ester, wherein R³ and R⁴ can be at any position or positions on the phenyl-ring;

X is O or S;

n is an integer between 0 and 18;

or a pharmaceutically acceptable salt, solvate, clathrate or ester thereof.

In yet another aspect, the invention generally relates to a compound of selected from:

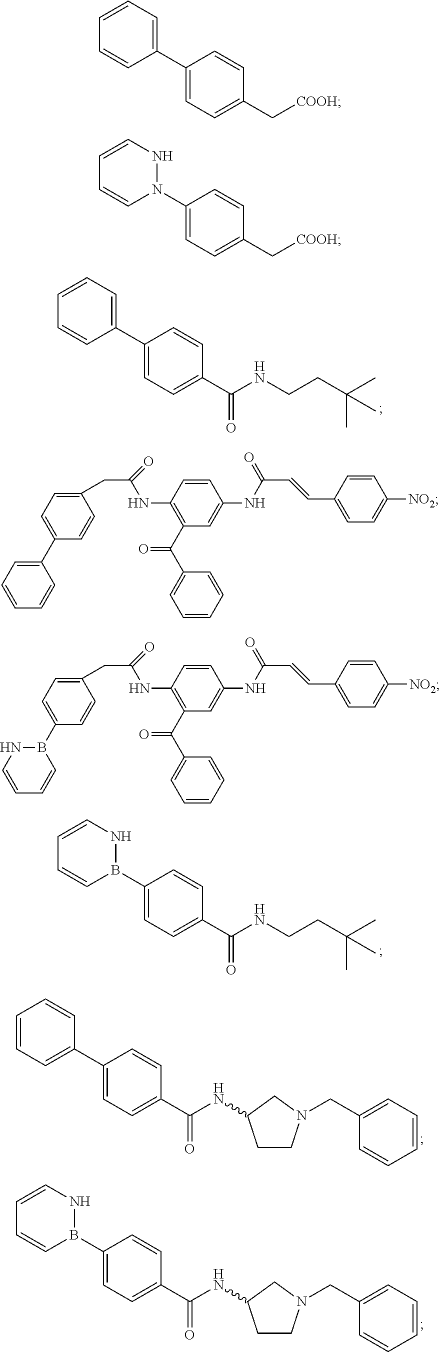

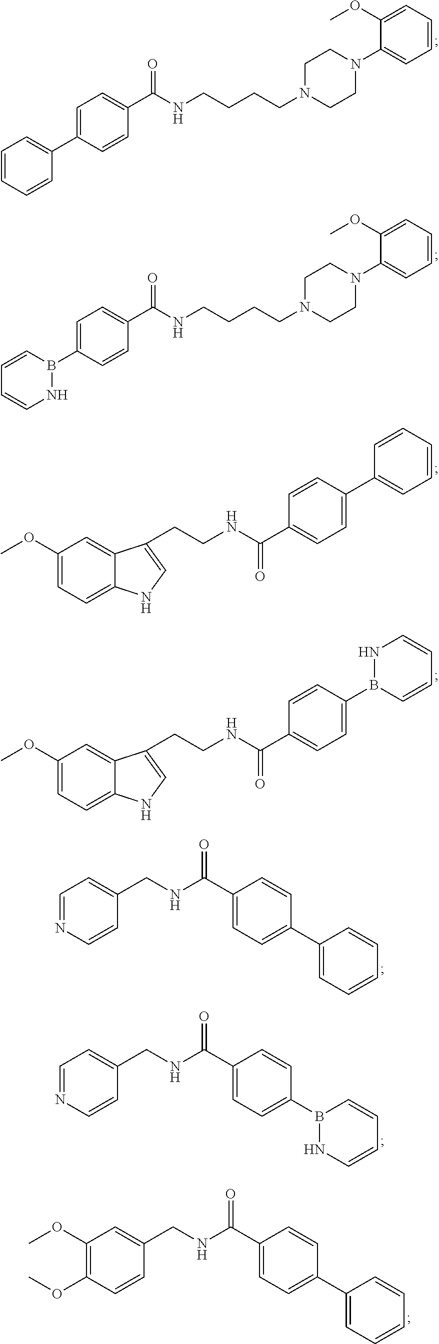

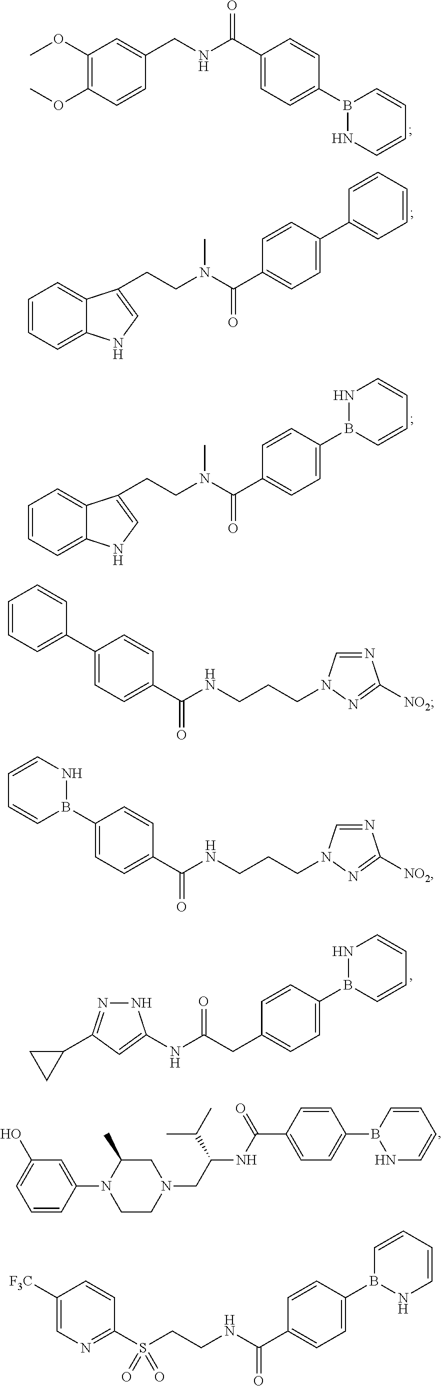

or a pharmaceutically acceptable salt, solvate, clathrate, or ester thereof.

In yet another aspect, the invention generally relates to a compound having the structural Formula (VII):

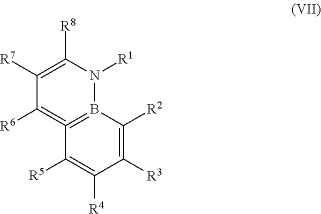

wherein

R¹ is H, or an optionally substituted alkyl, aryl, or silane;

each of R², R³, R⁴, R⁵, R6, R⁷ and R⁸ is independently H, or an optionally substituted alkyl, alkoxy, aryl, alkenyl, alkynyl, heteroaryl, phosphinyl, amino, amide, silyl, thio, sunlfonyl, carbonyl, ester, boronic ester, or ketone;

or a pharmaceutically acceptable salt, solvate, or clathrate thereof.

In yet another aspect, the invention generally relates to a compound having the structural Formula (VIII):

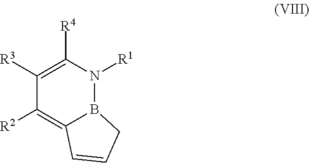

wherein

R¹ is H, or an optionally substituted alkyl, aryl, or silane;

each of R², R³, or R⁴ is independently H, or an optionally substituted alkyl, alkoxy, aryl, alkenyl, alkynyl, heteroaryl, phosphinyl, amino, amide, silyl, thio, sunlfonyl, carbonyl, ester, boronic ester, or ketone;

or a pharmaceutically acceptable salt, solvate, or clathrate thereof.

In yet another aspect, the invention generally relates to a compound of selected from:

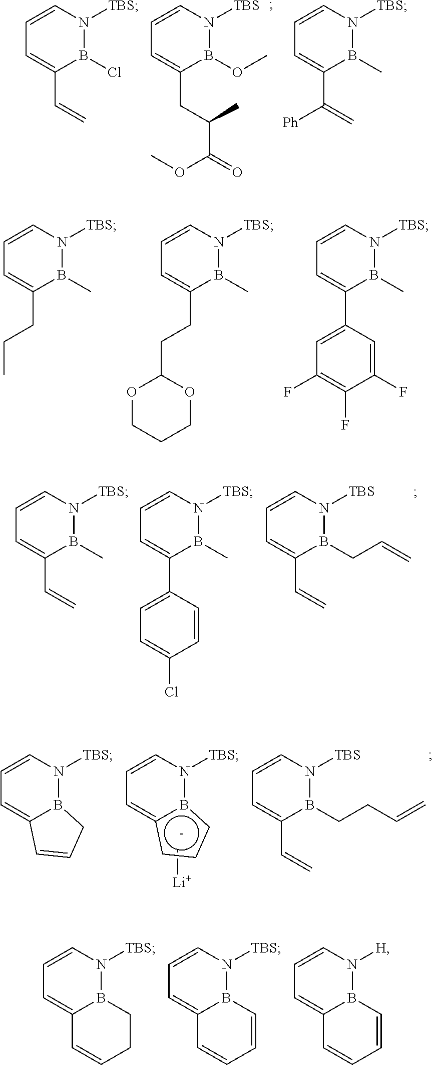

or a pharmaceutically acceptable salt, solvate, clathrate, or ester thereof

The invention also encompasses the use of any compound disclosed herein for the manufacture of a medicament for use in the treatment of a disease.

In yet another aspect, the invention generally relates to a pharmaceutical composition comprising an amount of a compound of the invention, effective to treat, prevent, or reduce one or more diseases or disorders, and a pharmaceutically acceptable excipient, carrier, or diluent.

In yet another aspect, the invention generally relates to a method of treating a disease, comprising administering to the subject in need thereof administering to a subject in need thereof a pharmaceutical composition comprising an amount of the compound of the invention, effective to treat, prevent, or reduce one or more diseases or disorders, and a pharmaceutically acceptable excipient, carrier, or diluent.

### EXAMPLES

The examples described herein will be understood by one of ordinary skill in the art as exemplary protocols. One of ordinary skill in the art will be able to modify the below procedures appropriately and as necessary.

### Example 1

### Exemplary synthesis of 4-(1,2-azaborinin-2(1H)-yl)benzoic acid 4

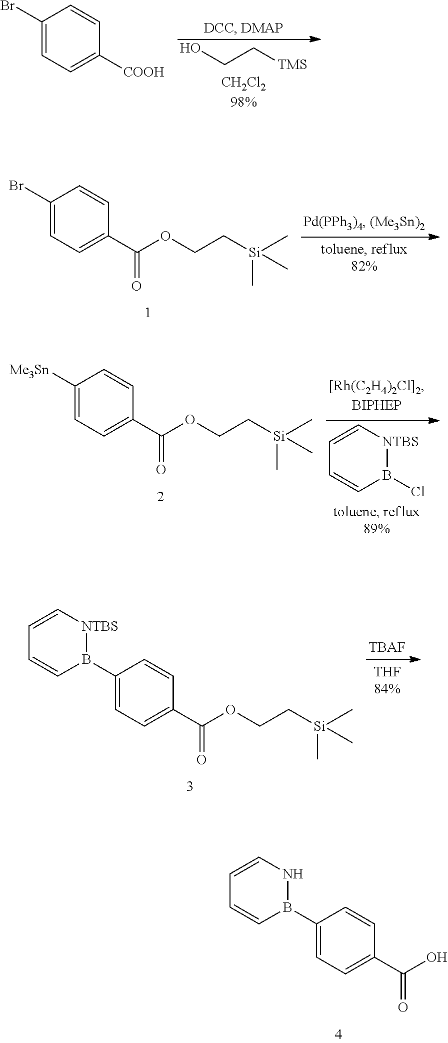

### Example 2

### Exemplary Synthesis of Azaborine-Containing Biarylcarboxamide

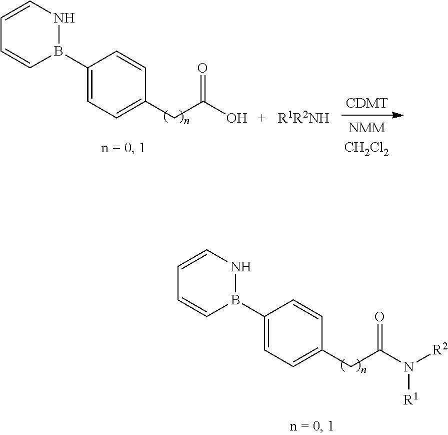

### Example 3

### Synthetic Protocols for Exemplary Compounds

### 2-(Trimethylsilyl)ethyl-4-bromobenzoate (1)

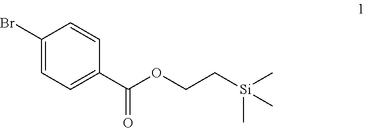 [SMILES: C[Si](C)(C)CCOC(=O)c1ccc(Br)cc1]

To a solution of 4-bromobenzoic acid (5.10 g, 24.9 mmol) in CH₂Cl₂ (150 mL) was added 4-dimethylaminopyridine (180 mg), N,N′-dicyclohexylcarbodiimide (5.00 g) and 2-(trimethylsilyl)ethanol (6.20 mL) under ice-water bath. The reaction was stirred at rt for 14 h. The solid was filtered off and the filtrate was purified by silica gel chromatography (5% EtOAc/hexanes) (v/v) provided compound 1 as colorless oil (7.52 g, 98% yield).

¹H NMR (300 MHz, CD₂Cl₂) δ 7.92 (d, J=7.8 Hz, 2H), 7.62 (d, J=7.8 Hz, 2H), 4.44 (t, J=8.1 Hz, 2H), 1.16 (t, J=4.8 Hz, 2H), 0.13 (s, 9H); ¹³C NMR (126 MHz, CD₂Cl₂) δ 165.7, 131.6, 131.0, 129.8, 127.6, 63.4, 17.3, −1.77.

### Compound 2: 2-(Trimethylsilyl)ethyl-4-(trimethylstannyl)benzoate

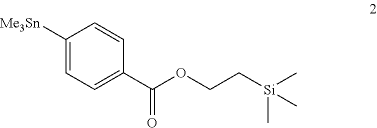

In a glovebox, to a 20 mL a pressure vessel, compound 1 (100 mg, 0.33 mmol), tetrakis(triphenylphosphine)palladium (20 mg, 0.05 eq.), hexamethylditin (140 mg, 0.427 mmol) and toluene (4 mL) was added. The solution was brought to 100° C. for 15 hr then cooled to rt. The crude product was purified by silica gel chromatography (pentane then 10% EtOAc/hexanes) (v/v) to afford compound 2 as colorless oil (105 mg, 82% yield).

¹H NMR (300 MHz, CD₂Cl₂) δ 7.99 (d, J=4.5 Hz, 2H), 7.64 (d, J=4.8 Hz, 2H), 4.44 (t, J=5.1 Hz, 2H), 1.17 (t, J=5.1 Hz, 2H), 0.36 (s, 9H), 0.13 (s, 9H); ¹³C NMR (126 MHz, CD₂Cl₂) δ166.8, 149.4, 135.8, 135.6, 130.4, 128.2, 63.0, 17.2, −1.2, −1.8, −9.9.

### Compound 3

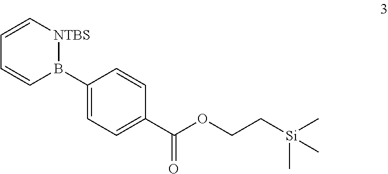

In a glovebox, chlorobis(ethylene)rhodium dimer (52 mg, 0.13 mmol, 0.05 eq.), BIPHEP (140 mg, 0.26 mmol, 0.1 eq.) and toluene (5 mL) were added to a 20 mL vial. The solution was stirred for 30 min, then it was transferred to a pressure vessel containing 1-(tert-butyldimethylsilyl)-2-chloro-1,2-dihydro-1,2-azaborinine (650 mg, 2.86 mmol, 1.1 eq.), compound 2 (1.00 g, 2.59 mmol, 1.0 eq) and toluene (15 mL). The pressure vessel was sealed and heated at 100° C. for 15 h. The reaction was allowed to cool to room temperature and purified in the glovebox by silica gel chromatography (10% ether/pentane) to provide the product 3 as white solid (951 mg, 89% yield based on 2).

¹H NMR (300 MHz, CD₂Cl₂) δ 8.00 (d, J=8.1 Hz, 2H), 7.66-7.71 (m, 1H), 7.51-7.55 (m, 3H), 6.68 (d, J=10.5 Hz, 1H), 6.54 (m, 1H), 4.49 (t, J=4.2, Hz, 2H), 1.23 (t, J=4.5 Hz, 2H), 0.99 (s, 9H), 0.18 (s, 9H), 0.11 (s, 6H); ¹³C NMR (126 MHz, CD₂Cl₂) δ 167.0, 143.2, 138.3, 132.0, 129.4, 128.9, 128.3, 127.5, 112.2, 62.9, 26.6, 26.3, 18.8, 17.4, −1.7, −2.3; ¹¹B NMR (96 MHz) δ 41.3; HRMS (ESI) calcd for C₂₂H₃₇BNO₂Si₂ (M+H)⁺ 414.2456. found 414.2468.

### Compound 4

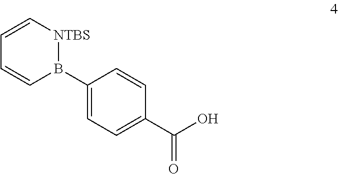

In the glovebox, compound 3 (850 mg, 2.06 mmol) was dissolved into THF (12 mL) and cooled in −25° C. freezer for 30 min. The reaction flask was taken out of the glovebox and TBAF (5.0 mL, 1.0 M in THF) was added slowly. The resulted yellow solution was stirred at rt for 3 hr. Purification of crude material was performed on silica gel chromatography using CH2Cl2/MeOH/AcOH 100:4:0.8 (v/v) as the eluent. The resulted off-white solid was recrystallized in CH₂Cl₂/hexane system to afford compound (344 mg, 84% yield).

¹H NMR (300 MHz, acetone-d6) δ 10.19 (br s, 1H), 7.89-8.07 (m, 4H), 7.81 (dd, J=6.3 and 11.1 Hz, 1H), 7.61 (t, J=6.6 Hz, 1H), 7.22 (d, J=11.1 Hz, 1H), 6.47 (t, J=6.6 Hz, 1H); ¹³C NMR (126 MHz, acetone-d6) δ 205.4, 167.2, 144.8, 135.2, 132.4, 130.6, 129.0, 111.2; ¹¹B NMR (96 MHz) δ 33.6; HRMS (DART) calcd for C₁₁H₂₁BNO₂ (M+H)⁺ 200.08828. found 200.08758.

### Example 4

### General Experimental Procedure to Form Azaborine-Containing Biarylcarboxamide

To the mixture of 2-chloro-4,6-dimethoxyl-1,3,5triazine (CDMT, 32 mg, 0.182 mmol) and BN-Felbinac (38 mg, 0.176 mmol, for amide 5) or compound 4 (35 mg, 0.176 mmol, for amides 6-13) in anhydrous CH₂Cl₂ (3 mL), N-methylmorpholine (NMM, 20 μL, 0.182 mmol) was added under ice-water bath. The resulted clear solution was stirred at rt for 1 hr. Then corresponding amine (1.1 eq.) was added and this mixture was stirred overnight (if this amine is in salt form, another 1 eq. NMM should also be added). The reaction mixture was purified by silica gel chromatography to afford corresponding amide products 5-13. If necessary, recrystallization in CH₂Cl₂/hexane or MeOH/CH₂Cl₂/hexane can provide desired amide compounds as off-white solid.

### Example 5

### Characterization Data for Representative Compounds

### Compound 5

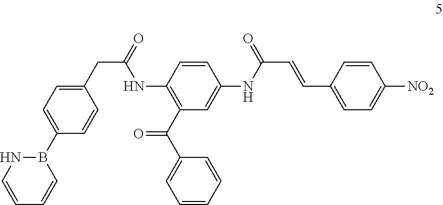 [SMILES: O=C(/C=C/c1ccc([N+](=O)[O-])cc1)Nc1ccc(NC(=O)Cc2ccc(B3C=CC=CN3)cc2)c(C(=O)c2ccccc2)c1]

¹H NMR (300 MHz, DMSO-d6) δ 10.57 (br s, 2H), 10.24 (br s, 1H), 8.29 (m, 2H), 7.73-7.79 (m, 3H), 7.58-7.71 (m, 8H), 7.48-7.55 (m, 4H), 6.99-7.16 (m, 4H), 6.37 (t, J=6.6 Hz, 1H), 3.44 (s, 2H); ¹³C NMR (126 MHz, DMSO-d6) δ 195.3, 169.4, 163.3, 148.2, 144.7, 141.7, 138.4, 137.5, 136.3, 135.9, 135.7, 133.2, 133.0, 132.3, 131.6, 130.1, 129.2, 129.1, 128.7, 126.7, 124.8, 124.6, 122.8, 120.9, 110.7, 43.1; ¹¹B NMR (96 MHz) δ 33.1.

### Compound 6

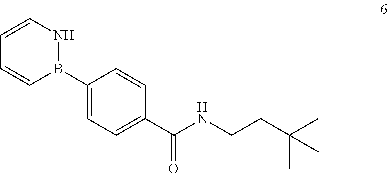 [SMILES: CC(C)(C)CCNC(=O)c1ccc(B2C=CC=CN2)cc1]

¹H NMR (500 MHz, CD₂Cl₂) δ 8.58 (br s, 1H), 7.77-7.87 (m, 5H), 7.48 (t, J=4.5 Hz, 1H), 7.20 (d, J=6.3 Hz, 1H), 6.45 (t, J=6.5 Hz, 1H), 6.20 (br s, 1H), 3.46 (m, 2H), 1.55 (m, 2H), 0.98 (s, 9H); ¹³C NMR (126 MHz, CD₂Cl₂) δ 167.0, 144.9, 135.1, 134.2, 132.3, 126.3, 111.3, 43.3, 36.6, 29.8, 29.1; ¹¹B NMR (160 MHz) δ 33.4; HRMS (DART) calcd for C₁₇H₂₄BN₂O (M+H)⁺ 283.19817. found 283.19844.

### Compound 7

(Note that the squiggly bond means that stereochemistry is undefined. This representation is understood to depict both (r) and (s) enantiomers).

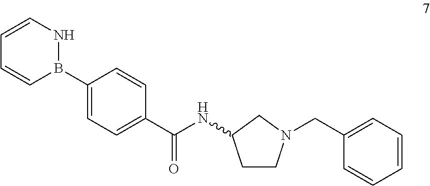 [SMILES: O=C(NC1CCN(Cc2ccccc2)C1)c1ccc(B2C=CC=CN2)cc1]

¹H NMR (500 MHz, CD₂Cl₂) δ 8.56 (br s, 1H), 7.80-7.87 (m, 4H), 7.20-7.60 (m, 8H), 6.70 (br s, 1H), 6.45 (t, J=7.0 Hz, 1H), 4.66 (br s, 1H), 3.70 (s, 2H), 2.96 (br s, 1H), 2.69-2.76 (m, 2H), 2.39 (d, J=5.0 Hz, 2H), 1.78 (br s, 1H); ¹³C NMR (126 MHz, CD₂Cl₂) δ 144.9, 134.2, 132.2, 128.8, 128.3, 126.4, 111.3, 60.6, 59.8, 52.5, 49.1, 32.5; ¹¹B NMR (160 MHz) δ 35.2; HRMS (DART) calcd for C₂₂H₂₅BN₃O (M+H)⁺ 358.20907. found 358.20858.

### Compound 8

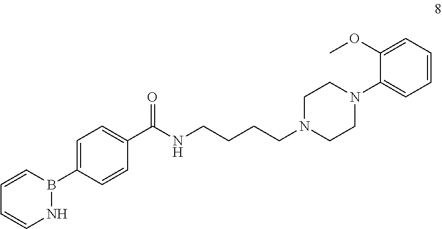 [SMILES: COc1ccccc1N1CCN(CCCCNC(=O)c2ccc(B3C=CC=CN3)cc2)CC1]

¹H NMR (500 MHz, CD₂Cl₂) δ 8.48 (br s, 1H), 7.79-7.86 (m, 4H), 7.47 (d, J=6.5 Hz, 1H), 7.20 (d, J=6.0 Hz, 1H), 6.86-6.97 (m, 4H), 6.46 (d, J=6.0 Hz, 1H), 3.82 (s, 3H), 3.43-3.48 (m, 2H), 2.96-3.20 (m, 4H), 2.44-2.78 (m, 6H), 1.67-1.80 (m, 4H); ¹³C NMR (126 MHz, CD₂Cl₂) δ167.5, 152.4, 144.8, 141.5, 135.4, 134.2, 132.3, 128.4, 126.5, 122.6, 120.9, 118.1, 111.4, 111.2, 57.9, 55.2, 50.2, 39.8, 31.6, 27.4, 24.2, 22.6, 13.9; ¹¹B NMR (160 MHz) δ 36.7; HRMS (DART) calcd for C₂₆H₃₄BN₄O₂ (M+H)⁺ 445.27748. found 445.27853.

### Compound 9

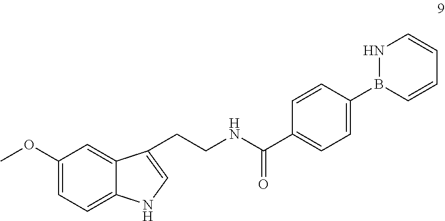 [SMILES: COc1ccc2[nH]cc(CCNC(=O)c3ccc(B4C=CC=CN4)cc3)c2c1]

¹H NMR (500 MHz, DMSO-d6) δ 10.72 (br s, 1H), 10.62 (br s, 1H), 8.56 (br s, 1H), 7.84-7.94 (m, 3H), 7.70 (br s, 1H), 7.49 (br s, 1H), 7.05-7.21 (m, 3H), 6.69 (d, J=8.5 Hz, 1H), 6.39 (br s, 1H), 3.70 (s, 3H), 3.30-3.53 (m, 2H), 2.89-2.91 (m, 2H); ¹³C NMR (126 MHz, DMSO-d6) δ 166.7, 153.4, 145.0, 136.0, 135.1, 132.8, 1331.8, 128.7, 128.1, 127.8, 127.6, 127.0, 123.7, 112.5, 112.3, 111.5, 111.2, 100.6, 56.3, 55.7, 25.7; ¹¹B NMR (160 MHz) δ 33.5; HRMS (DART) calcd for C₂₂H₂₃BN₃O₂ (M+H)⁺ 372.18833. found 372.18984.

### Compound 10

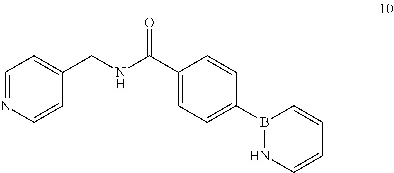 [SMILES: O=C(NCc1ccncc1)c1ccc(B2C=CC=CN2)cc1]

¹H NMR (500 MHz, CD₃OD) δ 10.20 (br s, 1H), 8.47 (s, 2H), 7.82-7.96 (m, 3H), 7.73-7.76 (m, 1H), 7.28-7.55 (m, 3H), 7.13 (d, J=10.5 Hz, 1H), 6.39 (t, J=6.0 Hz, 1H), 4.62 (s, 2H); ¹³C NMR (126 MHz, CD₃OD) δ 148.7, 144.4, 134.7, 132.2, 127.0, 126.3, 122.5, 110.7, 42.0; ¹¹B NMR (160 MHz) δ 33.6; HRMS (DART) calcd for C₁₇H₁₇BN₃O (M+H)⁺ 290.14647. found 290.14561.

### Compound 11

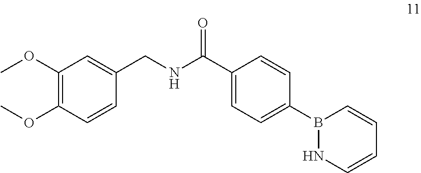 [SMILES: COc1ccc(CNC(=O)c2ccc(B3C=CC=CN3)cc2)cc1OC]

¹H NMR (500 MHz, DMSO-d6) δ 10.72 (br s, 1H), 8.92 (br s, 1H), 7.89-7.93 (m, 4H), 7.70 (br s, 1H), 7.48 (br s, 1H), 7.10 (br s, 1H), 6.84-6.84 (m, 3H), 6.39 (br s, 1H), 4.40 (s, 2H), 3.70 (s, 6H); ¹³C NMR (126 MHz, DMSO-d6) δ 166.7, 149.1, 148.2, 145.0, 136.0, 132.8, 127.8, 127.1, 119.9, 112.2, 112.0, 111.3, 111.2, 56.0, 55.9, 42.9; ¹¹B NMR (160 MHz) δ 32.9; HRMS (DART) calcd for C₂₀H₂₂BN₂O₃(M+H)⁺ 349.17235. found 349.17111.

### Compound 12

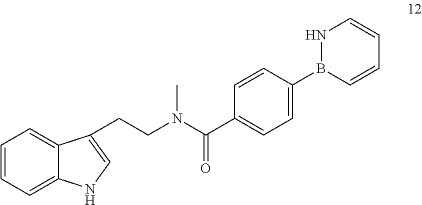 [SMILES: CN(CCc1c[nH]c2ccccc12)C(=O)c1ccc(B2C=CC=CN2)cc1]

¹H NMR (500 MHz, DMSO-d6) δ (major rotamer+minor rotamer) 10.80 (br s, 1H), 10.68 (br s, 1H), 7.85-7.89 (m, 2H), 7.68-7.72 (m, 2H), 7.48 (m, 1H), 7.22-7.35 (m, 4H), 6.90-7.09 (m, 4H), 6.68 (br s, 1H), 6.39 (t, J=5.5 Hz, 1H), 3.71 (s, 1H), 3.43 (m, 2H), 3.30 (m, 2H), 3.05 (s, 3H), 2.80 (s, 3H); ¹³C NMR (126 MHz, DMSO-d6) δ 171.4, 170.6, 145.0, 137.5, 136.6, 136.0, 132.8, 127.7, 127.4, 126.7, 126.2, 123.3, 121.3, 118.8, 118.6, 118.4, 111.8, 111.1, 110.9, 55.4, 51.9, 48.3, 37.8, 32.8, 24.5, 23.0; ¹¹B NMR (160 MHz) δ 33.9; HRMS (DART) calcd for C₂₂H₂₃BN₃O (M+H)⁺ 356.19342. found 356.19417.

### Compound 13

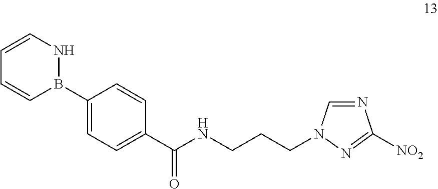 [SMILES: O=C(NCCCn1cnc([N+](=O)[O-])n1)c1ccc(B2C=CC=CN2)cc1]

¹H NMR (500 MHz, DMSO-d6) δ 10.75 (br s, 1H), 8.90 (s, 1H), 8.57 (t, J=5.0 Hz, 1H), 7.96-7.99 (m, 2H), 7.86-7.88 (m, 2H), 7.72-7.76 (m, 1H), 7.53 (t, J=7.0 Hz, 1H), 7.13 (d, J=11.5 Hz, 1H), 6.44 (m, 1H), 4.39-4.43 (m, 2H), 3.88 (s, 1H), 2.51 (s, 1H), 2.14-2.18 (m, 2H); ¹³C NMR (126 MHz, DMSO-d6) δ 167.1, 147.3 145.0, 136.0, 134.8, 132.8, 127.0, 111.3 49.0, 36.6, 29.4; ¹¹B NMR (160 MHz) δ 34.3; HRMS (DART) calcd for C₁₆H₁₈BN₆03 (M+H)⁺ 353.15334. found 353.15353.

### Example 6

### Exemplary Synthesis of Halogenated Substrate for Cross-Coupling

Below is a representative synthesis of compound (14), a viable substrate for the cross coupling to produce substituted azaborines.

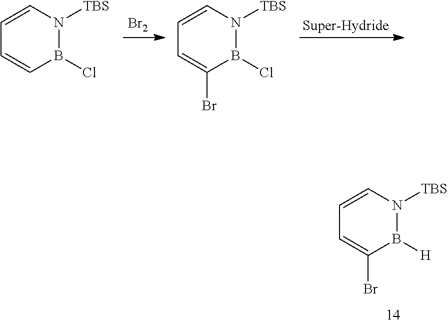

Other substrates that are also viable cross-coupling partners include:

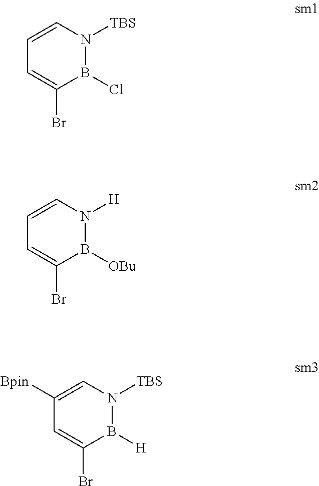

The halogenated substrate is then treated with an organozincate in the presence of a catalyst. The catalyst can be a palladium catalyst (e.g., PdCl₂(Ptol₃)₂ or Pd(PtBu₃)₂. The organozincate can be of the formula RZnX (wherein X can be a halogen such as bromine) or of the formula R₂Zn. In each case, “R” represents the organic functionality to be added to the 1,2-dihydro-1,2-azaborine scaffold at the halogenated carbon atom. In some preferred embodiments, the coupling reaction of the 1,2-dihydro-1,2-azaborine scaffold to the organic functionality is a Negishi cross-coupling. The added functionality can be a wide variety of organic substituents described and defined herein, including but not limited to alkyl, alkenyl, alkynyl or aryl (including heteroaryl) substituents. The cross-coupling reactions can be carried out according to established procedures known to one of ordinary skill in the art as well as procedures defined herein.

### Example 7

### Exemplary Cross-Coupling Procedure Using Compound (14) as a Substrate to Couple with R₂Zn or RZnX Reagents

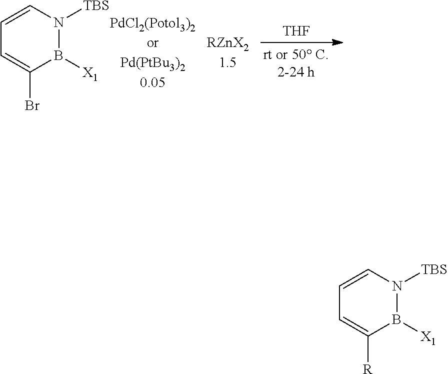

wherein R is H or an alkyl, aryl, heteroaryl, alkenyl group. X₁ can be H, a halogen, or an alkoxy, alkyl, aryl group. X₂ can be a halogen, an alkyl, aryl, heteroaryl, or alkenyl group.

### General Procedure A

In a nitrogen glovebox a pressure tube equipped with a bar of stirring was charged with 1.0 equiv. 14 (150 mg, 0.55 mmol), 1.5 equiv. appropriate zincate, and was diluted with THF to a total volume of 5 mL. 0.05 equiv. of PdCl₂(P(o-tol)₃)₂(21.7 mg, 0.028 mmol) was added in one portion and the system was sealed and allowed to react at 50° C. for 1.5 hours. The crude reaction mixture was passed through a dry plug of silica (eluent: Et₂O) and the solvent was removed. The product was isolated by silica gel chromatography.

### General Procedure B

In a nitrogen glovebox a scintillation vial equipped with a bar of stirring was charged with 1.0 equiv. 14 (150 mg, 0.55 mmol), 1.5 equiv. appropriate zincate, and was diluted with THF to a total volume of 5 mL. 0.05 equiv. of Pd(P(t-Bu)₃)₂ (14 mg, 0.028 mmol) was added in one portion and the system was sealed and allowed to react at room temperature for 24 hours. Upon completion the crude reaction mixture was passed through a dry plug of silica (eluent: Et₂O) and the solvent was removed. The products were isolated via column chromatography. Any additional or modified workup is detailed in the specific entry.

### Example 8

### Exemplary Compounds Made by Coupling Substrate with R₂Zn or RZnX Reagents

### Compound 15

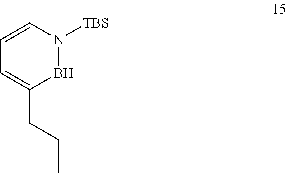

General procedure A was followed using 1.5 equiv. of a 0.5 M solution of propylzinc bromide (1.7 mL, 0.830 mmol), after the initial plug the solvent was blown down carefully with a stream of nitrogen and a pentane dry-silica plug was run in a pipette (eluent: pentane). Solvent removal yielded volatile compound 15 (116 mg, 89% yield). ¹H NMR (500 MHz, CD₂Cl₂) δ 7.32 (t, ³J_{HH}=10.5 Hz, 1H), 7.24 (d, ³J_{HH}=6.5 Hz, 1H), 6.36 (t, ³J_{HH}=6.6 Hz, 1H), 2.55-2.49 (m, 2H), 1.59 (dq, ³J_{HH}=14.6, 7.2 Hz, 2H), 1.06-0.82 (m, 12H), 0.47 (s, 6H). ¹¹B NMR (160 MHz, CD₂Cl₂) δ 34.7 (D, J_{BH}=108 Hz). The quaternary carbon adjacent to boron was not observed. HRMS (DART+) calculated for C₁₃H₂₇BNSi (M+1): 236.20058. found: 236.19986.

### Compound 16

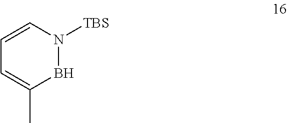

General procedure A was followed using 1.5 equiv. of a 1.0 M solution of dimethylzinc (0.830 mL, 0.830 mmol), after the initial plug the solvent was blown down carefully and an isopentane dry-silica plug was run in a pipette (eluent: isopentane). Solvent removal yielded volatile compound 16 (95.2 mg, 83% yield). ¹H NMR (500 MHz, CD₂Cl₂) δ 7.37 (d, ³J_{HH}=5.8 Hz, 1H), 7.22 (d, ³J_{HH}=6.4 Hz, 1H), 6.35 (t, ³J_{HH}=6.6 Hz, 1H), 2.27 (s, 3H), 0.92 (s, 9H), 0.47 (s, 6H). ¹¹B NMR (160 MHz, CD₂Cl₂) δ 34.7 (d, J_{BH}=115.7 Hz). ¹³C NMR (126 MHz, CD₂Cl₂) δ 141.2, 135.2, 112.5, 26.4, 22.3, 18.5, −3.9. The quaternary carbon adjacent to boron was not observed. HRMS (DART+) calculated for C₁₁H₂₃BNSi (M+1): 208.16928. found: 208.16897.

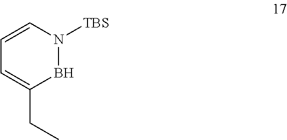

General procedure A was followed using 1.5 equiv. of a 1.0 M solution of diethylzinc (0.830 mL, 0.830 mmol), after the initial plug the solvent was blown down carefully and a pentane dry-silica plug was run in a pipette. Solvent removal yielded volatile compound 17 (93.7 mg, 77% yield). ¹H NMR (500 MHz, CD₂Cl₂) δ 7.35 (d, ³J_{HH}=6.5 Hz, 1H), 7.24 (d, ³J_{HH}=6.5 Hz, 1H), 6.37 (t, ³J_{HH}=6.6 Hz, 1H), 2.58 (q, ³J_{HH}=7.5 Hz, 2H), 1.19 (t, ³J_{HH}=7.6 Hz, 3H), 0.92 (s, 9H), 0.48 (s, 6H).

### Compound 18

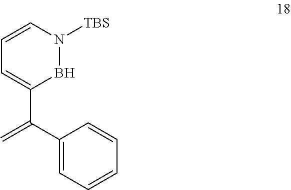

General procedure B was followed using 1.5 equiv. of a 0.5 M solution of (1-phenylvinyl)zinc bromide (1.7 mL, 0.830 mmol), after the initial plug the product was isolated via recycling preparative HPLC equipped with a Jaigel polystyrene column (eluent: Toluene) removal of solvent yielded compound 18. (153.7 mg, 94% yield). ¹H NMR (500 MHz, CD₂Cl₂) δ 7.56-7.18 (m, 7H), 6.44 (dd, ³J_{HH}=8.3, 5.0 Hz, 1H), 5.50 (d, ³J_{HH}=1.9 Hz, 1H), 5.31 (d, ³J_{HH}=1.9 Hz, 1H), 0.93 (s, 9H), 0.49 (s, 6H). ¹³C NMR (126 MHz, CD₂Cl₂) δ 153.8, 143.6, 141.7, 137.8, 128.8, 128.5, 127.7, 112.6, 112.4, 26.4, 18.5, −3.9. The quaternary carbon adjacent to boron was not observed. HRMS (DART+) calculated for C₁₈H₂₇BNSi (M+1): 296.20058. found: 296.20012.

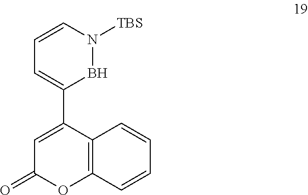

General procedure B was followed using 1.5 equiv. of a 0.5 M solution of (2-oxo-2H-chromen-4-yl)zinc bromide (1.7 mL, 0.830 mmol), after the initial plug the solvent was switched to CH₂Cl₂ and the mixture was allowed to stir for 1.5 hours before being passed through a dry silica pipette plug (eluent: CH₂Cl₂) removal of solvent yielded 19. (136.8 mg, 73% yield). ¹H NMR (500 MHz, CD₂Cl₂) δ 7.71 (d, ³J_{HH}=7.0 Hz, 1H), 7.63-7.58 (m, 1H), 7.57 (d, ³J_{HH}=6.4 Hz, 1H), 7.55-7.49 (m, 1H), 7.35 (dd, ³J_{HH}=8.3, 0.6 Hz, 1H), 7.26-7.17 (m, 1H), 6.68-6.60 (m, 1H), 6.21 (s, ³J_{HH}=14.3 Hz, 1H), 0.92 (s, 9H), 0.49 (s, 6H). ¹³C NMR (126 MHz, CD₂Cl₂) δ 161.5, 160.4, 154.8, 143.7, 140.6, 131.8, 128.0, 124.1, 120.4, 117.4, 113.3, 26.3, 18.5, −3.9. The quaternary carbon adjacent to boron was not observed. HRMS (DART+) calculated for C₁₉H₂₅BNO₂Si (M+1): 338.17476. found: 338.17605.

### Compound 20

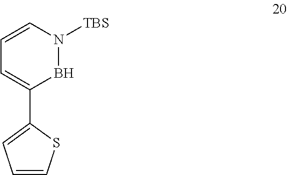

General procedure A was followed using 1.5 equiv. of a 0.5 M solution of 2-thienylzinc bromide (1.7 mL, 0.830 mmol). After the initial plug the product was purified by silica gel column chromatography (eluent pentane) yielding compound 20 as a yellow oil. (118.6 mg, 78% yield). ¹H NMR (500 MHz, CD₂Cl₂) δ 7.85-7.79 (m, 1H), 7.41-7.32 (m, 1H), 7.23 (d, ³J_{HH}=1.1 Hz, 1H), 7.22 (d, ³J_{HH}=1.1 Hz, 1H), 7.11-7.05 (m, 1H), 6.55-6.47 (m, 1H), 0.95 (s, ³J_{HH}=2.0 Hz, 9H), 0.53 (s, ³J_{HH}=1.6 Hz, 6H). ¹¹B NMR (160 MHz, CD₂Cl₂) δ 33.9 (br s). HRMS (DART+) calcd for C₁₄H₂₃BNSSi (M+1): 276.14135. found: 276.14187.

### Compound 21

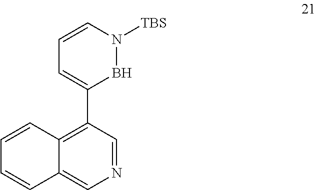

General procedure B was followed using 1.5 equiv. of a 0.5 M solution of isoquinolin-4-ylzinc bromide (1.7 mL, 0.830 mmol), after the initial plug the solvent was switched to CH₂Cl₂ and the mixture was allowed to stir for 1.5 hours before being passed through a dry silica pipette plug (eluent: CH₂Cl₂). Removal of solvent yielded compound 21. (155.5 mg, 88% yield). ¹H NMR (500 MHz, CD₂Cl₂) δ 9.47 (s, 1H), 8.48 (s, 1H), 8.17 (d, ³J_{HH}=8.1 Hz, 1H), 8.12 (d, ³J_{HH}=8.5 Hz, 1H), 7.82 (ddd, J=8.4, 6.9, 1.3 Hz, 1H), 7.73 (dd, ³J_{HH}=11.1, 4.0 Hz, 1H), 7.69 (d, ³J_{HH}=6.8 Hz, 1H), 7.56 (d, ³J_{HH}=6.0 Hz, 1H), 6.66 (t, ³J_{HH}=6.6 Hz, 1H), 0.92 (s, 9H), 0.47 (s, 6H). ¹¹B NMR (160 MHz, CD₂Cl₂) δ 34.55. ¹³C NMR (126 MHz, CD₂Cl₂) δ 150.9, 144.6, 140.7, 139.4, 139.1, 136.1, 132.9, 129.5, 129.0, 128.9, 126.2, 113.3, 26.3, 18.5, 15.7. The quaternary carbon adjacent to boron was not observed. HRMS (DART+) calculated for C₁₉H₂₆BN₂Si (M+1): 321.19583. found: 321.19567.

### Compound 22

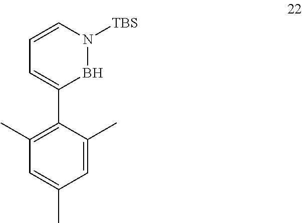

General procedure B was followed with the following modifications: 48 h reaction time with 2.5 equiv. of a 0.5 M solution of mesitylzinc iodide (2.8 mL, 1.4 mmol). The product was purified via silica gel chromatography (eluent: pentane). Removal of solvent yielded compound 22 (132.7 mg, 74% yield). ¹H NMR (500 MHz, CD₂Cl₂) δ 7.39 (d, ³J_{HH}=6.4 Hz, 1H), 7.30 (d, ³J_{HH}=6.6 Hz, 1H), 6.93 (s, 2H), 6.54 (dd, ³J_{HH}=8.2, 5.0 Hz, 1H), 2.31 (s, 3H), 2.04 (s, 6H), 0.92 (s, 9H), 0.49 (s, 6H). ¹¹B NMR (160 MHz, CD₂Cl₂) δ 33.9. ¹³C NMR (126 MHz, CD₂Cl₂) δ 142.1, 141.7, 135.8, 134.7, 134.6, 127.8, 112.2, 25.8, 21.2, 20.6, 17.9, −4.6. The quaternary carbon adjacent to boron was not observed. HRMS (DART+) calculated for C₁₉H₃₁BNSi (M+1): 312.23188. found: 312.23217.

### Compound 23

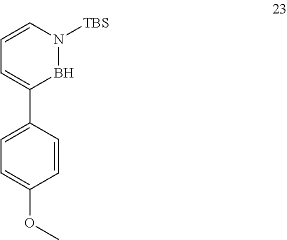

General procedure B was followed using 1.5 equiv. of a 0.5 M solution of 4-methoxyphenyl)zinc bromide (1.7 mL, 0.830 mmol), after the initial plug the solvent was switched to CH₂Cl₂ and the mixture was allowed to stir for 1.5 hours before being passed through a dry silica pipette plug (eluent: CH₂Cl₂) removal of solvent yielded compound 23. (130.5 mg, 79% yield). ¹H NMR (500 MHz, cd₂cl₂) δ 7.78 (d, ³J_{HH}=6.9 Hz, 1H), 7.60 (d, ³J_{HH}=8.9 Hz, 2H), 7.40 (d, ³J_{HH}=6.3 Hz, 1H), 6.97 (d, ³J_{HH}=8.9 Hz, 2H), 6.55 (t, ³J_{HH}=6.7 Hz, 1H), 3.86 (s, 3H), 0.96 (s, 9H), 0.54 (s, 6H). ¹¹B NMR (160 MHz, CD₂Cl₂) δ 34.2. ¹³C NMR (126 MHz, CD₂Cl₂) δ 158.9, 138.9, 137.4, 136.9, 128.3, 114.5, 113.1, 55.8, 26.4, 18.5, −3.9. The quaternary carbon adjacent to boron was not observed. HRMS (DART+) calculated for C₁₉H₂₇BNOSi (M+1): 300.19550. found: 300.19536.

### Compound 24

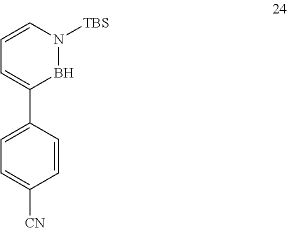

General procedure B was followed using 1.5 equiv. of a 0.5 M solution of (4-cyanophenyl)zinc bromide (1.7 mL, 0.830 mmol), after the initial plug the solvent was switched to CH₂Cl₂ and the mixture was allowed to stir for 1.5 hours before being passed through a dry silica pipette plug (eluent: CH₂Cl₂) removal of solvent yielded compound 24. (151.3 mg, 93% yield). ¹H NMR (500 MHz, CD₂Cl₂) δ 7.89 (dd, ³J_{HH}=6.2, 0.9 Hz, 1H), 7.76 (d, ³J_{HH}=8.6 Hz, 2H), 7.69 (d, ³J_{HH}=8.6 Hz, 2H), 7.52 (d, ³J_{HH}=6.4 Hz, 1H), 6.69-6.56 (m, 1H), 0.95 (s, 9H), 0.54 (s, 6H). ¹¹B NMR (160 MHz, CD₂Cl₂) δ 34.1. ¹³C NMR (126 MHz, CD₂Cl₂) δ 149.7, 141.4, 139.5, 132.8, 127.9, 120.0, 113.2, 109.6, 26.3, 18.4, −3.9. The quaternary carbon adjacent to boron was not observed. HRMS (DART+) calculated for C₁₇H₂₄BN₂Si (M+1): 295.18018. found: 295.18067.

### Compound 25

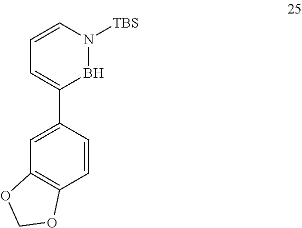

General procedure B was followed using 1.5 equiv. of a 0.5 M solution of benzo[d][1,3]dioxol-5-ylzinc bromide (1.7 mL, 0.830 mmol), after the initial plug the solvent was switched to CH₂Cl₂ and the mixture was allowed to stir for 1.5 hours before being passed through a dry silica pipette plug (eluent: CH₂Cl₂) removal of solvent yielded compound 25. (169.7 mg, 98% yield). ¹H NMR (500 MHz, CD₂Cl₂) δ 7.75 (dd, ³J_{HH}=6.9, 0.9 Hz, 1H), 7.40 (d, ³J_{HH}=6.3 Hz, 1H), 7.19-7.12 (m, 2H), 6.88 (d, ³J_{HH}=8.0 Hz, 1H), 6.55 (t, ³J_{HH}=6.7 Hz, 1H), 6.00 (s, 2H), 0.95 (s, 9H), 0.53 (s, 6H). ¹¹B NMR (160 MHz, CD₂Cl₂) δ 34.0. ¹³C NMR (126 MHz, CD₂Cl₂) δ 148.6, 146.6, 139.3, 139.2, 137.3, 120.6, 113.0, 108.8, 107.8, 101.6, 26.4, 18.5, 1.4. The quaternary carbon adjacent to boron was not observed. HRMS (DART+) calculated for C₁₇H₂₅BNO₂Si (M+1): 314.17476. found: 314.17412.

### Compound 26

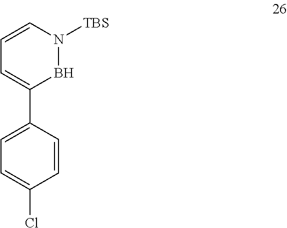

General procedure B was followed using 1.5 equiv. of a 0.5 M solution of 4-chloro-phenylzinc iodide (1.7 mL, 0.830 mmol), after the initial plug the solvent was switched to CH₂Cl₂ and the mixture was allowed to stir for 1.5 hours before being passed through a dry silica pipette plug (eluent: CH₂Cl₂). Removal of solvent yielded compound 26. (149.9 mg, 89% yield). ¹H NMR (500 MHz, CD₂Cl₂) δ 7.82 (d, ³J_{HH}=6.9 Hz, 1H), 7.64-7.57 (m, 2H), 7.46 (t, ³J_{HH}=7.1 Hz, 1H), 7.41-7.34 (m, 2H), 6.58 (t, ³J_{HH}=6.7 Hz, 1H), 0.95 (s, 9H), 0.53 (s, 6H). ¹¹B NMR (160 MHz, CD₂Cl₂) δ 34.2. ¹³C NMR (126 MHz, CD₂Cl₂) δ 143.5, 140.1, 138.2, 132.1, 128.9, 128.7, 113.1, 26.4, 18.4, −3.9. The quaternary carbon adjacent to boron was not observed. HRMS (DART+) calculated for C₁₆—H₂₄BClNSi (M+1): 304.14596. found: 304.14596.

### Compound 27

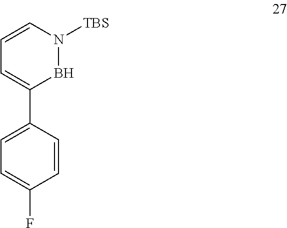

General procedure B was followed using 1.5 equiv. of a 0.5 M solution of 4-fluoro phenylzincbromide (1.7 mL, 0.830 mmol), after the initial plug the product was isolated via recycling preparative HPLC equipped with a Jaigel polystyrene column (eluent: Toluene) removal of solvent yielded white crystalline 27. (87.7 mg, 55% yield). ¹H NMR (500 MHz, CD₂Cl₂) δ 7.74 (d, ³J_{HH}=7.0 Hz, 1H), 7.64-7.48 (m, 2H), 7.39 (d, ³J_{HH}=6.3 Hz, 1H), 7.06 (t, ³J_{HH}=8.7 Hz, 2H), 6.52 (t, ³J_{HH}=6.7 Hz, 1H), 0.91 (s, 9H), 0.49 (s, 6H). ¹¹B NMR (160 MHz, CD₂Cl₂) δ 34.2. HRMS (DART+) calculated for C₁₆H₂₄BFNSi (M+1): 288.17551. found: 288.17497.

### Compound 28

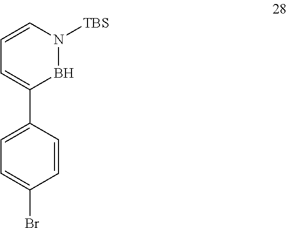

General procedure B was followed using 1.5 equiv. of a 0.5 M solution of p-Br phenylzinciodide (1.7 mL, 0.830 mmol), after the initial plug the after the initial plug the product was isolated via recycling preparative HPLC equipped with a Jaigel polystyrene column (eluent: Toluene) removal of solvent yielded off-white crystalline 28. (111 mg, 58% yield). ¹H NMR (500 MHz, CD₂Cl₂) δ 7.85 (d, ³J_{HH}=6.9 Hz, 1H), 7.70 (dd, ³J_{HH}=8.5, 2.1 Hz, 2H), 7.64-7.46 (m, 5H), 7.42 (d, ³J_{HH}=5.9 Hz, 1H), 6.56 (td, ³J_{HH}=6.7, 2.1 Hz, 1H), 0.92 (s, 9H), 0.51 (s, 6H). ¹¹B NMR (160 MHz, CD₂Cl₂) δ 34.0. ¹³C NMR (126 MHz, CD₂Cl₂) δ 143.9, 140.2, 138.3, 131.9, 129.2, 120.3, 113.2, 26.4, 18.5, −3.9. The quaternary carbon adjacent to boron was not observed. HRMS (DART+) calculated for C₁₆H₂₄BBrNSi (M+1): 348.09544. found: 348.09466.

### Compound 29

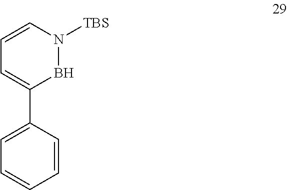

General procedure B was followed using 1.5 equiv. of a 0.5 M solution of phenylzincbromide (1.7 mL, 0.830 mmol), after the initial plug the product was isolated via recycling preparative HPLC equipped with a Jaigel polystyrene column (eluent: Toluene) removal of solvent yielded off-white crystalline compound 29. (102.1 mg, 69% yield). ¹H NMR (500 MHz, CD₂Cl₂) δ 7.82 (d, ³J_{HH}=6.9 Hz, 1H), 7.64-7.57 (m, 2H), 7.46 (t, ³J_{HH}=7.1 Hz, 1H), 7.41-7.34 (m, 2H), 6.58 (t, ³J_{HH}=6.7 Hz, 1H), 0.95 (s, 9H), 0.53 (s, 6H). ¹¹B NMR (160 MHz, CD₂Cl₂) δ 34.2. ¹³C NMR (126 MHz, CD₂Cl₂) δ 143.5, 140.1, 138.2, 132.1, 128.9, 128.7, 113.1, 26.4, 18.4, −3.9. The quaternary carbon adjacent to boron was not observed. HRMS (DART+) calculated for C₁₆H₂₅BNSi (M+1): 270.18493. found: 270.18420.

### Compound 30

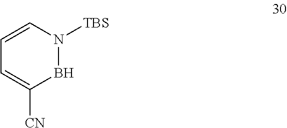

A unique procedure was followed for this compound based upon standard prep B. To one equivalent of compound 1 (150 mg, 0.552 mmole) was added 1.02 equiv. of dicyanozinc (66.1 mg, 0.565 mmole), 1 equiv. of N-methylimidazole (45 mg, 0.552 mmole). This mixture was diluted to 5 ml in THF, to this was added in one portion 0.05 equiv. of Pd(P(t-Bu)₃)₂ (14 mg, 0.028 mmol).

The mixture was allowed to stir at room temperature for 36 hours upon which it was run through a plug of silica (eluent: Et₂O). The yellow solution was dissolved in methylene chloride and allowed to stir for 1 hour upon which it was run through another plug of silica yielding compound 30 upon solvent removal as a yellow solid. (98.6 mg, 82% yield). ¹H NMR (500 MHz, CD₂Cl₂) δ 8.06 (d, J=7.0 Hz, 1H), 7.69 (d, ³J_{HH}=6.3 Hz, 1H), 6.64 (t, ³J_{HH}=6.7 Hz, 1H), 0.92 (d, 9H), 0.52 (d, 6H). ¹¹B NMR (160 MHz, CD₂Cl₂) δ 34.6. ¹³C NMR (126 MHz, CD₂Cl₂) δ 151.18, 143.92, 123.31, 113.20, 26.12, 18.29, −4.14. The quaternary carbon adjacent to boron was not observed. HRMS (DART+) calculated for C₁₁H₂₀BN₂Si (M+1): 219.14888. found: 219.14871.

### Compound 31

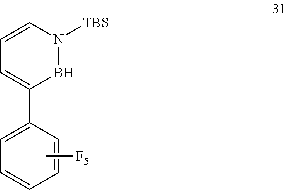

General procedure B was followed using 1.5 equiv. of bis(pentafluorophenyl) zinc (1.7 mL, 0.830 mmol), after the initial plug the solvent was switched to CH₂Cl₂ and the mixture was allowed to stir for 1.5 hours before being passed through a dry silica pipette plug (eluent: CH₂Cl₂) removal of solvent yielded crystalline compound 31. (166.8 mg, 84% yield). ¹H NMR (500 MHz, CD₂Cl₂) δ 7.73 (d, ³J_{HH}=6.9 Hz, 1H), 7.55 (d, ³J_{HH}=6.4 Hz, 1H), 6.65 (t, ³J_{HH}=6.7 Hz, 1H), 0.95 (s, 9H), 0.53 (s, 6H). ¹¹B NMR (160 MHz, CD₂Cl₂) δ 34.2. HRMS (DART+) calculated for C₁₆H₂₀BF₅NSi (M+1): 360.13782. found: 360.13912.

### Compound 32

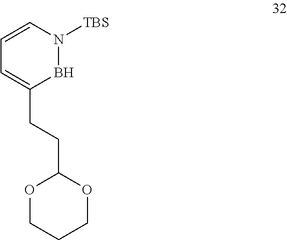

General procedure B was followed using 1.5 equiv. of a 0.5 M solution of the zincate shown (1.7 mL, 0.830 mmol), after the initial plug the product was isolated via recycling preparative HPLC equipped with a Jaigel polystyrene column (eluent: Toluene) removal of solvent yielded compound 32 (101 mg, 60% yield). ¹H NMR (500 MHz, CD₂Cl₂) δ 7.33 (d, J=6.5 Hz, 1H), 7.22 (d, J=6.4 Hz, 1H), 6.34 (t, J=6.6 Hz, 1H), 4.53 (t, J=5.2 Hz, 1H), 4.11-4.04 (m, 2H), 3.80-3.69 (m, 2H), 2.63-2.54 (m, 2H), 2.04 (dtt, J=17.5, 12.5, 5.0 Hz, 1H), 1.84-1.75 (m, 2H), 1.33 (dtt, J=13.4, 2.6, 1.4 Hz, 1H), 0.89 (s, 9H), 0.45 (s, 6H). ¹¹B NMR (160 MHz, CD₂Cl₂) δ 34.4. ¹³C NMR (126 MHz, CD₂Cl₂) δ 140.7, 135.5, 112.3, 102.4, 67.2, 38.1, 31.3, 26.4, 26.2, 18.2, −4.1. The quaternary carbon adjacent to boron was not observed. HRMS (DART+) calculated for C₁₆H₃₁BNO₂Si (M+1): 308.22171. found: 308.22158.

### Compound 33

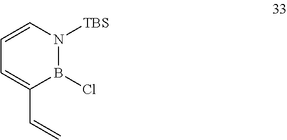

A unique procedure was followed for this compound based upon standard prep B. Vinylzincbromide was prepared by stirring 1.2 equiv. vinylmagnesium bromide (7.8 mL of 1M solution in THF, 7.8 mmole) with 2.4 equiv. zinc bromide (3.53 g, 15.7 mmole) in 125 mL THF for 2 hours at room temperature. 1 equiv. of sm1 (2 g, 6.54 mmole) and 0.05 equiv. of Pd(P(t-Bu)₃)₂ were combined in c.a. 20 mL of THF and added to the suspension dropwise. The mixture was allowed to stir at room temperature in a glovebox for 24 h. 125 mL of pentane was added to this suspension and this mixture was filtered. Solvent was removed and the resulting oil was triturated with 25 mL of pentane. The pentane suspension was filtered through an Acros syringe filter and solvent was removed leaving a brown oil. Short-path vacuum distillation (300 mTorr, 85-100° C.) yielded 33 as a clear colorless oil in a single fraction (870 mg, 52%). ¹H NMR (500 MHz, CD₂Cl₂) δ 7.68 (d, J=6.7 Hz, 1H), 7.25 (d, J=6.6 Hz, 1H), 6.93 (dd, J=17.6, 10.9 Hz, 1H), 6.35 (t, J=6.7 Hz, 1H), 5.59 (dd, J=17.6, 1.7 Hz, 1H), 5.10 (dd, J=10.9, 1.7 Hz, 1H), 0.95 (s, 9H), 0.56 (s, 6H). ¹¹B NMR (160 MHz, CD₂Cl₂) δ 34.9. ¹³C NMR (126 MHz, CD₂Cl₂) δ 140.5, 139.1, 138.2, 112.9, 111.9, 27.0, 19.8, −1.1. The quaternary carbon adjacent to boron was not observed. HRMS (DART+) calculated for C₁₂H₂₂BClNSi (M+1): 254.13031. found: 254.13037.

### Compound 34

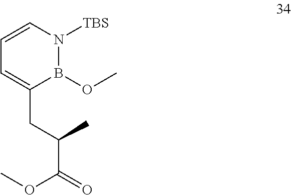

A unique procedure was followed for this compound based upon standard prep B. 1 Equiv. of sm4 (150 mg, 0.497 mmole) was dissolved in 2 mL of THF. To this mixture was added 0.05 equiv. (12.5 mg, 0.0249 mmole) of Pd(P^{t}Bu₃)₂ in 1 mL THF followed by 1.5 equiv. of (S)-(3-methoxy-2-methyl-3-oxopropyl)zinc(II) bromide (1.5 mL of 0.5 M solution in THF, 0.75 mmole). The mixture was stirred for 16 hours. Upon completion, the volatiles were removed under reduced pressure followed by column chromatography (˜40 mL silica gel, eluent: CH₂Cl₂). (colorless oil: 113.4 mg, 71% yield). ¹H NMR (500 MHz, CD₂Cl₂) δ 7.11 (d, J=6.1 Hz, 1H), 6.93-6.91 (m, 1H), 5.80 (t, J=6.5 Hz, 1H), 3.87-3.78 (m, 3H), 3.61-3.53 (m, 3H), 3.02-2.86 (m, 1H), 2.68-2.35 (m, 2H), 1.11 (d, J=6.7 Hz, 3H), 0.88 (s, 9H), 0.34 (s, 6H). ¹¹B NMR (160 MHz, CD₂Cl₂) δ 30.2 (s). ¹³C NMR (126 MHz, CD₂Cl₂) δ 177.3, 146.7, 137.3, 106.7, 53.2, 51.8, 42.3, 40.1, 27.1, 19.2, 17.0, −2.6. The quaternary carbon adjacent to boron was not observed. HRMS (DART+) calculated for C₁₆H₃₁BNO₃Si (M+1): 324.21662. found: 324.21690.

### Example 9

### Representative Procedure for Cross Coupling of Compound Sm1 Followed by In-Situ Nucleophilic Substitution of Boron

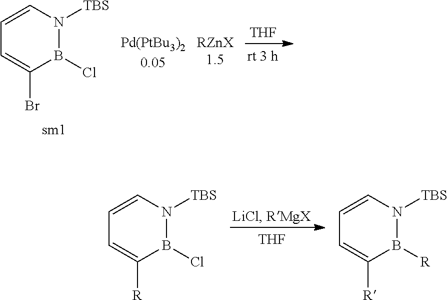

R can be alkyl, aryl, heteroaryl, or alkenyl.
R′ can be alkyl, aryl, heteroaryl, alkenyl, or allyl.

Representative Procedure 1 Equiv. of sm1 (200 mg, 0.653 mmole) was dissolved in 3 mL of THF. To this mixture was added 0.05 equiv. (17.0 mg, 0.0326 mmole) of Pd(P^{t}Bu₃)₂ in 1 mL THF followed by 1.5 equiv. of appropriate RZnX. The mixture was stirred for 3 hours and 0.5 mL of CH₂Cl₂ was added followed by 0.2 mL of TMEDA (1.3 mmole). After 15 minutes the reaction was concentrated under reduced pressure. The remaining oily solids were triturated with four portions of −2 mL of pentane and filtered. Upon solvent removal nmr analysis showed clean conversion to the C3 substituted B—Cl compound. 2 Equiv. of lithium bromide (120 mg, 1.33 mmole) was added to the B—Cl compound and was dissolved in 3 mL THF. 1.5 equiv. of methyl magnesium bromide solution (0.35 mL of 3M solution in Et₂O) was added and was stirred for 30 minutes. The reaction mixture was passed directly through a plug of silica (˜35 mL silica gel, eluent: Et₂O) and concentrated. The remaining oil was purified by column chromatography.

### Example 10

### Representative Compounds Synthesized by In Situ Quench Procedure

### Compound 35

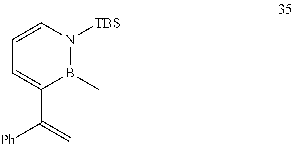

1 Equiv. of sm1 (200 mg, 0.653 mmole) was dissolved in 3 mL of THF. To this mixture was added 0.05 equiv. (17.0 mg, 0.0326 mmole) of Pd(P^{t}Bu₃)₂ in 1 mL THF followed by 1.5 equiv. of (1-phenylvinyl)zinc(II) bromide (2.0 mL of 0.5 M solution in THF, 1.0 mmole). The mixture was stirred for 3 hours and 0.5 mL of CH₂Cl₂ was added followed by 0.2 mL of TMEDA (1.3 mmole).

After 15 minutes the reaction was concentrated under reduced pressure. The remaining oily solids were triturated with three portions of ˜2 mL of pentane and filtered. Upon solvent removal nmr analysis showed clean conversion to the C3 substituted B—Cl compound. 2 equiv. of lithium bromide (120 mg, 1.33 mmole) was added to the B—Cl compound and was dissolved in 3 mL THF. 1.5 equiv. of methyl magnesium bromide solution (0.35 mL of 3M solution in Et₂O) was added and was stirred for 30 minutes. The reaction mixture was passed directly through a plug of silica (˜35 mL silica, eluent: CH₂Cl₂) and concentrated. The remaining oil was purified by column chromatography (silica gel, eluent: CH₂Cl₂). (yellow oil: 193.2 mg, 96% yield, a second run gave 199 mg, 98% yield). ¹H NMR (500 MHz, CD₂Cl₂) δ 7.33-7.18 (m, 7H), 6.24 (t, J=6.7 Hz, 1H), 5.44 (d, J=1.9 Hz, 1H), 5.00 (t, J=3.7 Hz, 1H), 0.90 (s, 9H), 0.44 (s, 6H), 0.41 (s, 3H). ¹¹B NMR (160 MHz, CD₂Cl₂) δ 40.2 (s). ¹³C NMR (126 MHz, CD₂Cl₂) δ 155.1, 143.4, 141.4, 138.7, 128.5, 127.6, 127.4, 111.5, 110.5, 26.9, 19.8, −1.0. The carbons adjacent to boron were not observed. HRMS (DART+) calculated for C₁₉H₂₉BNSi (M+1): 310.21623. found: 310.21612.

### Compound 36

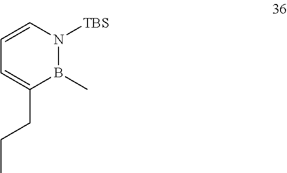

1 Equiv. of sm1 (200 mg, 0.653 mmole) was dissolved in 3 mL of THF. To this mixture was added 0.05 equiv. (17.0 mg, 0.0326 mmole) of Pd(P^{t}Bu₃)₂ in 1 mL THF followed by 1.5 equiv. of propylzinc bromide (2.0 mL of 0.5 M solution in THF, 1.0 mmole). The mixture was stirred for 3 hours and 0.5 mL of CH₂Cl₂ was added followed by 0.2 mL of TMEDA (1.3 mmole). After 15 minutes the reaction was concentrated under reduced pressure. The remaining oily solids were triturated with four portions of ˜2 mL of pentane and filtered. Upon solvent removal nmr analysis showed clean conversion to the C3 substituted B—Cl compound. 2 equiv. of lithium bromide (120 mg, 1.33 mmole) was added to the B—Cl compound and was dissolved in 3 mL THF. 1.5 equiv. of methyl magnesium bromide solution (0.35 mL of 3M solution in Et₂O) was added and was stirred for 30 minutes. The reaction mixture was passed directly through a plug of silica (˜35 mL silica gel, eluent: Et₂O) and concentrated. The remaining oil was purified by column chromatography (˜3 mL silica gel, eluent: pentane). (colorless oil: 122 mg, 75% yield, a second run gave 127 mg, 78% yield) ¹H NMR (500 MHz, CD₂Cl₂) δ 7.16-7.09 (m, 2H), 6.12 (t, J=6.6 Hz, 1H), 2.47-2.37 (m, 2H), 1.50-1.41 (m, 2H), 1.05-0.81 (m, 12H), 0.74 (s, 3H), 0.46 (s, 3H). ¹¹B NMR (160 MHz, CD₂Cl₂) δ 40.5 (s). ¹³C NMR (126 MHz, CD₂Cl₂) δ 139.4, 136.5, 110.5, 38.5, 26.9, 25.2, 19.8, 14.6, −0.9. The carbons adjacent to boron were not observed. HRMS (DART+) calculated for C₁₄H₂₉BNSi (M+1): 250.21623. found: 250.21640.

### Compound 37

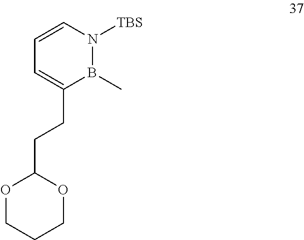

1 Equiv. of sm1 (200 mg, 0.653 mmole) was dissolved in 3 mL of THF. To this mixture was added 0.05 equiv. (17.0 mg, 0.0326 mmole) of Pd(P^{t}Bu₃)₂ in 1 mL THF followed by 1.5 equiv. of (2-(1,3-dioxan-2-yl)ethyl)zinc bromide (2.0 mL of 0.5 M solution in THF, 1.0 mmole). The mixture was stirred for 3 hours and 0.5 mL of CH₂Cl₂ was added followed by 0.2 mL of TMEDA (1.3 mmole). After 15 minutes the reaction was concentrated under reduced pressure. The remaining oily solids were triturated with four portions of ˜2 mL of pentane and filtered. Upon solvent removal nmr analysis showed clean conversion to the C3 substituted B—Cl compound. 2 Equiv. of lithium bromide (120 mg, 1.33 mmole) was added to the B—Cl compound and was dissolved in 3 mL THF. 1.5 equiv. of methyl magnesium bromide solution (0.35 mL of 3M solution in Et₂O) was added and was stirred for 30 minutes. The reaction mixture was passed directly through a plug of silica (˜35 mL silica gel, eluent: Et₂O) and concentrated. The remaining oil was purified by column chromatography (˜3 mL silica gel, eluent: CH₂Cl₂). (colorless oil: 135.4 mg, 65% yield, a second run gave 140.2 mg, 67% yield) ¹H NMR (500 MHz, CD₂Cl₂) δ 7.17-7.09 (m, 2H), 6.12 (t, J=6.6 Hz, 1H), 4.50 (t, J=5.2 Hz, 1H), 4.06 (dd, J=10.7, 5.0 Hz, 2H), 3.73 (td, J=12.3, 2.2 Hz, 2H), 2.55-2.43 (m, 2H), 2.11-1.89 (m, 1H), 1.72-1.58 (m, 2H), 1.32 (dd, J=13.4, 1.2 Hz, 1H), 0.91 (s, 9H), 0.74 (s, 3H), 0.46 (s, 6H). ¹¹B NMR (160 MHz, CD₂Cl₂) δ 40.5 (s). ¹³C NMR (126 MHz, CD₂Cl₂) δ 139.5, 136.7, 110.5, 102.8, 67.4, 37.4, 30.3, 26.9, 26.6, 19.7, −0.9. The carbons adjacent to boron were not observed. HRMS (DART+) calculated for C₁₇H₃₃BNO₂Si (M+1): 322.23736. found: 322.23852.

### Compound 38

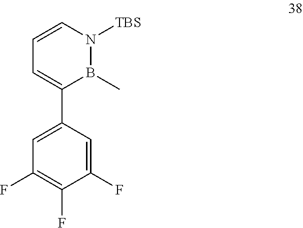

1 Equiv. of sm1 (200 mg, 0.653 mmole) was dissolved in 3 mL of THF. To this mixture was added 0.05 equiv. (17.0 mg, 0.0326 mmole) of Pd(P^{t}Bu₃)₂ in 1 mL THF followed by 1.5 equiv. of (3,4,5-trifluorophenyl)zinc bromide (2.0 mL of 0.5 M solution in THF, 1.0 mmole). The mixture was stirred for 3 hours and 0.5 mL of CH₂Cl₂ was added followed by 0.2 mL of TMEDA (1.3 mmole). After 15 minutes the reaction was concentrated under reduced pressure. The remaining oily solids were triturated with four portions of ˜2 mL of pentane and filtered. Upon solvent removal nmr analysis showed clean conversion to the C3 substituted B—Cl compound. 2 Equiv. of lithium bromide (120 mg, 1.33 mmole) was added to the B—Cl compound and was dissolved in 3 mL THF. 0.92 equiv. of methyl magnesium bromide solution (0.20 mL of 3M solution in Et₂O) was added and was stirred for 30 minutes. The reaction mixture was passed directly through a plug of silica (˜35 mL silica gel, eluent: Et₂O) and concentrated. The remaining oil was purified by column chromatography (˜3 mL silica gel, eluent: CH₂Cl₂). (colorless oil: 195.0 mg, 89% yield, a second run gave 195.1 mg, 89% yield) ¹H NMR (600 MHz, CD₂Cl₂) δ 7.37 (dd, J=6.8, 1.1 Hz, 1H), 7.32 (dd, J=6.7, 1.1 Hz, 1H), 6.89-6.83 (m, 2H), 6.31 (t, J=6.7 Hz, 1H), 0.95 (s, 9H), 0.75 (s, 3H), 0.51 (s, 6H). ¹¹B NMR (192 MHz, CD₂Cl₂) δ 39.7 (s). ¹³C NMR (151 MHz, cd₂cl₂) δ 151.9 (dd, J=9.9, 4.3 Hz), 150.4 (dd, J=9.8, 4.5 Hz), 143.7 (s), 141.9 (s), 139.8 (s), 112.9 (dd, J=16.3, 4.0 Hz), 110.6 (s), 26.9 (s), 19.8 (s), −0.9 (s). The carbons adjacent to boron were not observed. HRMS (DART+) calculated for C₁₇H₂₄BF₃NSi (M+1): 338.17232. found: 338.17327.

### Compound 39

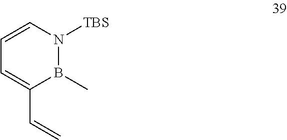

Vinylzinc bromide was generated from 1.02 equiv. vinylmagnesium bromide (660 μL of a 1 M solution, 0.660 mmole) and 2.04 equiv. Zinc Bromide (305 mg, 1.33 mmole) in 10 mL THF. In a separate vial 1 Equiv. of sm1 (200 mg, 0.653 mmole) was dissolved in 5 mL of THF. To this mixture was added 0.05 equiv. (17.0 mg, 0.0326 mmole) of Pd(P^{t}Bu₃)₂ in 1 mL THF. The azaborine/catalyst mixture was rinsed into the vinylzincbromide slurry with an additional 2 mL of THF (total volume ˜17 mL THF). The mixture was stirred for 20 hours and the reaction was diluted with 30 mL pentane and filtered and 0.5 mL of CH₂Cl₂ was added to quench the remaining catalyst. Upon solvent removal and a second pentane filtration, nmr analysis showed relatively clean conversion to the C3 substituted B—Cl compound. 2 Equiv. of lithium bromide (120 mg, 1.33 mmole) was added to the B—Cl compound and was dissolved in 3 mL THF. 1.15 equiv. of methyl magnesium bromide solution (0.25 mL of 3M solution in Et₂O) was added and was stirred for one hour. The reaction mixture was passed directly through a plug of alumina (˜35 mL silica gel, eluent: Et₂O) and concentrated. The remaining oil was purified by column chromatography (˜1.5 mL alumina, eluent: pentane). (colorless oil: 74.8 mg, 48% yield, a second run gave 81.2 mg, 53% yield) ¹H NMR (600 MHz, CD₂Cl₂) δ 7.50 (d, J=6.7 Hz, 1H), 7.26 (d, J=6.7 Hz, 1H), 6.91 (dd, J=17.5, 10.8 Hz, 1H), 6.23 (t, J=6.7 Hz, 1H), 5.37 (dd, J=17.5, 2.0 Hz, 1H), 5.01 (dd, J=10.8, 1.9 Hz, 1H), 0.94 (s, 9H), 0.82 (s, 3H), 0.48 (s, 6H). ¹¹B NMR (192 MHz, CD₂Cl₂) δ 40.3 (s). ¹³C NMR (151 MHz, CD₂Cl₂) δ140.9, 138.9, 137.8, 111.7, 110.9, 26.9, 19.7, −0.9. The carbons adjacent to boron were not observed HRMS (DART+) calculated for C₁₃H₂₅BNSi (M+1): 234.18493. found: 234.18529.

### Compound 40

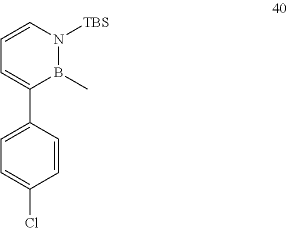

1 Equiv. of sm1 (200 mg, 0.653 mmole) was dissolved in 3 mL of THF. To this mixture was added 0.05 equiv. (17.0 mg, 0.0326 mmole) of Pd(P^{t}Bu₃)₂ in 1 mL THF followed by 1.5 equiv. of (4-chlorophenyl)zinc iodide (2.0 mL of 0.5 M solution in THF, 1.0 mmole). The mixture was stirred for 3 hours and 0.5 mL of CH₂Cl₂ was added followed by 0.2 mL of TMEDA (1.3 mmole). After 15 minutes the reaction was concentrated under reduced pressure. The remaining oily solids were triturated with four portions of ˜2 mL of pentane and filtered. Upon solvent removal nmr analysis showed conversion to the C3 substituted B—Cl compound. 2 Equiv. of lithium bromide (120 mg, 1.33 mmole) was added to the B—Cl compound and was dissolved in 3 mL THF. 1.5 equiv. of methyl magnesium bromide solution (0.3 mL of 3M solution in Et₂O) was added and was stirred for one hour. The reaction mixture was passed directly through a plug of silica (˜35 mL silica gel, eluent: Et₂O) and concentrated. The remaining oil was purified by column chromatography. (white solid: 106.0 mg, 51% yield, a second run gave 104.4 mg, 50% yield) ¹H NMR (400 MHz, CD₂Cl₂) δ7.36-7.25 (m, 4H), 7.23-7.16 (m, 2H), 6.31 (t, J=6.7 Hz, 1H), 0.95 (s, 9H), 0.74 (s, 6H), 0.51 (s, 3H). HRMS (DART+) calculated for C₁₇H₂₆BClNSi (M+1): 318.16161. found: 318.16265.

### Example 11

### Use of Compound 33 to Generate New BN-Indene and Indenyl

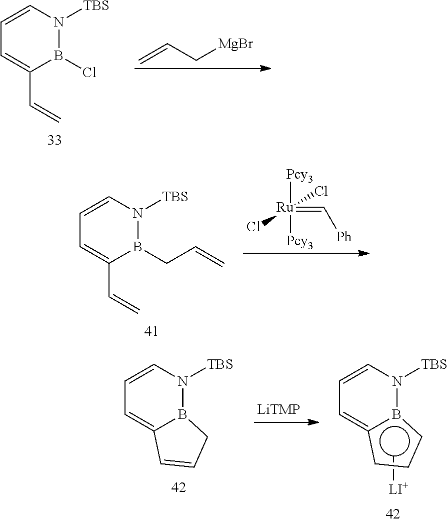

### Compound 41

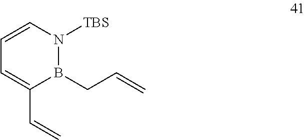

1.1 Equiv. of allylmagnesium bromide (1.0 mL of 1M solution in THF, 1.0 mmole) was added dropwise to a solution of 1 equiv. of compound 33 (231.5 mg, 0.914 mmole) in 5 mL THF at −20° C. The solution was warmed to room temperature and stirred for 2 h. The reaction was quenched with 200 μL TMS-Cl and solvent was removed. The crude mixture was triturated with pentane and filtered and the solvent was removed. (222.2 mg, 94% yield). ¹H NMR (500 MHz, CD₂Cl₂) δ 7.62 (d, J=6.7 Hz, 1H), 7.30 (d, J=6.7 Hz, 1H), 7.01 (dd, J=17.4, 10.7 Hz, 1H), 6.30 (t, J=6.7 Hz, 1H), 5.96 (ddt, J=16.1, 11.1, 6.8 Hz, 1H), 5.42 (dd, J=17.4, 1.9 Hz, 1H), 5.00 (dd, J=10.7, 1.8 Hz, 1H), 4.96-4.87 (m, 2H), 2.30 (d, J=6.8 Hz, 2H), 0.92 (s, 9H), 0.53 (s, 6H). ¹¹B NMR (160 MHz, CD₂Cl₂) δ 39.1. ¹³C NMR (126 MHz, CD₂Cl₂) δ 140.4, 139.0, 138.3, 138.2, 115.1, 111.6, 111.8, 26.9, 19.5, −0.8. The carbons adjacent to boron were not observed. HRMS (DART+) calculated for C₁₅H₂₇BNSi (M+1): 260.20058. found: 260.20166.

### Compound 42

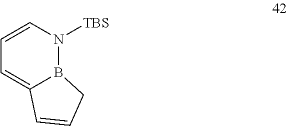

1 Equiv. of compound 34 (92.5 mg, 0.357 mmole) was dissolved in 5 mL of CH₂Cl₂ and 0.05 equiv. of Grubbs 1^{st} generation catalyst (15 mg, 0.0178 mmole) was added in one portion. The resulting purple solution was stirred at room temperature for 2 hours. Solvent was removed under reduced pressure and the product was isolated by filtration through neutral alumina. (eluent: pentane). (Colorless oil, 49.5 mg, 60% yield). ¹H NMR (500 MHz, CD₂Cl₂) δ 7.27 (d, J=6.1 Hz, 1H), 7.11 (d, J=6.7 Hz, 1H), 6.93-6.85 (m, 1H), 6.48-6.40 (m, 1H), 6.32 (dd, J=9.8, 3.6 Hz, 1H), 1.89 (s, J=2.4 Hz, 2H), 0.89 (s, 9H), 0.48 (s, 6H). ¹¹B NMR (160 MHz, CD₂Cl₂) δ 43.8. ¹³C NMR (126 MHz, CD₂Cl₂) δ 138.5, 136.4, 133.6, 129.2, 112.6, 26.6, 19.2, −3.7. The carbons adjacent to boron were not observed. HRMS (DART+) calculated for C₁₉H₂₃BNSi (M+1): 232.16928. found: 232.17023.

### Compound 43

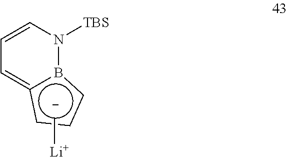

Lithium tetramethylpiperadine was generated by treatment of 1.2 equiv of 2,2-6,6-tetramethylpiperadine (40 mg, 0.283 mmole) in 1 mL THF with nBuLi (113 μL of 2.5 M solution in hexanes, 0.283 mmole) for 15 minutes with stirring resulting in a blood red solution. This solution was added in one portion to a solution of 42 in THF and stirred until completion (followed by ¹¹B nmr and completion took approximately 40 minutes). Upon completion the solvent was removed and the resulting solid was washed thoroughly with a 1:1 diethyl ether:pentane. The resulting orange solid (43.5 mg, 78%) generates a dark red solution upon dissolution in THF for analysis. Crystals suitable for x-ray diffraction were grown in a −30° C. freezer from a 1:1 mixture of THF to pentane. ¹H NMR (600 MHz, THF) δ 7.38-7.36 (m, 2H), 7.03 (d, J=6.3 Hz, 1H), 6.19 (t, J=6.4 Hz, 1H), 5.62 (dd, J=3.6, 1.1 Hz, 1H), 4.52 (d, J=5.6 Hz, 1H), 0.92 (s, 9H), 0.58 (s, 6H). ¹¹B NMR (192 MHz, THF) δ 28.8. ¹³C NMR (151 MHz, THF) δ 142.6, 126.2, 122.9, 107.3, 88.5, 26.4, 18.9, −4.1. The carbons adjacent to boron were not observed.

### Example 12

### Use of Compound 33 to Generate New Isomer of Parental BN-Napthalene

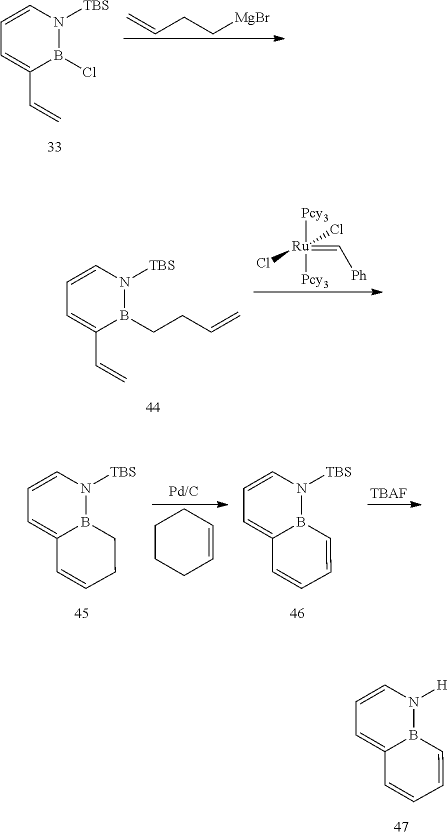

### Compound 44

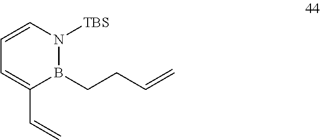

4.0 Equiv of homoallylmagnesium bromide (3 mL of 0.5M solution in Et₂O, 1.5 mmole) was added in one portion to 1 equiv. compound 33 (100 mg, 0.394 mmole) at rt. The solution was stirred for 12 h at which point approximately half of the solvent was removed and magnesium salts were precipitated with 10 mL pentane. The solvent was removed from the filtrate under reduced pressure. The product was isolated by passing through a pipette plug of silica gel (eluent: pentane). (Colorless oil, 65 mg, 60% yield). ¹H NMR (500 MHz, CD₂Cl₂) δ 7.58 (d, J=6.7 Hz, 1H), 7.26 (d, J=6.6 Hz, 1H), 6.94 (dd, J=17.4, 10.8 Hz, 1H), 6.26 (t, J=6.7 Hz, 1H), 5.96 (ddt, J=16.6, 10.2, 6.2 Hz, 1H), 5.41 (dd, J=17.3, 1.9 Hz, 1H), 5.11-4.95 (m, 2H), 4.91 (ddd, J=10.1, 1.8, 1.1 Hz, 1H), 2.17-2.00 (m, 2H), 1.45-1.36 (m, 2H), 0.91 (s, 9H), 0.50 (s, 6H). ¹¹B NMR (160 MHz, CD₂Cl₂) δ 40.2. ¹³C NMR (126 MHz, CD₂Cl₂) δ 142.34, 140.4, 138.9, 138.2, 112.7, 111.4, 111.3, 31.6, 26.9, 19.4, −0.9. The carbons adjacent to boron were not observed.

### Compound 45

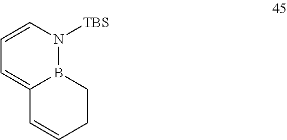

1 Equiv. of compound 44 (182.5 mg, 0.668 mmole) was dissolved in 5 mL of CH₂Cl₂ and 0.05 equiv. of Grubbs 1^{st} generation catalyst (27.4 mg, 0.0334 mmole) was added in one portion. The resulting solution was stirred at room temperature for 25 minutes. Solvent was removed under reduced pressure and the product was isolated by filtration through neutral alumina. (eluent: pentane). (Colorless oil, 116.1 mg, 71% yield). ¹H NMR (500 MHz, CD₂Cl₂) δ 7.07 (d, J=6.8 Hz, 1H), 6.94 (d, J=6.3 Hz, 1H), 6.46 (d, J=9.6 Hz, 1H), 6.16 (t, J=6.6 Hz, 1H), 5.87-5.75 (m, 1H), 2.32 (dt, J=7.6, 6.0 Hz, 2H), 1.41 (t, J=7.7 Hz, 2H), 0.94 (s, 9H), 0.44 (s, 6H). ¹¹B NMR (160 MHz, CD₂Cl₂) δ 41.5. ¹³C NMR (126 MHz, CD₂Cl₂) δ 137.0, 134.9, 132.7, 130.2, 111.6, 26.7, 24.9, 19.4, −1.8. The carbons adjacent to boron were not observed. HRMS (DART+) calculated for C₁₄H₂₅BNSi (M+1): 246.18493. found: 246.18617.

### Compound 46

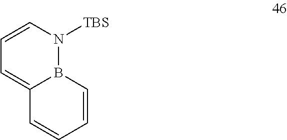

1 Equiv. of compound 45 (179 mg, 0.730 mmole) was mixed with 2 equiv. of tert-butyl ethylene (123 mg, 1.46 mmole), 2 equiv. of cyclohexene (123 mg, 1.46 mmole) and 0.05 equivalents of 10% palladium on carbon (50 mg, 0.0547 mmole) in 30 mL of toluene and refluxed for 48 hours. Upon completion the reaction was filtered and solvent was removed under reduced pressure. A significant amount of fully reduced product was observed (¹¹B NMR ˜40). Compound 46 was isolated by column chromatography (neutral alumina, ˜40 mL) (76.8 mg, 43%). ¹H NMR (500 MHz, CD₂Cl₂) δ 8.33 (d, J=7.0 Hz, 1H), 8.00 (d, J=6.2 Hz, 1H), 7.75 (dd, J=11.6, 6.4 Hz, 1H), 7.62 (d, J=8.4 Hz, 1H), 7.35 (dd, J=11.7, 0.7 Hz, 1H), 6.99-6.90 (m, 2H), 0.94 (s, 9H), 0.71 (s, 6H). ¹¹B NMR (160 MHz, CD₂Cl₂) δ 29.5. ¹³C NMR (126 MHz, CD₂Cl₂) δ 146.7, 142.9, 140.6, 132.7, 123.5, 113.2, 26.9, 19.1, −1.1. The carbons adjacent to boron were not observed. HRMS (DART+) calculated for C₁₄H₂₃BNSi (M+1): 244.16928. found: 244.16911.

### Compound 47

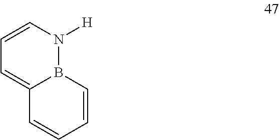

Compound 33 (40 mg, 0.164 mmole) was dissolved in 3 mL of THF. 1.05 equiv. of a 1M TBAF solution (175 μL, 0.175 mmole) was added and the mixture was stirred for 10 minutes. Final product 47 was isolated by column chromatography (silica gel, eluent Et₂O) (21.2 mg, quantitative yield). ¹H NMR (500 MHz, CD₂Cl₂) δ 9.31 (t, J=53.8 Hz, 1H), 8.41 (d, J=7.1 Hz, 1H), 7.94 (t, J=7.1 Hz, 1H), 7.82 (dd, J=10.4, 6.1 Hz, 1H), 7.65 (d, J=8.5 Hz, 1H), 7.23 (d, J=11.3 Hz, 1H), 7.05 (dd, J=8.4, 6.4 Hz, 1H), 6.93 (t, J=6.6 Hz, 1H). ¹¹B NMR (160 MHz, CD₂Cl₂) δ 26.7. ¹³C NMR (126 MHz, CD₂Cl₂) δ 145.7, 141.7, 136.9, 131.7, 126.7 (br), 124.8, 112.2. The quaternary carbon adjacent to boron was not observed. HRMS (DART+) calculated for C₈H₉BN (M+1): 130.08280. found: 130.08289.

### Example 13

### Exemplary Accessible Compounds

### Compound 48

2-Phenylpyridine compounds can be used in organometallic chemistry as ligands.

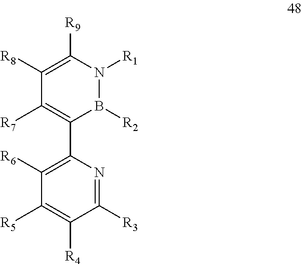

wherein R₁ can be hydrogen, deuterium, halogen, alkyl, aryl, heteroaryl, acyl, alkenyl, alkynyl, sulfonyl, alkoxy, an amine protecting group, or silane; R₂ can be hydrogen, deuterium, halogen, alkyl, aryl, heteroaryl, acyl, alkenyl, alkynyl, sulfonyl, alkoxy, thiol, ester, amino, or amide; and Remaining each of R₃—R₉ can independently be hydrogen, halogen, alkyl, aryl, heteroaryl, acyl, amide, alkenyl, alkynyl, alkoxy, or boronic ester or any combination thereof.

### Compound 49

Biphenyls can be used in medicinal chemistry and materials chemistry.

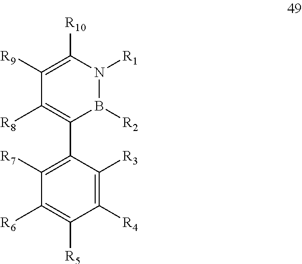

wherein R₁ can be hydrogen, deuterium, halogen, alkyl, aryl, heteroaryl, acyl, alkenyl, alkynyl, sulfonyl, alkoxy, an amine protecting group, or silane; R₂ can be hydrogen, deuterium, halogen, alkyl, aryl, heteroaryl, acyl, alkenyl, alkynyl, sulfonyl, alkoxy, thiol, ester, amino, or amide; and each of R₃—R₁₀ can independently be hydrogen, halogen, alkyl, aryl, heteroaryl, acyl, amide, alkenyl, alkynyl, alkoxy, or boronic ester or any combination thereof.

### Compound 50

Biaryl substituted ligands can be used for catalysis. Incorporation of an azaborine into these could potentially provide further tunability of these ligands.

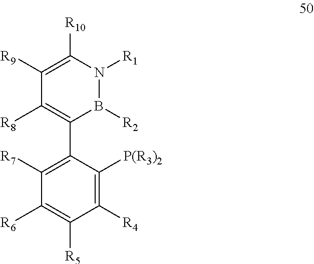

wherein R₁ can be hydrogen, deuterium, halogen, alkyl, aryl, heteroaryl, acyl, alkenyl, alkynyl, sulfonyl, alkoxy, an amine protecting group, or silane; R₂ can be hydrogen, deuterium, halogen, alkyl, aryl, heteroaryl, acyl, alkenyl, alkynyl, sulfonyl, alkoxy, thiol, ester, amino, or amide; R₃ can be hydrogen, alkyl, aryl, heteroaryl, alkoxy; and each of R₄—R₁₀ can independently be hydrogen, halogen, alkyl, aryl, heteroaryl, acyl, amide, alkenyl, alkynyl, alkoxy, or boronic ester or any combination thereof.

### Compound 51

Boron-phosphine ligands can be used for organometallic applications.

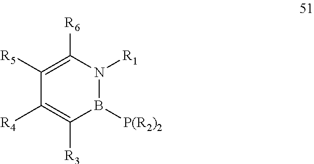

R₁ can be hydrogen, deuterium, halogen, alkyl, aryl, heteroaryl, acyl, alkenyl, alkynyl, sulfonyl, alkoxy, an amine protecting group, or silane.
wherein R₂ can be hydrogen, alkyl, aryl, heteroaryl, alkoxy; R₃ can be hydrogen, alkyl, aryl, heteroaryl; and each of R₃—R₆ can independently be hydrogen, halogen, alkyl, aryl, heteroaryl, acyl, amide, alkenyl, alkynyl, alkoxy, or boronic ester or any combination thereof.

### Compound 52

Aryl-tetrazoles can be used in medicinal chemistry.

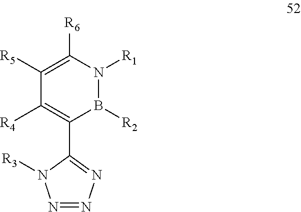

wherein R₁ can be hydrogen, deuterium, halogen, alkyl, aryl, heteroaryl, acyl, alkenyl, alkynyl, sulfonyl, alkoxy, an amine protecting group, or silane; R₂ can be hydrogen, deuterium, halogen, alkyl, aryl, heteroaryl, acyl, alkenyl, alkynyl, sulfonyl, alkoxy, thiol, ester, amino, or amide; R₃ can be hydrogen, deuterium, halogen, alkyl, aryl, heteroaryl, acyl, alkenyl, alkynyl, sulfonyl, alkoxy, thiol, ester, or amide; and each of R₄—R₆ can independently be hydrogen, halogen, alkyl, aryl, heteroaryl, acyl, amide, alkenyl, alkynyl, alkoxy, or boronic ester or any combination thereof.

### Compound 53

A new class of BN indoles could be synthesized using this methodology.

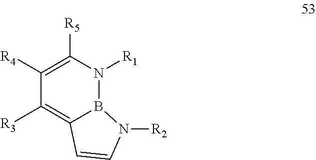

wherein R₁ can be hydrogen, deuterium, halogen, alkyl, aryl, heteroaryl, acyl, alkenyl, alkynyl, sulfonyl, alkoxy, an amine protecting group, or silane; R₂ can be hydrogen, deuterium, halogen, alkyl, aryl, heteroaryl, acyl, alkenyl, alkynyl, sulfonyl, alkoxy, an amine protecting group, or silane; and each of R₃—R₅ can independently be hydrogen, halogen, alkyl, aryl, heteroaryl, acyl, amide, alkenyl, alkynyl, alkoxy, or boronic ester or any combination thereof.

### Compound 54

A new class of BN carbazoles could be synthesized using this methodology.

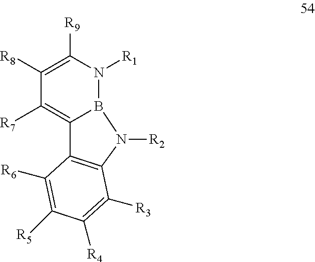

wherein R₁ can be hydrogen, deuterium, halogen, alkyl, aryl, heteroaryl, acyl, alkenyl, alkynyl, sulfonyl, alkoxy, an amine protecting group, or silane; R₂ can be hydrogen, deuterium, halogen, alkyl, aryl, heteroaryl, acyl, alkenyl, alkynyl, sulfonyl, alkoxy, an amine protecting group, or silane; and each of R₃—R₉ can independently be hydrogen, halogen, alkyl, aryl, heteroaryl, acyl, amide, alkenyl, alkynyl, alkoxy, or boronic ester or any combination thereof.

### Compound 55

Ethylaminoarenes can be found in drugs and biological systems. Specifically the phenylalanine derivative wherein R₁₋₄ and R₆₋₈=hydrogen while R₅=carboxyl is a compound potentially accessible by the current technology.

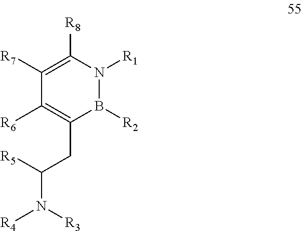

wherein R₁ can be hydrogen, deuterium, halogen, alkyl, aryl, heteroaryl, acyl, alkenyl, alkynyl, sulfonyl, alkoxy, an amine protecting group, or silane; R₂ can be hydrogen, deuterium, halogen, alkyl, aryl, heteroaryl, acyl, alkenyl, alkynyl, sulfonyl, alkoxy, thiol, ester, or amide, amino; each of R₃ and R₄ can independently be hydrogen, deuterium, halogen, alkyl, aryl, heteroaryl, acyl, alkenyl, alkynyl, sulfonyl, alkoxy, an amine protecting group, or silane; R₅ can be hydrogen, halogen, alkyl, aryl, heteroaryl, acyl, amide, alkenyl, alkynyl, alkoxy, carboxyl, or acyl; and each of R₆—R₈ can independently be hydrogen, halogen, alkyl, aryl, heteroaryl, acyl, amide, alkenyl, alkynyl, alkoxy, or boronic ester or any combination thereof.

### Compounds 56-72

Both linear and bent extended fused arenes are of interest from a materials science perspective. Many new extended arenes should be accessible through this methodology.

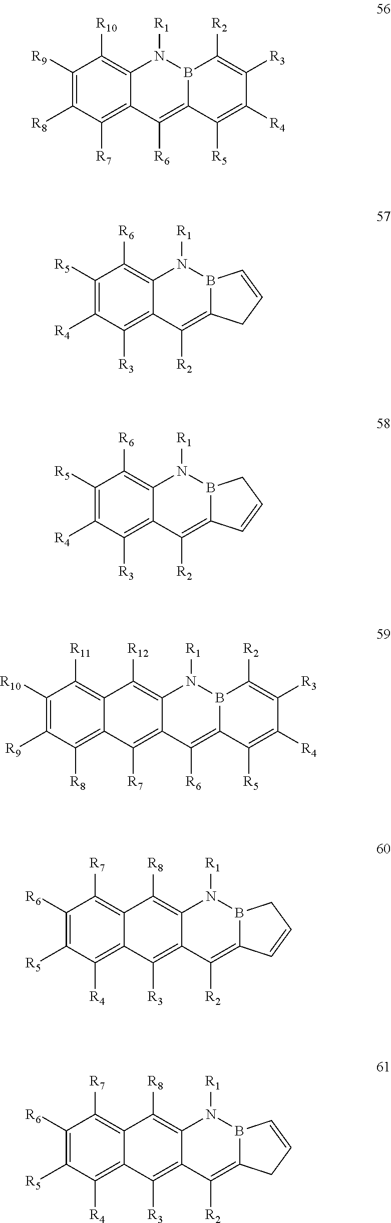

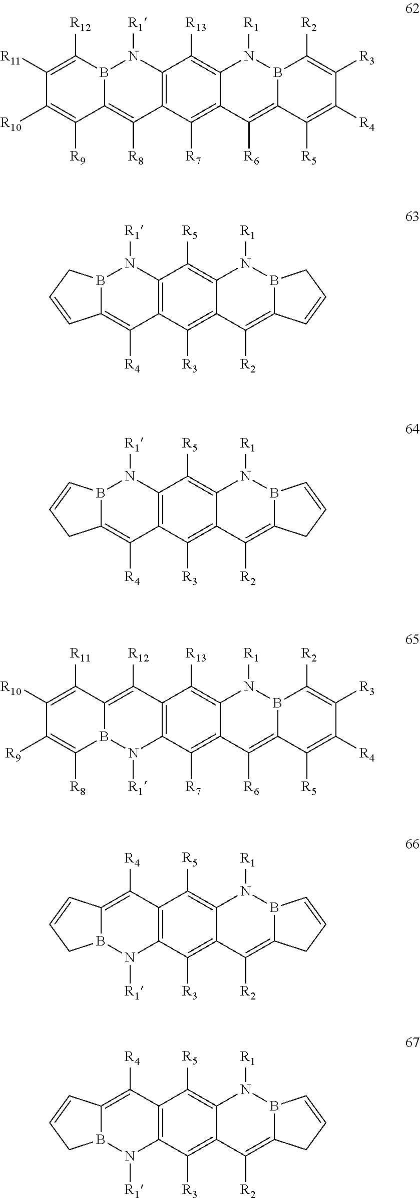

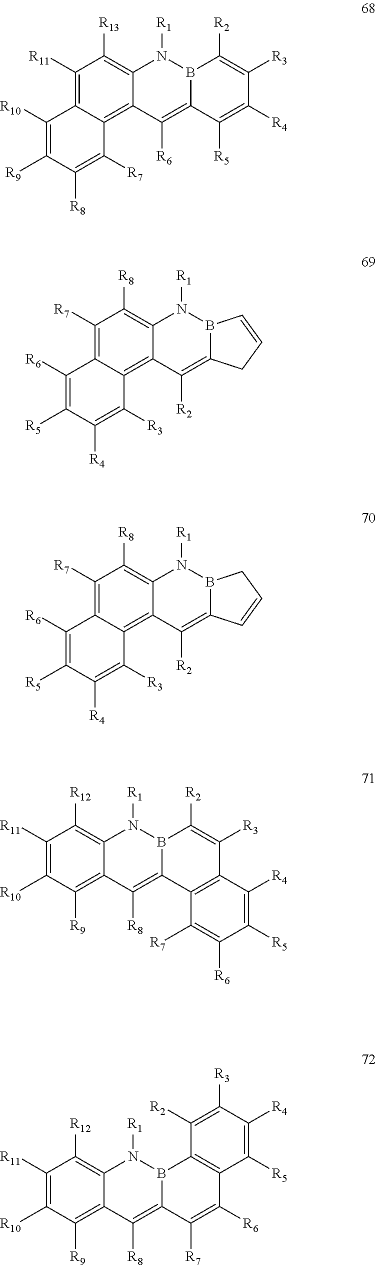

wherein R₁ can be hydrogen, deuterium, halogen, alkyl, aryl, heteroaryl, acyl, alkenyl, alkynyl, sulfonyl, alkoxy, an amine protecting group, or silane; and each of R₂—R₁₂ can independently be hydrogen, halogen, alkyl, aryl, heteroaryl, acyl, amide, alkenyl, alkynyl, alkoxy, or boronic ester or any combination thereof.

### Example 14

### Synthesis of Azaborine-Containing Biaryl-Alcohol and Derivatives

General structure of azaborine-containing biaryl-alcohol and its derivatives

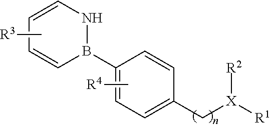

wherein

X is O, S or N, and
When X is O, R¹ is H, alkyl, alkoxy, aryl, alkenyl, alkynyl, aryl, heteroaryl, ester, carbamate, or amino acid; R² is a lone electron pair;
When X is S, R¹ is H, alkyl, alkoxy, aryl, alkenyl, alkynyl, aryl, heteroaryl, ester, carbamate, or amino acid; R² is lone electron pair or oxygen;
When X is N, R¹ is H, alkyl, alkoxy, aryl, alkenyl, alkynyl, aryl, heteroaryl, ester, carbamate, urea, amide, or amino acid; R² is H, alkyl, alkoxy, aryl, alkenyl, alkynyl, aryl, heteroaryl, ester, carbamate, urea, amide, or amino acid;

R³ is H, alkyl, alkoxy, aryl, alkenyl, alkynyl, heteroaryl, halogen, phosphinyl, amino, amide, silyl, thio, sunlfonyl, carbonyl, carbonate, or ester;

R⁴ is H, alkyl, alkoxy, aryl, alkenyl, alkynyl, heteroaryl, halogen, phosphinyl, amino, amide, silyl, thio, sunlfonyl, carbonyl, carbonate, or ester.

R³ and R⁴ can be at any position(s) at phenyl-ring; when X is O or S, n is 0-18. The chains can be located at ortho, meta orpara position to azaborine ring. The chains may be a hydrocarbon with one or more carbons substituted by heteroatoms. The chains may be straight or branched. The chains can be saturated or unsaturated. The unsaturated chain has one or more double bonds and/or one or more triple bonds.

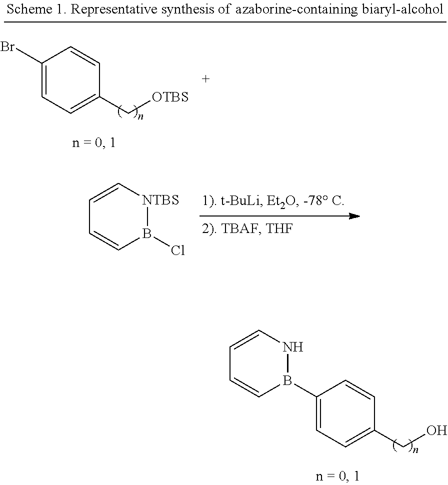

### General Experimental Procedure to Form Azaborine-Containing Biaryl-Alcohol

To the solution of ((4-bromobenzyl)oxy)(tert-butyl)dimethylsilane (901 mg, 3 mmol) in Et₂O (10 mL), tBuLi (1.7M in hexane, 3.7 mL, 2.1 eq.) was added slowly at −78° C. under N₂ environment within 15 min, the solution was stirred at this temperature for 1 hr followed by slow addition of a solution of 1-(tert-butyldimethylsilyl)-2-chloro-1,2-dihydro-1,2-azaborinine in Et₂O (684 mg in 6 mL). The reaction was stirred overnight with the temperature slowly rising to room temperature. In the glovebox, the reaction mixture was quickly purified through a short silica gel chromatography column using pentane/Et₂O as eluent to the desired intermediate as yellow oil which was used directly for the next de-protection step. In the glovebox, THF (7 mL) was added to this yellow oil

and the reaction flask was taken out of the glovebox. The solution was cooled in −25° C. freezer for 15 min and TBAF (6.4 mL, 1.0 M in THF) was added slowly. The resulted yellow solution was stirred at room temperature for 3 hr. Purification of crude material was performed on silica gel chromatography using hexane/acetone as the eluent. The resulted off-white solid was recrystallized in acetone/hexane system to afford compound (388 mg, 70% yield for two steps).

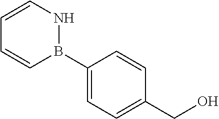 [SMILES: OCc1ccc(B2C=CC=CN2)cc1]

¹H NMR (600 MHz, CD₂Cl₂) δ 8.46 (br s, 1H), 7.78-7.82 (m, 3H), 7.43-7.47 (m, 3H), 7.20 (d, J=10.8 Hz, 1H), 6.42 (t, J=6.0 Hz, 1H), 4.73 (d, J=6.0, 2H), 1.77 (t, J=6.0, 1H); ¹³C NMR (125 MHz, Acetone-d6) δ 144.2, 134.9, 132.3, 126.1, 63.9; ¹¹B NMR (128 MHz) δ 34.4; HRMS (DART) calculated for C₁₁H₁₃BNO (M+H)⁺ 186.10902. found 186.10927.

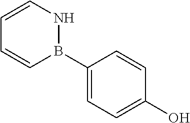 [SMILES: Oc1ccc(B2C=CC=CN2)cc1]

¹H NMR (600 MHz, Acetone-d6) δ 9.73 (br s, 1H), 8.33 (s, 1H), 7.71-7.76 (m, 2H), 7.64-7.69 (m, 1H), 7.46 (t, J=7.2 Hz, 1H), 7.04-7.09 (m, 1H), 6.86-6.90 (m, 2H), 6.28 (dt, J=6.6, 5.4 Hz, 1H); ¹³C NMR (150 MHz, Acetone-d6) δ 158.4, 143.9, 136.9, 134.7, 133.9, 133.8, 115.0, 114.5, 109.7; ¹¹B NMR (128 MHz) δ 34.2; HRMS (DART) calculated for C₁₀H₁₁BNO (M+H)⁺ 172.09337. found 172.09378.

### General Synthetic Protocol for Derivation on Azaborine-Containing Biaryl-Alcohol

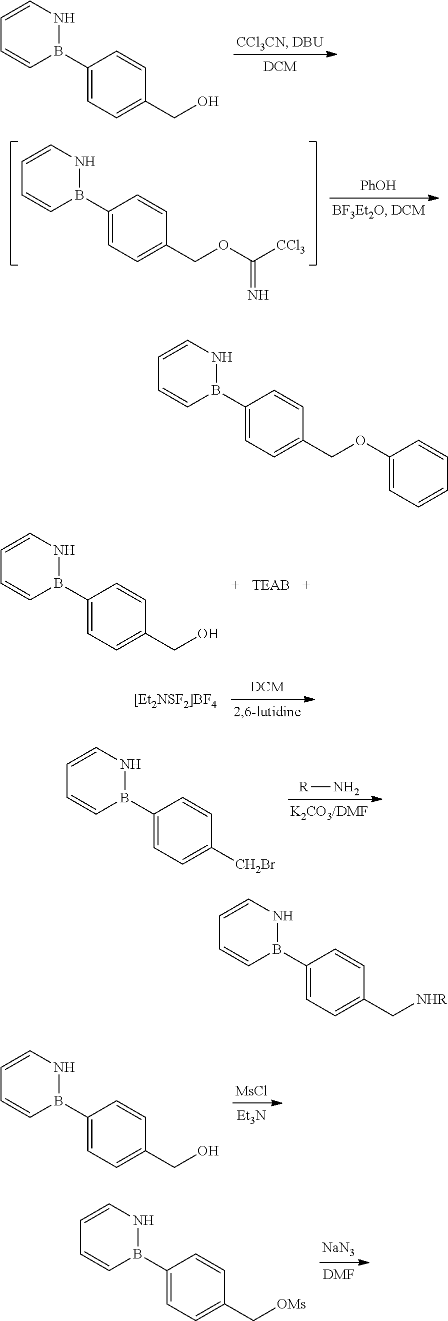

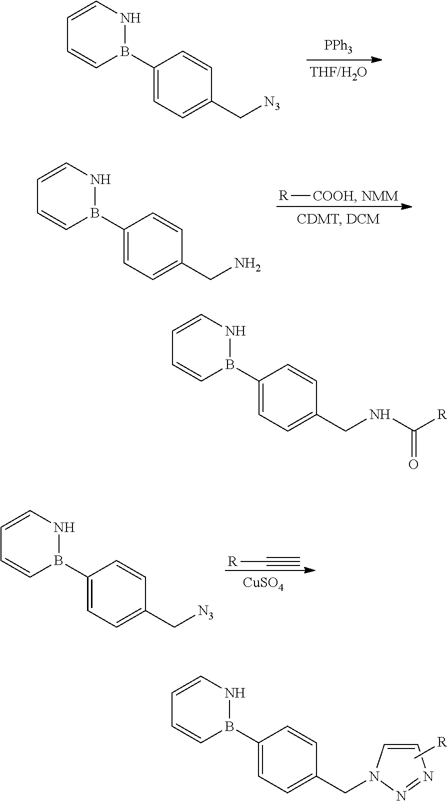

4-(1,2-azaborinine)-benzyl alcohol (102 mg, 0.55 mmol) was dissolved into CH₂Cl₂ (5 mL), CCl₃CN (240 mg, 3.0 eq.) and DBU (9 mg, 0.1 eq.) was added successively. The reaction mixture was stirred at rt for 3 hr and purified by silica gel chromatography using hexane/ethyl acetate/trimethylamine system to afford the trichloroacetamide intermediate as yellow solid (112 mg, yield 62%). 4-(1,2-azaborinin-2(1H)-yl)benzyl 2,2,2-trichloroacetimidate (16 mg, 0.05 mmol) was mixed with phenol (7 mg, 1.5 eq.) in CH₂Cl₂ (2 mL). BF₃Et₂O (1 μL, 0.2 eq.) was added and the mixture was stirred at rt for 2 hr. Desired ether product was got by by silica gel chromatography (8 mg, yield 63%).

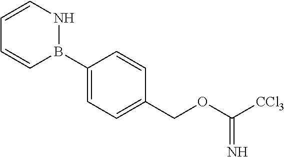

¹H NMR (500 MHz, CD₂Cl₂) δ 8.57 (br s, 1H), 8.48 (s, 1H), 7.77-7.84 (m, 3H), 7.42-7.51 (m, 3H), 7.19 (d, J=10.5 Hz, 1H), 6.42 (t, J=6.0 Hz, 1H), 5.33 (s, 2H); ¹¹B NMR (128 MHz) δ 33.6.

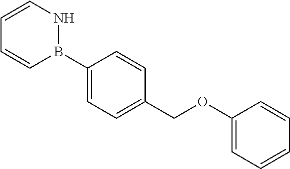 [SMILES: C1=CNB(c2ccc(COc3ccccc3)cc2)C=C1]

¹H NMR (500 MHz, CD₂Cl₂) δ 8.53 (br s, 1H), 7.88-7.91 (m, 3H), 7.56-7.61 (m, 3H), 7.28-7.39 (m, 4H), 7.06-7.11 (m, 3H), 6.50 (t, J=6.6, 1H), 5.19 (s, 2H); ¹¹B NMR (128 MHz) δ 33.7; HRMS (DART) calcd for C₁₇H₁₇BNO (M+H)⁺ 262.14032. found 262.13998.

4-(1,2-azaborinine)-benzyl alcohol (19 mg, 0.10 mmol) was dissolved into CH₂Cl₂ (5 mL), TEAB (32 mg, 1.5 eq.), 2,6-lutidine (35 uL, 3 eq.) was added. The mixture was cooled to −25° C. and XtalFluor-E (35 mg, 1.5 eq.) was added. The reaction mixture was stirred overnight and purified by silica gel chromatography to afford the benzyl bromide (12 mg, yield 48%).

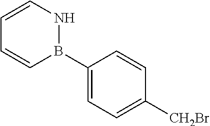

¹H NMR (400 MHz, CD₂Cl₂) δ 8.41 (br s, 1H), 7.76-7.78 (m, 3H), 7.39-7.42 (m, 3H), 7.15-7.18 (m, 1H), 6.41 (t, J=6.8 Hz, 1H), 4.55 (s, 2H); ¹¹B NMR (128 MHz) δ 33.8; HRMS (DART) calculated for C₁₁H₁₂BBrN (M+H)⁺ 248.02462. found 248.02454.

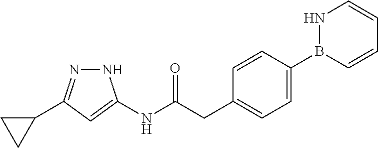 [SMILES: O=C(Cc1ccc(B2C=CC=CN2)cc1)Nc1cc(C2CC2)n[nH]1]

¹H NMR (500 MHz, DMSO-d6) δ 11.18 (s, 1H), 10.62 (bs, 1H), 7.83 (d, J=8.0 Hz, 2H), 7.66-7.69 (m, 1H), 7.47 (t, J=7.0 Hz, 1H), 7.35 (d, J=8.0 Hz, 2H), 7.06 (d, J=11.5 Hz, 1H), 6.36 (t, J=6.0 Hz, 1H), 6.11 (s, 1H), 5.76 (s, 1H), 3.68 (s, 2H), 1.92 (m, 1H), 0.99 (m, 2H), 0.75 (m, 2H); ¹³C NMR (126 MHz, DMSO-d6) δ 169.2, 144.7, 136.5, 135.9, 133.0, 129.2, 110.7, 55.4, 40.8, 8.8, 7.3; ¹¹B NMR (160 MHz) δ 34.7; HRMS (DART) calculated for C₁₈H₂₀BN₄O (M+H)⁺ 319.17379. found 319.17302.

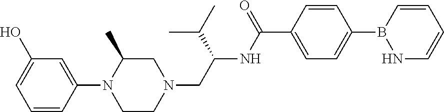 [SMILES: CC(C)[C@@H](CN1CCN(c2cccc(O)c2)[C@@H](C)C1)NC(=O)c1ccc(B2C=CC=CN2)cc1]

¹H NMR (500 MHz, CD₂Cl₂) δ 8.75 (br s, 1H), 7.76-7.86 (m, 5H), 7.42-7.47 (m, 1H), 7.17-7.20 (m, 1H), 6.99-7.03 (m, 1H), 6.24-6.43 (m, 4H), 4.20-4.24 (m, 1H), 4.06-4.11 (m, 1H), 3.70-3.76 (s, 1H), 3.12-3.15 (m, 1H), 2.96-3.02 (m, 1H), 2.77-2.80 (m, 1H), 2.58 (t, J=15.0 Hz, 1H), 2.24-2.41 (m, 2H), 2.01-2.05 (m, 2H), 1.23-1.27 (m, 2H), 0.97-0.99 (m, 5H), 0.87 (m, 2H); ¹³C NMR (126 MHz, CD₂Cl₂) δ 168.0, 157.3, 151.4, 144.9, 135.1, 134.3, 132.3, 129.8, 126.4, 111.3, 107.8, 105.7, 102.8, 60.2, 58.7, 54.5, 51.3, 50.5, 30.9, 18.8, 17.7, 13.9, 12.3; ¹¹B NMR (160 MHz) δ 35.8; HRMS (DART) calculated for C₂₇H₃₆BN₄O₂ (M+H)⁺ 459.29313. found 459.29461.

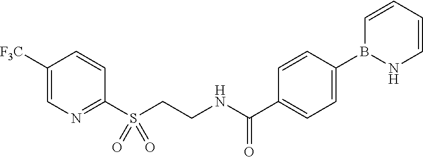 [SMILES: O=C(NCCS(=O)(=O)c1ccc(C(F)(F)F)cn1)c1ccc(B2C=CC=CN2)cc1]

¹H NMR (500 MHz, Acetone-d6) δ 10.67 (br s, 1H), 9.06 (s, 1H), 8.45-8.50 (m, 2H), 8.23 (d, J=8.5 Hz, 1H), 7.85-7.90 (m, 2H), 7.63-7.72 (m, 1H), 7.58-7.60 (m, 2H), 7.48 (t, J=7.5 Hz, 1H), 7.07 (d, J=11.0 Hz, 1H), 6.39 (t, J=6.0 Hz, 1H), 3.84-3.93 (m, 2H), 3.60-3.78 (m, 2H); ¹³C NMR (126 MHz, Acetone-d6) δ 166.7, 160.5, 147.7, 145.1, 137.3, 136.0, 133.7, 132.6, 126.7, 122.7, 111.3, 50.9, 34.2; ¹¹B NMR (160 MHz) δ 34.3; HRMS (DART) calculated for C₁₉H₁₈BF₃N₃O₃S (M+H)⁺ 436.11140. found 436.11278.

### Example 15

### Testing for Bioactivity and ADME

Bioactivity and ADME testing were performed for certain compounds of the invention. Results are provided in Table 2.

TABLE 2
Bioactivity and ADME Profiling

| | | | Solubility | | | | | | |
|---|---|---|---|---|---|---|---|---|---|
| | Biological | Therapeutic | pH = 6.8 | FASSIF | | | RLM | CYP3A4 | hERG |
| Structure | Activity | Application | (mM) | (mM) | LogD | PAMPA | Cl (ml/min/kg) | (μM) | (μM) |
| 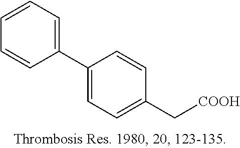 [SMILES: O=C(O)Cc1ccc(-c2ccccc2)cc1] | | | 0.89 | 0.84 | | | | >20 | >30 |
| 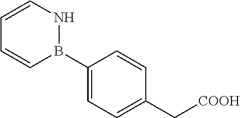 [SMILES: O=C(O)Cc1ccc(B2C=CC=CN2)cc1] | | | >1 | 0.79 | | | | >20 | >30 |
| 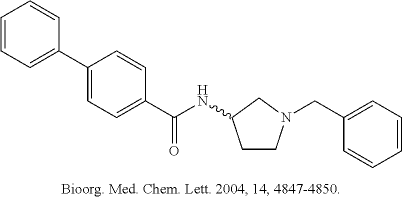 [SMILES: O=C(NC1CCN(Cc2ccccc2)C1)c1ccc(-c2ccccc2)cc1] | | | 0.013 | 0.027 | 4.4 | −3.6 | 43.7 | >20 | 0.32 |
| 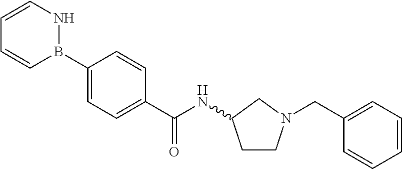 [SMILES: O=C(NC1CCN(Cc2ccccc2)C1)c1ccc(B2C=CC=CN2)cc1] | | | >0.03 | 0.597 | 4.1 | −4.8 | 48.5 | >20 | 1.4 |
| 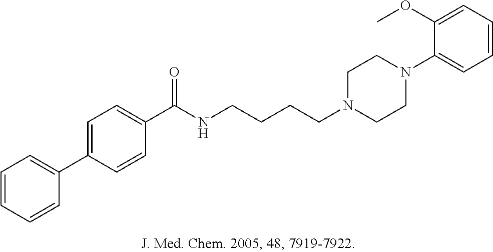 [SMILES: COc1ccccc1N1CCN(CCCCNC(=O)c2ccc(-c3ccccc3)cc2)CC1] | Dopamine D₂ antagonist IC₅₀ = 0.45 uM Dopamine D₃ antagonist IC₅₀ = 0.003 uM | | <0.005 | 0.021 | 4.2 | −3.9 | 51.4 | >20 | 0.042 |
| 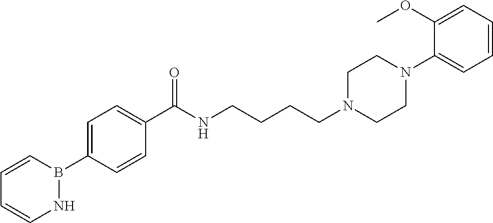 [SMILES: COc1ccccc1N1CCN(CCCCNC(=O)c2ccc(B3C=CC=CN3)cc2)CC1] | Dopamine D₂ antagonist IC₅₀ = 0.52 uM Dopamine D₃ antagonist IC₅₀ = 0.004 uM | Parkinson's disease, schizophrenia, substance abuse, bipolar disorder, nausea, vomiting and control of hypersexuality. | 0.046 | 0.22 | 4.1 | −4.3 | >53 | 11 | 0.17 |
| 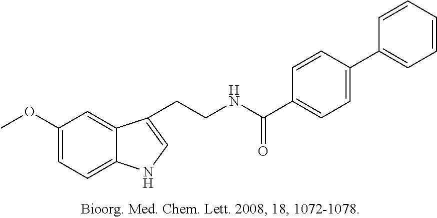 [SMILES: COc1ccc2[nH]cc(CCNC(=O)c3ccc(-c4ccccc4)cc3)c2c1] | | | | | >5 | −4.1 | 46.4 | >20 | 11 |
| 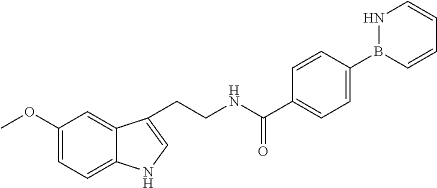 [SMILES: COc1ccc2[nH]cc(CCNC(=O)c3ccc(B4C=CC=CN4)cc3)c2c1] | | | | | 5 | −4.2 | 51.3 | 17 | 7.9 |
| 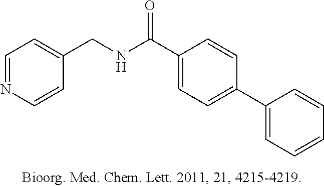 [SMILES: O=C(NCc1ccncc1)c1ccc(-c2ccccc2)cc1] | | | 0.0097 | 0.022 | 3.4 | −3.8 | 42.1 | 3.05 | 14 |
| 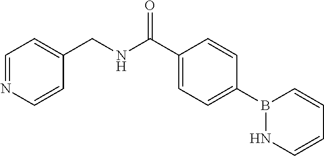 [SMILES: O=C(NCc1ccncc1)c1ccc(B2C=CC=CN2)cc1] | | | 0.088 | 0.13 | 3.2 | −4.6 | 39.6 | 8.6 | >30 |
| 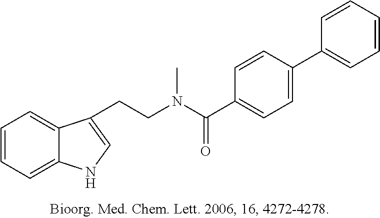 [SMILES: CN(CCc1c[nH]c2ccccc12)C(=O)c1ccc(-c2ccccc2)cc1] | | | <0.005 | <0.005 | >5 | −4.5 | 48.6 | >20 | >30 |
| 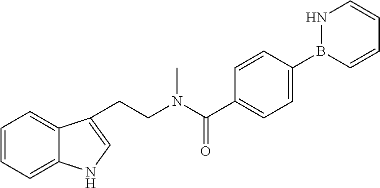 [SMILES: CN(CCc1c[nH]c2ccccc12)C(=O)c1ccc(B2C=CC=CN2)cc1] | | | <0.005 | 0.013 | 4.6 | −4.2 | 52.4 | >20 | 5.8 |
| 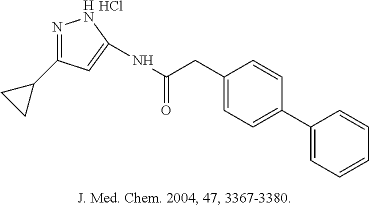 [SMILES: Cl ; O=C(Cc1ccc(-c2ccccc2)cc1)Nc1cc(C2CC2)n[nH]1] | | | <0.004 | 0.013 | 4.2 | −3.9 | 50 | >20 | >30 |
| 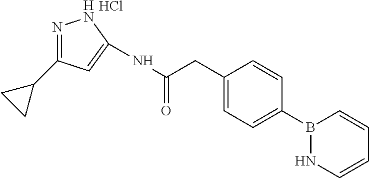 [SMILES: Cl ; O=C(Cc1ccc(B2C=CC=CN2)cc1)Nc1cc(C2CC2)n[nH]1] | CDK2 inhibitor IC₅₀ = 0.24 uM | Anti-cancer | | | | | | 7.8 | >30 |
| 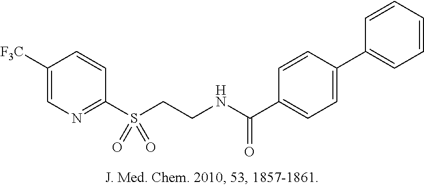 [SMILES: O=C(NCCS(=O)(=O)c1ccc(C(F)(F)F)cn1)c1ccc(-c2ccccc2)cc1] | PPARα inverse agonist IC₅₀ = 0.25 uM PPARγ antagonist IC₅₀ = 1.4 uM PPARδ antagonist IC₅₀ = 3.9 uM | | <0.004 | <0.004 | 3.5 | −4.2 | 38.7 | >20 | >20 |
| 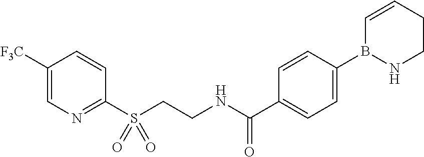 [SMILES: O=C(NCCS(=O)(=O)c1ccc(C(F)(F)F)cn1)c1ccc(B2C=CCCN2)cc1] | PPARα inverse agonist IC₅₀ = 0.052 uM PPARγ antagonist IC₅₀ = 4.8 uM PPARδ antagonist IC₅₀ = 1.4 uM | Treatment of metabolic disorders. Lowering triglycerides and blood sugar. Diabetes and high cholesterol. | <0.004 | 0.006 | 3.5 | −4.5 | >53 | >20 | >30 |
| 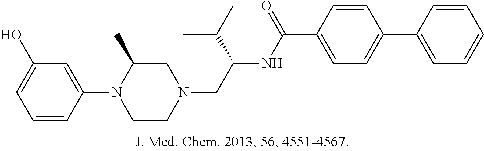 [SMILES: CC(C)[C@@H](CN1CCN(c2cccc(O)c2)[C@@H](C)C1)NC(=O)c1ccc(-c2ccccc2)cc1] | Opioid δ antagonist IC₅₀ > 30 uM Opioid μ antagonist IC₅₀ = 7.4 uM | | 0.05 | 0.349 | 5.2 | −5.7 | >53 | >20 | >30 |
| 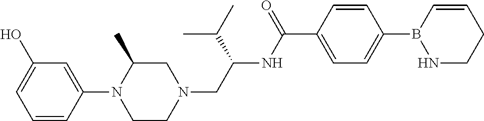 [SMILES: CC(C)[C@@H](CN1CCN(c2cccc(O)c2)[C@@H](C)C1)NC(=O)c1ccc(B2C=CCCN2)cc1] | Opioid δ antagonist IC₅₀ > 14 uM Opioid μ antagonist IC₅₀ = 1 uM | Depression, anxiety, schizophrenia, addiction, stress, fear, and eating disorders. | 0.026 | 0.119 | 4.9 | −5.0 | >53 | 16 | 9.1 |

FASSIF (fasted state simulated intestinal fluid);
PAMPA (parellel artificial membrane permeability assay);
CYP3A4 (Cytochrome P450 3A4)

In this specification and the appended claims, the singular forms “a,” “an,” and “the” include plural reference, unless the context clearly dictates otherwise.

Unless defined otherwise, all technical and scientific terms used herein have the same meaning as commonly understood by one of ordinary skill in the art. Although any methods and materials similar or equivalent to those described herein can also be used in the practice or testing of the present disclosure, the preferred methods and materials are now described. Methods recited herein may be carried out in any order that is logically possible, in addition to a particular order disclosed.

### INCORPORATION BY REFERENCE

References and citations to other documents, such as patents, patent applications, patent publications, journals, books, papers, web contents, have been made in this disclosure. All such documents are hereby incorporated herein by reference in their entirety for all purposes. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

### EQUIVALENTS

The representative examples are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples and the references to the scientific and patent literature included herein. The examples contain important additional information, exemplification and guidance that can be adapted to the practice of this invention in its various embodiments and equivalents thereof.

1. A compound having the structural Formula (I): 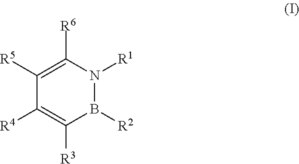
wherein
R¹ is H, or an optionally substituted alkyl, aryl, or silane group;
R² is H, a halogen, or an optionally substituted aryl, alkyl, alkenyl, alkynyl, alkoxy, amino, alcohol, or thio group; and
each of R³, R⁴, R⁵ and R⁶ is independently H, a halogen, or an optionally substituted alkyl, alkoxy, aryl, alkenyl, alkynyl, heteroaryl, phosphinyl, amino, amide, silyl, thio, sunlfonyl, carbonyl, ester, or ketone group,
or a pharmaceutically acceptable salt or ester thereof.

2. The compound of claim 1, having the structural Formula (II): 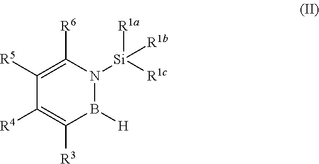
wherein each of R^{1a}, R^{1b}, and R^{1c} is independently a C₁-C₆ alkyl or aryl group.

3-5. (canceled)

6. The compound of claim 1, having the structural formula: 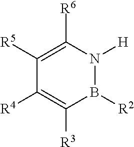
wherein R² is a halogen, or an optionally substituted alkoxy group.

7-9. (canceled)

10. The compound of claim 1, having the structural formula: 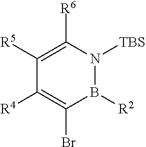
wherein R² is H, a halogen, or an alkoxy group.

11. (canceled)

12. The compound of claim 1, having the structural formula: 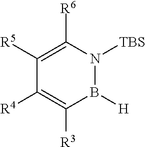
wherein R³ is H Br or an alkyl, aryl, heteroaryl, or alkenyl group.

13-14. (canceled)

15. A method of preparing a compound of claim 1,
the method comprising:
reacting a compound of Formula (III) with a zincate in the presence of a catalyst; 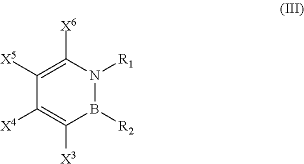
wherein
R¹ is H, or an optionally substituted alkyl, aryl, or silane;
R² is H, a halogen, or an optionally substituted aryl, alkyl, alkenyl, alkynyl, alkoxy, amino, alcohol, or thio; and
each of X³, X⁴, X⁵ and X⁶ is independently H, a halogen, an optionally substituted alkyl, alkoxy, aryl, alkenyl, alkynyl, heteroaryl, phosphinyl, amino, amide, silyl, thio, sunlfonyl, carbonyl, ester, boronic ester, or ketone group;
provided that at least one of X³, X⁴, X⁵ and X⁶ is a halogen.

16. The method of claim 15, wherein X³ is a halogen.

17. (canceled)

18. The method of claim 15, wherein the catalyst is PdCl₂(Potol₃)₂ or Pd(PtBu₃)₂.

19-23. (canceled)

24. A method of preparing a compound of claim 2,
the method comprising:
reacting a compound of Formula (IV) with a zincate in the presence of a catalyst; 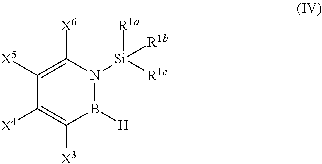
wherein;
R^{1a}, R^{1b}, and R^{1c} are each independently lower alkyl or aryl groups; and
each of X³, X⁴, X⁵ and X⁶ is independently H, a halogen, alkyl, alkoxy, aryl, alkenyl, alkynyl, heteroaryl, phosphinyl, amino, amide, silyl, thio, sunlfonyl, carbonyl, ester, boronic ester, or ketone;
provided that at least one of X³, X⁴, X⁵ and X⁶ is a halogen.

25. The method of claim 24, wherein X³ is a halogen.

26. The method of claim 25, wherein X³ is bromine.

27. The method of claim 24, wherein the catalyst is PdCl₂(Potol₃)₂ or Pd(PtBu₃)₂.

28. The method of claim 24, wherein the zincate is RZnX^{a}, wherein
R is an optionally substituted alkyl, alkoxy, aryl, alkenyl, alkynyl, heteroaryl, phosphinyl, amino, amide, silyl, thio, sunlfonyl, carbonyl, ester, or ketone desired to be added to formula (III); and
X^{a} is a halogen.

29. The method of claim 28, wherein X^{a} is bromine.

30. The method of claim 28, wherein the reaction is conducted in an organic solvent.

31. The compound of claim 1, having the Formula (V): 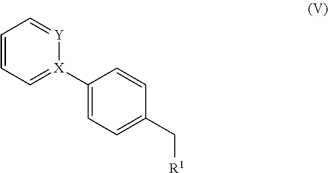
wherein:
X is B or C;
Y is CR² or NR²;
R¹ is CO₂R³ or CONR³R⁴;
R² is H, a halogen, or an optionally substituted alkyl, alkenyl, alkynyl, aryl, phosphinyl, heteroaryl, alkoxy, aramino, amide, silyl, thio, sunlfonyl, carbonyl, or carbonate ester; and
each of R³ and R⁴ is independently H, a halogen, or an optionally substituted alkyl, alkenyl, alkynyl, aryl, phosphinyl, heteroaryl, alkoxy, aramino, amide, silyl, thio, sunlfonyl, carbonyl, or carbonate ester;
or a pharmaceutically acceptable salt, solvate, clathrate, or ester thereof.

32. The compound claim 1, having the structural Formula (VI): 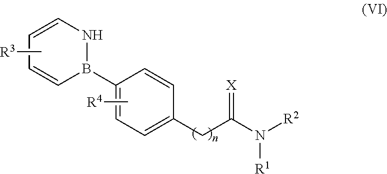
wherein:
each of R¹ and R² is independently H, or an alkyl, alkoxy, aryl, alkenyl, alkynyl, heteroaryl, ester, or amino acid group;
each of R³ and R⁴ is H, or an alkyl, alkoxy, aryl, alkenyl, alkynyl, heteroaryl, halogen, phosphinyl, amino, amide, silyl, thio, sunlfonyl, carbonyl, carbonate, ester, wherein R³ and R⁴ can be at any position or positions on the phenyl-ring;
X is O or S;
n is an integer between 0 and 18;
or a pharmaceutically acceptable salt, solvate, clathrate or ester thereof.

33-36. (canceled)

37. The compound of claim 1, having the structural Formula (IX): 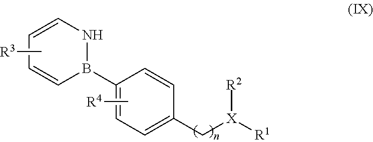
wherein
X is O, S or N, and
When X is O, R¹ is H, alkyl, alkoxy, aryl, alkenyl, alkynyl, aryl, heteroaryl, ester, carbamate, or amino acid; R² is a lone electron pair;
When X is S, R¹ is H, alkyl, alkoxy, aryl, alkenyl, alkynyl, aryl, heteroaryl, ester, carbamate, or amino acid; R² is lone electron pair or oxygen;
When X is N, R¹ is H, alkyl, alkoxy, aryl, alkenyl, alkynyl, aryl, heteroaryl, ester, carbamate, urea, amide, or amino acid; R² is H, alkyl, alkoxy, aryl, alkenyl, alkynyl, aryl, heteroaryl, ester, carbamate, urea, amide, or amino acid;
R³ is H, alkyl, alkoxy, aryl, alkenyl, alkynyl, heteroaryl, halogen, phosphinyl, amino, amide, silyl, thio, sunlfonyl, carbonyl, carbonate, or ester; and
R⁴ is H, alkyl, alkoxy, aryl, alkenyl, alkynyl, heteroaryl, halogen, phosphinyl, amino, amide, silyl, thio, sunlfonyl, carbonyl, carbonate, or ester.

38. (canceled)

39. A pharmaceutical composition comprising an amount of a compound having the structural Formula (I): 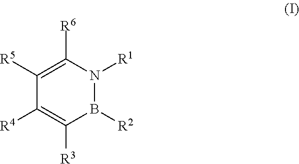
wherein
R¹ is H, or an optionally substituted alkyl, aryl, or silane group;
R² is H, a halogen, or an optionally substituted aryl, alkyl, alkenyl, alkynyl, alkoxy, amino, alcohol, or thio group; and
each of R³, R⁴, R⁵ and R⁶ is independently H, a halogen, or an optionally substituted alkyl, alkoxy, aryl, alkenyl, alkynyl, heteroaryl, phosphinyl, amino, amide, silyl, thio, sunlfonyl, carbonyl, ester, or ketone group,
or a pharmaceutically acceptable salt or ester thereof, effective to treat, prevent, or reduce one or more diseases or disorders, and a pharmaceutically acceptable excipient, carrier, or diluent.

40. A method of treating a disease, comprising administering to the subject in need thereof administering to a subject in need thereof a pharmaceutical composition comprising an amount of a compound having the structural Formula (I): 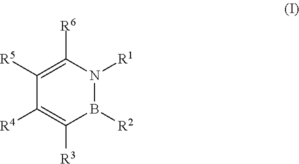
wherein
R¹ is H, or an optionally substituted alkyl, aryl, or silane group;
R² is H, a halogen, or an optionally substituted aryl, alkyl, alkenyl, alkynyl, alkoxy, amino, alcohol, or thio group; and
each of R³, R⁴, R⁵ and R⁶ is independently H, a halogen, or an optionally substituted alkyl, alkoxy, aryl, alkenyl, alkynyl, heteroaryl, phosphinyl, amino, amide, silyl, thio, sunlfonyl, carbonyl, ester, or ketone group,
or a pharmaceutically acceptable salt or ester thereof, effective to treat, prevent, or reduce one or more diseases or disorders, and a pharmaceutically acceptable excipient, carrier, or diluent.
